(19) United States
(12) Patent Application Publication
(10) Pub. No.: US 2026/0099146 A1
(43) Pub. Date: Apr. 9, 2026

(54) SYSTEMS AND METHODS FOR VEHICLE NAVIGATION

(71) Applicant: Mobileye Vision Technologies Ltd., Jerusalem (IL)

(72) Inventors: Roy Maor LOTAN, Caesarea (IL); Shahar HAROUCHE, Raanana (IL); Nadav SHAAG, Jerusalem (IL)

(21) Appl. No.: 19/416,498

(22) Filed: Dec. 11, 2025

Related U.S. Application Data
(63) Continuation of application No. PCT/US2024/034900, filed on Jun. 21, 2024.
(60) Provisional application No. 63/522,853, filed on Jun. 23, 2023.
(60) Provisional application No. 63/612,518, filed on Dec. 20, 2023.
(60) Provisional application No. 63/622,189, filed on Jan. 18, 2024.

(51) Int. Cl. G05D 1/243; G06V 20/56; G06V 20/58

(52) U.S. Cl. CPC G05D 1/2435; G06V 20/582; G06V 20/588

(57) ABSTRACT

A system for navigating a host vehicle relative to a road segment is disclosed. The system may comprise at least one processor comprising circuitry and a memory, wherein the memory includes instructions that when executed by the circuitry cause the at least one processor to: receive a captured image acquired by a camera onboard the host vehicle; based on analysis of the image, generate image height information including a predicted height value for each of a first plurality of pixels included in the captured image, the predicted height value for each of the first plurality of pixels being indicative of height above a ground surface; based on analysis of the image, generate image range information, including a predicted range value for each of a second plurality of pixels included in the captured image, the predicted range value for each of the second plurality of pixels being indicative of distance relative to the camera; and determine a navigational action for the host vehicle based on at least one of the image height information or the image range information.

### CROSS REFERENCES TO RELATED APPLICATIONS

This application claims the benefit of priority of U.S. Provisional Application No. 63/522,853, filed on Jun. 23, 2023; U.S. Provisional Application No. 63/612,518, filed on Dec. 20, 2023; and U.S. Provisional Application No. 63/622,189, filed on Jan. 18, 2024. The foregoing applications are incorporated herein by reference in their entirety.

### BACKGROUND

### Technical Field

The present disclosure relates generally to autonomous vehicle navigation.

### Background Information

As technology continues to advance, the goal of a fully autonomous vehicle that is capable of navigating on roadways is on the horizon. Autonomous vehicles may need to take into account a variety of factors and make appropriate decisions based on those factors to safely and accurately reach an intended destination. For example, an autonomous vehicle may need to process and interpret visual information (e.g., information captured from a camera) and may also use information obtained from other sources (e.g., from a GPS unit, a speed sensor, an accelerometer, a suspension sensor, a LIDAR, a RADAR, etc.).

To make real-time decisions regarding navigation, speed control, and/or steering, an autonomous vehicle relying on visual information must extract or derive useful data from the captured images. This process involves obtaining information, such as the 3D position and/or relative velocity of various features within a scene in the host vehicle environment. For example, the vehicle's navigation system might need to identify the location of a pedestrian, calculate the speed at which another car is moving, and/or estimate the size of an obstacle, among many other tasks. These details allow the vehicle navigation system to accurately assess the environment of the host vehicle, predict movements of other objects, and make informed decisions to navigate safely. Therefore, there is a need for an autonomous vehicle to have the capability to extract and derive information from captured images.

The present disclosure describes solutions that enable improved autonomous navigation relative to a road segment. The disclosed embodiments include innovative systems, methods, and non-transitory computer-readable media for deriving valuable information from captured images.

### SUMMARY

Embodiments consistent with the present disclosure provide systems and methods for autonomous vehicle navigation. The disclosed embodiments may use cameras to provide autonomous vehicle navigation features. For example, consistent with the disclosed embodiments, the disclosed systems may include one, two, or more cameras that monitor the environment of a vehicle. The disclosed systems may provide a navigational response based on, for example, an analysis of images captured by one or more of the cameras.

In an embodiment, a system for navigating a host vehicle relative to a road segment is disclosed. The system may comprise at least one processor comprising circuitry and a memory, wherein the memory includes instructions that when executed by the circuitry cause the at least one processor to: receive a captured image acquired by a camera onboard the host vehicle; based on analysis of the image, generate image height information including a predicted height value for each of a first plurality of pixels included in the captured image, the predicted height value for each of the first plurality of pixels being indicative of height above a ground surface; based on analysis of the image, generate image range information, including a predicted range value for each of a second plurality of pixels included in the captured image, the predicted range value for each of the second plurality of pixels being indicative of distance relative to the camera; and determine a navigational action for the host vehicle based on at least one of the image height information or the image range information.

In another embodiment, a method for navigating a host vehicle relative to a road segment is disclosed. The method may comprise: receiving a captured image acquired by a camera onboard the host vehicle; based on analysis of the image, generating image height information including a predicted height value for each of a first plurality of pixels included in the captured image, the predicted height value for each of the first plurality of pixels being indicative of height above a ground surface; based on analysis of the image, generating image range information, including a predicted range value for each of a second plurality of pixels included in the captured image, the predicted range value for each of the second plurality of pixels being indicative of distance relative to the camera; and determining a navigational action for the host vehicle based on at least one of the image height information or the image range information.

In yet another embodiment, a system for navigating a host vehicle relative to a road segment is disclosed. The system may comprise at least one processor comprising circuitry and a memory, wherein the memory includes instructions that when executed by the circuitry cause the at least one processor to: receive a first image frame acquired at a first time by a camera onboard the host vehicle; receive a second image frame acquired at a second time by the camera onboard the host vehicle, wherein the second time is later than the first time; based on analysis of the second image frame, generate a point cloud of 3D points for the second image frame, wherein the generated point cloud includes at least a range value for each of a plurality of pixels included in the second image frame, the range value for each of the plurality of pixels being indicative of distance between the camera and one or more objects in an environment of the host vehicle; generate a test image frame based on the 3D points included in the generated point cloud and known ego-motion characteristics of the host vehicle from the first time to the second time; compare the test image frame to the first image frame; determine movement information associated with at least one object represented in the first image frame based on the comparison of the test image frame to the first image frame; and generate a navigational action for the host vehicle based on the determined movement information.

In yet another embodiment, a method for navigating a host vehicle relative to a road segment is disclosed. The method may comprise: receiving a first image frame acquired at a first time by a camera onboard the host vehicle; receiving a second image frame acquired at a second time by the camera onboard the host vehicle, wherein the second time is later than the first time; based on analysis of the second image frame, generating a point cloud of 3D points for the second image frame, wherein the generated point cloud includes at least a range value for each of a plurality of pixels included in the second image frame, the range value for each of the plurality of pixels being indicative of distance between the camera and one or more objects in an environment of the host vehicle; generating a test image frame based on the 3D points included in the generated point cloud and known ego-motion characteristics of the host vehicle from the first time to the second time; comparing the test image frame to the first image frame; determining movement information associated with at least one object represented in the first image frame based on the comparison of the test image frame to the first image frame; and generating a navigational action for the host vehicle based on the determined movement information.

In yet another embodiment, a system for navigating a host vehicle relative to a road segment is disclosed. The system may comprise at least one processor comprising circuitry and a memory, wherein the memory includes instructions that when executed by the circuitry cause the at least one processor to: receive a captured image acquired by a camera onboard the host vehicle; based on analysis of the captured image, identify at least one object represented in the captured image; determine a bounding box associated with the at least one object represented in the captured image; generate a plurality of three-dimensional locators indicative of a location in real world coordinates of the determined bounding box; generate a navigational action for the host vehicle based on the determined plurality of three-dimensional locators; and cause at least one actuator associated with the host vehicle to implement the navigational action.

In yet another embodiment, a method for navigating a host vehicle relative to a road segment is disclosed. The method may comprise: receiving a captured image acquired by a camera onboard the host vehicle; based on analysis of the captured image, identifying at least one object represented in the captured image; determining a bounding box associated with the at least one object represented in the captured image; generating a plurality of three-dimensional locators indicative of a location in real world coordinates of the determined bounding box; generating a navigational action for the host vehicle based on the determined plurality of three-dimensional locators; and causing at least one actuator associated with the host vehicle to implement the navigational action.

Consistent with other disclosed embodiments, non-transitory computer-readable storage media may store program instructions, which are executed by at least one processing device and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation of an exemplary system consistent with the disclosed embodiments.

FIG. 2A is a diagrammatic side view representation of an exemplary vehicle including a system consistent with the disclosed embodiments.

FIG. 2B is a diagrammatic top view representation of the vehicle and system shown in FIG. 2A consistent with the disclosed embodiments.

FIG. 2C is a diagrammatic top view representation of another embodiment of a vehicle including a system consistent with the disclosed embodiments.

FIG. 2D is a diagrammatic top view representation of yet another embodiment of a vehicle including a system consistent with the disclosed embodiments.

FIG. 2E is a diagrammatic top view representation of yet another embodiment of a vehicle including a system consistent with the disclosed embodiments.

FIG. 2F is a diagrammatic representation of exemplary vehicle control systems consistent with the disclosed embodiments.

FIG. 3A is a diagrammatic representation of an interior of a vehicle including a rearview mirror and a user interface for a vehicle imaging system consistent with the disclosed embodiments.

FIG. 3B is an illustration of an example of a camera mount that is configured to be positioned behind a rearview mirror and against a vehicle windshield consistent with the disclosed embodiments.

FIG. 3C is an illustration of the camera mount shown in FIG. 3B from a different perspective consistent with the disclosed embodiments.

FIG. 3D is an illustration of an example of a camera mount that is configured to be positioned behind a rearview mirror and against a vehicle windshield consistent with the disclosed embodiments.

FIG. 4 is an exemplary block diagram of a memory configured to store instructions for performing one or more operations consistent with the disclosed embodiments.

FIG. 5A is a flowchart showing an exemplary process for causing one or more navigational responses based on monocular image analysis consistent with disclosed embodiments.

FIG. 5B is a flowchart showing an exemplary process for detecting one or more vehicles and/or pedestrians in a set of images consistent with the disclosed embodiments.

FIG. 5C is a flowchart showing an exemplary process for detecting road marks and/or lane geometry information in a set of images consistent with the disclosed embodiments.

FIG. 5D is a flowchart showing an exemplary process for detecting traffic lights in a set of images consistent with the disclosed embodiments.

FIG. 5E is a flowchart showing an exemplary process for causing one or more navigational responses based on a vehicle path consistent with the disclosed embodiments.

FIG. 5F is a flowchart showing an exemplary process for determining whether a leading vehicle is changing lanes consistent with the disclosed embodiments.

FIG. 6 is a flowchart showing an exemplary process for causing one or more navigational responses based on stereo image analysis consistent with the disclosed embodiments.

FIG. 7 is a flowchart showing an exemplary process for causing one or more navigational responses based on an analysis of three sets of images consistent with the disclosed embodiments.

FIG. 8 illustrates an exemplary vehicle consistent with disclosed embodiments.

FIG. 9 illustrates an exemplary vehicle consistent with disclosed embodiments.

FIG. 10 is a flowchart showing an exemplary process for determining a navigational action for a host vehicle consistent with disclosed embodiments.

FIG. 11 is a flowchart showing an exemplary process for navigating a host vehicle relative to a road segment, consistent with the disclosed embodiments.

FIG. 12 is an illustration of an exemplary trained neural network, consistent with the disclosed embodiments.

FIG. 13A is an illustration of an exemplary image captured by a camera embarked in a host vehicle, consistent with the disclosed embodiments.

FIG. 13B is an illustration of another exemplary image captured by a camera embarked in a host vehicle, consistent with the disclosed embodiments.

FIG. 14 is a flowchart showing an exemplary process for navigating a host vehicle relative to a road segment, consistent with the disclosed embodiments.

FIG. 15A is an illustration of an exemplary image frame captured by a camera embarked in a host vehicle at a first time, consistent with the disclosed embodiments.

FIG. 15B is an illustration of an exemplary image frame captured by a camera embarked in a host vehicle at a second time later than the firs time, consistent with the disclosed embodiments.

FIG. 16 is an illustration of an exemplary point cloud of 3D points generated based on the analysis of the exemplary image frame of FIG. 15, consistent with the disclosed embodiments.

FIG. 17 is an illustration of an exemplary test image frame generated based on the point cloud of FIG. 16 and ego-motion characteristics of the host vehicle, consistent with the disclosed embodiments.

FIG. 18 is an illustration providing a comparison of the exemplary image frame of FIG. 15A to the exemplary test image frame of FIG. 17, consistent with the disclosed embodiments.

FIG. 19 is a flowchart showing an exemplary process for navigating a host vehicle relative to a road segment, consistent with the disclosed embodiments.

FIG. 20A is an illustration of an exemplary image captured by a camera embarked in a host vehicle, consistent with the disclosed embodiments.

FIG. 20B is an illustration of an exemplary image corresponding to the captured image of FIG. 20A further featuring bounding boxes associated with objects identified in the captured image of FIG. 20A, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Autonomous Vehicle Overview

As used throughout this disclosure, the term “autonomous vehicle” refers to a vehicle capable of implementing at least one navigational change without driver input. A “navigational change” refers to a change in one or more of steering, braking, or acceleration of the vehicle. To be autonomous, a vehicle need not be fully automatic (e.g., fully operation without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints), but may leave other aspects to the driver (e.g., braking). In some cases, autonomous vehicles may handle some or all aspects of braking, speed control, and/or steering of the vehicle.

As human drivers typically rely on visual cues and observations to control a vehicle, transportation infrastructures are built accordingly, with lane markings, traffic signs, and traffic lights are all designed to provide visual information to drivers. In view of these design characteristics of transportation infrastructures, an autonomous vehicle may include a camera and a processing unit that analyzes visual information captured from the environment of the vehicle. The visual information may include, for example, components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while the vehicle is traveling, and the vehicle (as well as other vehicles) may use the information to localize itself on the model.

In some embodiments in this disclosure, an autonomous vehicle may use information obtained while navigating (e.g., from a camera, GPS device, an accelerometer, a speed sensor, a suspension sensor, etc.). In other embodiments, an autonomous vehicle may use information obtained from past navigations by the vehicle (or by other vehicles) while navigating. In yet other embodiments, an autonomous vehicle may use a combination of information obtained while navigating and information obtained from past navigations. The following sections provide an overview of a system consistent with the disclosed embodiments, followed by an overview of a forward-facing imaging system and methods consistent with the system. The sections that follow disclose systems and methods for constructing, using, and updating a sparse map for autonomous vehicle navigation.

### System Overview

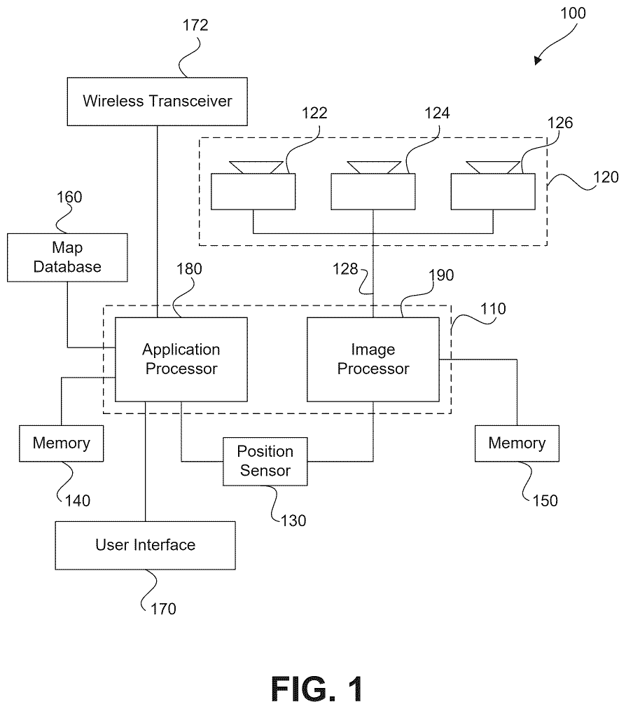

FIG. 1 is a block diagram representation of a system 100 consistent with the exemplary disclosed embodiments. System 100 may include various components depending on the requirements of a particular implementation. In some embodiments, system 100 may include a processing unit 110, an image acquisition unit 120, a position sensor 130, one or more memory units 140, 150, a map database 160, a user interface 170, and a wireless transceiver 172.

Processing unit 110 may include one or more processing devices. In some embodiments, processing unit 110 may include an applications processor 180, an image processor 190, or any other suitable processing device. Similarly, image acquisition unit 120 may include any number of image acquisition devices and components depending on the requirements of a particular application. In some embodiments, image acquisition unit 120 may include one or more image capture devices (e.g., cameras), such as image capture device 122, image capture device 124, and image capture device 126. System 100 may also include a data interface 128 communicatively connecting processing device 110 to image acquisition device 120. For example, data interface 128 may include any wired and/or wireless link or links for transmitting image data acquired by image accusation device 120 to processing unit 110.

Wireless transceiver 172 may include one or more devices configured to exchange transmissions over an air interface to one or more networks (e.g., cellular, the Internet, etc.) by use of a radio frequency, infrared frequency, magnetic field, or an electric field. Wireless transceiver 172 may use any known standard to transmit and/or receive data (e.g., Wi-Fi, Bluetooth®, Bluetooth Smart, 802.15.4, ZigBee, etc.). Such transmissions can include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 180 and image processor 190 may include various types of processing devices. For example, either or both of applications processor 180 and image processor 190 may include a microprocessor, preprocessors (such as an image preprocessor), a graphics processing unit (GPU), a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures (e.g., x86 processor, ARM®, etc.).

In some embodiments, applications processor 180 and/or image processor 190 may include any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture consists of two floating point, hyper-thread 32-bit RISC CPUs (MIPS32® 34K® cores), five Vision Computing Engines (VCE), three Vector Microcode Processors (VMP®) , Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMPTM and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third generation processor and is six times more powerful that the EyeQ2®, may be used in the disclosed embodiments. In other examples, the EyeQ4® and/or the EyeQ5® may be used in the disclosed embodiments. Of course, any newer or future EyeQ processing devices may also be used together with the disclosed embodiments.

Any of the processing devices disclosed herein may be configured to perform certain functions. Configuring a processing device, such as any of the described EyeQ processors or other controller or microprocessor, to perform certain functions may include programming of computer executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware based components of a host vehicle.

While FIG. 1 depicts two separate processing devices included in processing unit 110, more or fewer processing devices may be used. For example, in some embodiments, a single processing device may be used to accomplish the tasks of applications processor 180 and image processor 190. In other embodiments, these tasks may be performed by more than two processing devices. Further, in some embodiments, system 100 may include one or more of processing unit 110 without including other components, such as image acquisition unit 120.

Processing unit 110 may comprise various types of devices. For example, processing unit 110 may include various devices, such as a controller, an image preprocessor, a central processing unit (CPU), a graphics processing unit (GPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The GPU may also comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing unit 110. In another instance, the memory may be integrated into the processing unit 110.

Each memory 140, 150 may include software instructions that when executed by a processor (e.g., applications processor 180 and/or image processor 190), may control operation of various aspects of system 100. These memory units may include various databases and image processing software, as well as a trained system, such as a neural network, or a deep neural network, for example. The memory units may include random access memory (RAM), read only memory (ROM), flash memory, disk drives, optical storage, tape storage, removable storage and/or any other types of storage. In some embodiments, memory units 140, 150 may be separate from the applications processor 180 and/or image processor 190. In other embodiments, these memory units may be integrated into applications processor 180 and/or image processor 190.

Position sensor 130 may include any type of device suitable for determining a location associated with at least one component of system 100. In some embodiments, position sensor 130 may include a GPS receiver. Such receivers can determine a user position and velocity by processing signals broadcasted by global positioning system satellites. Position information from position sensor 130 may be made available to applications processor 180 and/or image processor 190.

In some embodiments, system 100 may include components such as a speed sensor (e.g., a tachometer, a speedometer) for measuring a speed of vehicle 200 and/or an accelerometer (either single axis or multiaxis) for measuring acceleration of vehicle 200.

User interface 170 may include any device suitable for providing information to or for receiving inputs from one or more users of system 100. In some embodiments, user interface 170 may include user input devices, including, for example, a touchscreen, microphone, keyboard, pointer devices, track wheels, cameras, knobs, buttons, etc. With such input devices, a user may be able to provide information inputs or commands to system 100 by typing instructions or information, providing voice commands, selecting menu options on a screen using buttons, pointers, or eye-tracking capabilities, or through any other suitable techniques for communicating information to system 100.

User interface 170 may be equipped with one or more processing devices configured to provide and receive information to or from a user and process that information for use by, for example, applications processor 180. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 170 may include a display, speaker, tactile device, and/or any other devices for providing output information to a user.

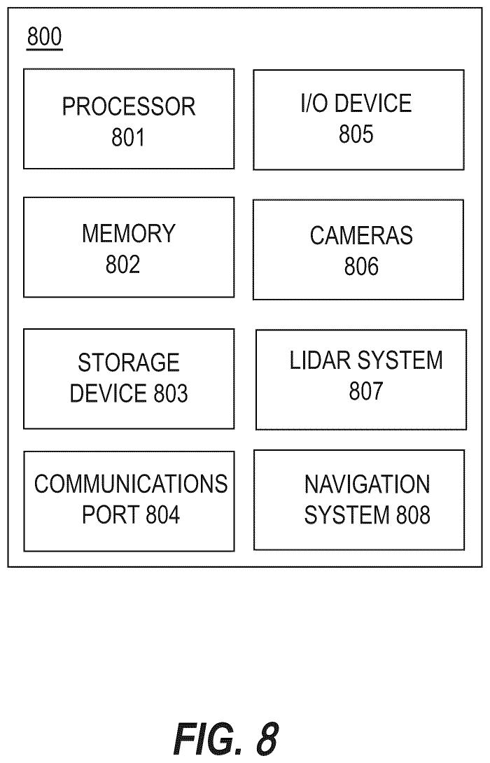

Map database 160 may include any type of database for storing map data useful to system 100. In some embodiments, map database 160 may include data relating to the position, in a reference coordinate system, of various items, including roads, water features, geographic features, businesses, points of interest, restaurants, gas stations, etc. Map database 160 may store not only the locations of such items, but also descriptors relating to those items, including, for example, names associated with any of the stored features. In some embodiments, map database 160 may be physically located with other components of system 100. Alternatively or additionally, map database 160 or a portion thereof may be located remotely with respect to other components of system 100 (e.g., processing unit 110). In such embodiments, information from map database 160 may be downloaded over a wired or wireless data connection to a network (e.g., over a cellular network and/or the Internet, etc.). In some cases, map database 160 may store a sparse data model including polynomial representations of certain road features (e.g., lane markings) or target trajectories for the host vehicle. Systems and methods of generating such a map are discussed below with references to FIGS. 8-19.

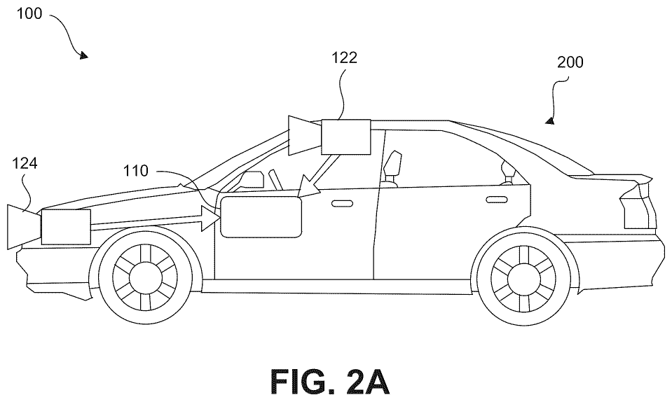

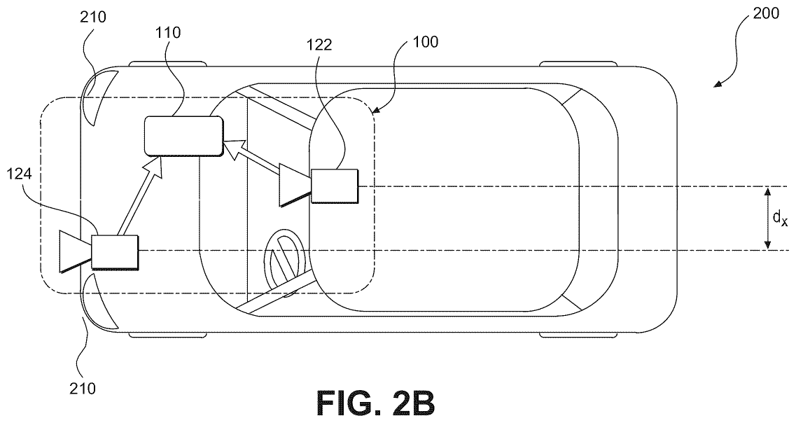

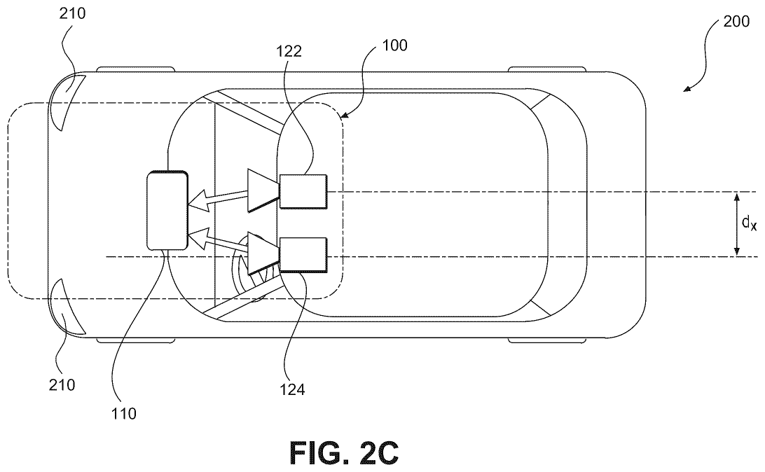

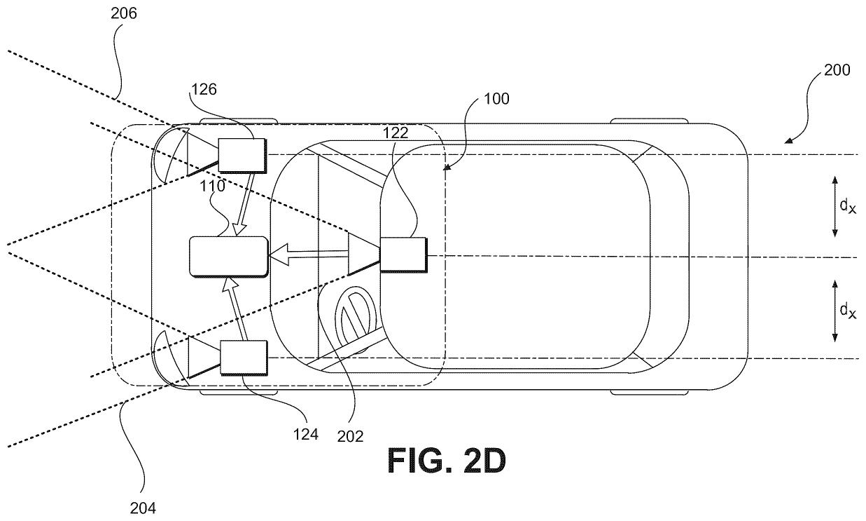

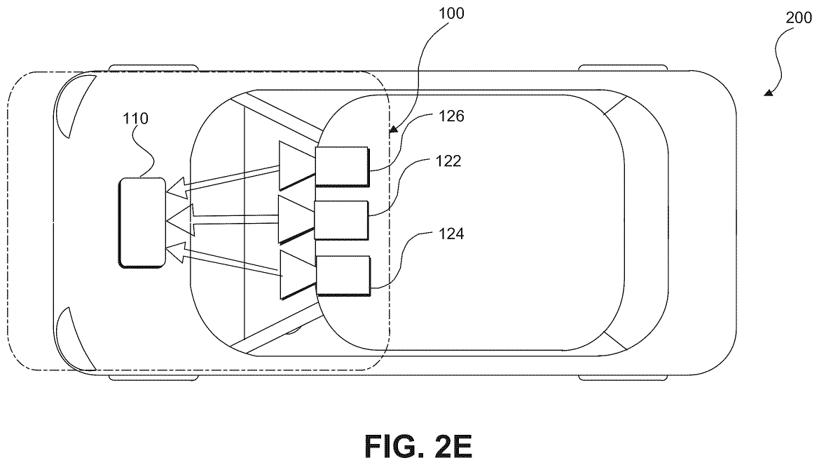

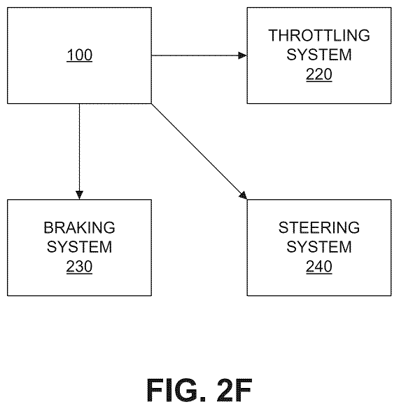

Image capture devices 122, 124, and 126 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 122, 124, and 126 will be further described with reference to FIGS. 2B-2E, below.

System 100, or various components thereof, may be incorporated into various different platforms. In some embodiments, system 100 may be included on a vehicle 200, as shown in FIG. 2A. For example, vehicle 200 may be equipped with a processing unit 110 and any of the other components of system 100, as described above relative to FIG. 1. While in some embodiments vehicle 200 may be equipped with only a single image capture device (e.g., camera), in other embodiments, such as those discussed in connection with FIGS. 2B-2E, multiple image capture devices may be used. For example, either of image capture devices 122 and 124 of vehicle 200, as shown in FIG. 2A, may be part of an ADAS (Advanced Driver Assistance Systems) imaging set.

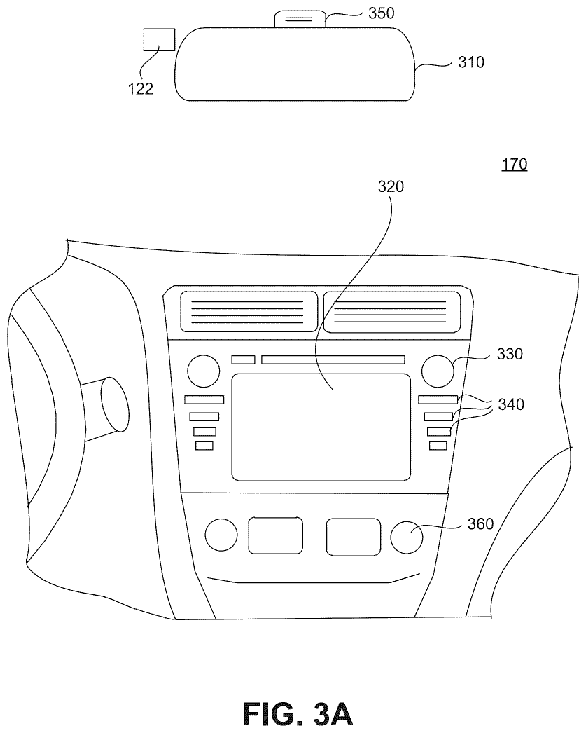

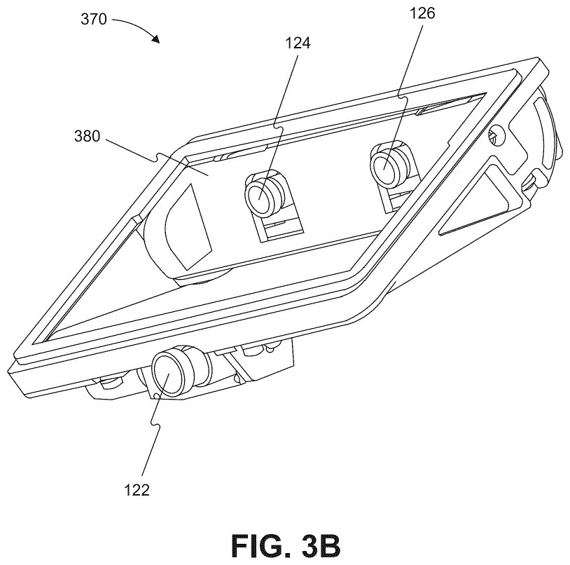

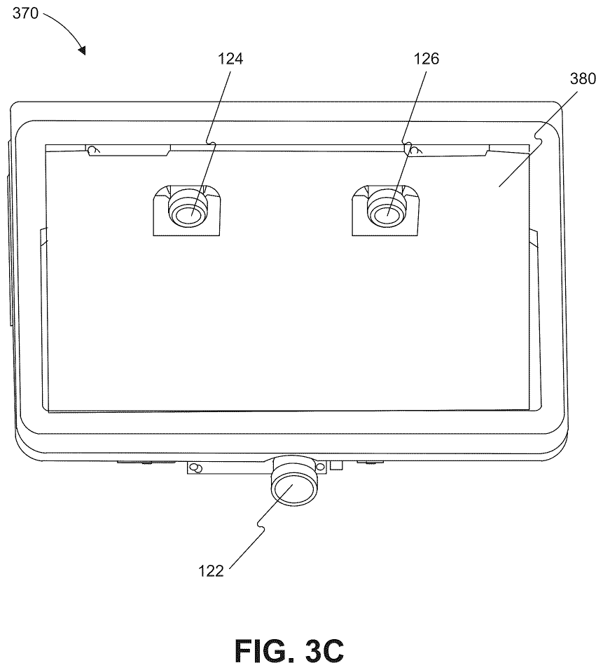

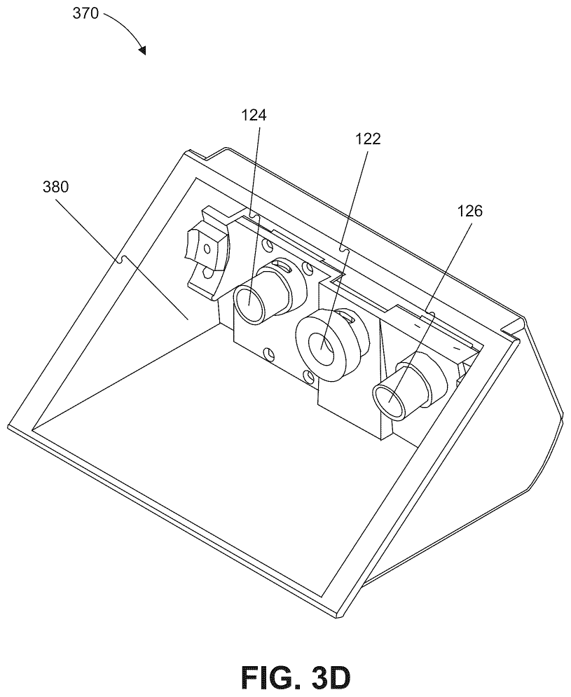

The image capture devices included on vehicle 200 as part of the image acquisition unit 120 may be positioned at any suitable location. In some embodiments, as shown in FIGS. 2A-2E and 3A-3C, image capture device 122 may be located in the vicinity of the rearview mirror. This position may provide a line of sight similar to that of the driver of vehicle 200, which may aid in determining what is and is not visible to the driver. Image capture device 122 may be positioned at any location near the rearview mirror, but placing image capture device 122 on the driver side of the mirror may further aid in obtaining images representative of the driver's field of view and/or line of sight.

Other locations for the image capture devices of image acquisition unit 120 may also be used. For example, image capture device 124 may be located on or in a bumper of vehicle 200. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 122, 124, and 126) may also be located in other locations. For example, the image capture devices may be located on or in one or both of the side mirrors of vehicle 200, on the roof of vehicle 200, on the hood of vehicle 200, on the trunk of vehicle 200, on the sides of vehicle 200, mounted on, positioned behind, or positioned in front of any of the windows of vehicle 200, and mounted in or near light figures on the front and/or back of vehicle 200, etc.

In addition to image capture devices, vehicle 200 may include various other components of system 100. For example, processing unit 110 may be included on vehicle 200 either integrated with or separate from an engine control unit (ECU) of the vehicle. Vehicle 200 may also be equipped with a position sensor 130, such as a GPS receiver and may also include a map database 160 and memory units 140 and 150.

As discussed earlier, wireless transceiver 172 may and/or receive data over one or more networks (e.g., cellular networks, the Internet, etc.). For example, wireless transceiver 172 may upload data collected by system 100 to one or more servers, and download data from the one or more servers. Via wireless transceiver 172, system 100 may receive, for example, periodic or on demand updates to data stored in map database 160, memory 140, and/or memory 150. Similarly, wireless transceiver 172 may upload any data (e.g., images captured by image acquisition unit 120, data received by position sensor 130 or other sensors, vehicle control systems, etc.) from by system 100 and/or any data processed by processing unit 110 to the one or more servers.

System 100 may upload data to a server (e.g., to the cloud) based on a privacy level setting. For example, system 100 may implement privacy level settings to regulate or limit the types of data (including metadata) sent to the server that may uniquely identify a vehicle and or driver/owner of a vehicle. Such settings may be set by user via, for example, wireless transceiver 172, be initialized by factory default settings, or by data received by wireless transceiver 172.

In some embodiments, system 100 may upload data according to a “high” privacy level, and under setting a setting, system 100 may transmit data (e.g., location information related to a route, captured images, etc.) without any details about the specific vehicle and/or driver/owner. For example, when uploading data according to a “high” privacy setting, system 100 may not include a vehicle identification number (VIN) or a name of a driver or owner of the vehicle, and may instead of transmit data, such as captured images and/or limited location information related to a route.

Other privacy levels are contemplated. For example, system 100 may transmit data to a server according to an “intermediate” privacy level and include additional information not included under a “high” privacy level, such as a make and/or model of a vehicle and/or a vehicle type (e.g., a passenger vehicle, sport utility vehicle, truck, etc.). In some embodiments, system 100 may upload data according to a “low” privacy level. Under a “low” privacy level setting, system 100 may upload data and include information sufficient to uniquely identify a specific vehicle, owner/driver, and/or a portion or entirely of a route traveled by the vehicle. Such “low” privacy level data may include one or more of, for example, a VIN, a driver/owner name, an origination point of a vehicle prior to departure, an intended destination of the vehicle, a make and/or model of the vehicle, a type of the vehicle, etc.

FIG. 2A is a diagrammatic side view representation of an exemplary vehicle imaging system consistent with the disclosed embodiments. FIG. 2B is a diagrammatic top view illustration of the embodiment shown in FIG. 2A. As illustrated in FIG. 2B, the disclosed embodiments may include a vehicle 200 including in its body a system 100 with a first image capture device 122 positioned in the vicinity of the rearview mirror and/or near the driver of vehicle 200, a second image capture device 124 positioned on or in a bumper region (e.g., one of bumper regions 210) of vehicle 200, and a processing unit 110.

As illustrated in FIG. 2C, image capture devices 122 and 124 may both be positioned in the vicinity of the rearview mirror and/or near the driver of vehicle 200. Additionally, while two image capture devices 122 and 124 are shown in FIGS. 2B and 2C, it should be understood that other embodiments may include more than two image capture devices. For example, in the embodiments shown in FIGS. 2D and 2E, first, second, and third image capture devices 122, 124, and 126, are included in the system 100 of vehicle 200.

As illustrated in FIG. 2D, image capture device 122 may be positioned in the vicinity of the rearview mirror and/or near the driver of vehicle 200, and image capture devices 124 and 126 may be positioned on or in a bumper region (e.g., one of bumper regions 210) of vehicle 200. And as shown in FIG. 2E, image capture devices 122, 124, and 126 may be positioned in the vicinity of the rearview mirror and/or near the driver seat of vehicle 200. The disclosed embodiments are not limited to any particular number and configuration of the image capture devices, and the image capture devices may be positioned in any appropriate location within and/or on vehicle 200.

It is to be understood that the disclosed embodiments are not limited to vehicles and could be applied in other contexts. It is also to be understood that disclosed embodiments are not limited to a particular type of vehicle 200 and may be applicable to all types of vehicles including automobiles, trucks, trailers, and other types of vehicles.

The first image capture device 122 may include any suitable type of image capture device. Image capture device 122 may include an optical axis. In one instance, the image capture device 122 may include an Aptina M9V024 WVGA sensor with a global shutter. In other embodiments, image capture device 122 may provide a resolution of 1280×960 pixels and may include a rolling shutter. Image capture device 122 may include various optical elements. In some embodiments one or more lenses may be included, for example, to provide a desired focal length and field of view for the image capture device. In some embodiments, image capture device 122 may be associated with a 6 mm lens or a 12 mm lens. In some embodiments, image capture device 122 may be configured to capture images having a desired field-of-view (FOV) 202, as illustrated in FIG. 2D. For example, image capture device 122 may be configured to have a regular FOV, such as within a range of 40 degrees to 56 degrees, including a 46 degree FOV, 50 degree FOV, 52 degree FOV, or greater. Alternatively, image capture device 122 may be configured to have a narrow FOV in the range of 23 to 40 degrees, such as a 28 degree FOV or 36 degree FOV. In addition, image capture device 122 may be configured to have a wide FOV in the range of 100 to 180 degrees. In some embodiments, image capture device 122 may include a wide angle bumper camera or one with up to a 180 degree FOV. In some embodiments, image capture device 122 may be a 7.2 M pixel image capture device with an aspect ratio of about 2:1 (e.g., HxV=3800×1900 pixels) with about 100 degree horizontal FOV. Such an image capture device may be used in place of a three image capture device configuration. Due to significant lens distortion, the vertical FOV of such an image capture device may be significantly less than 50 degrees in implementations in which the image capture device uses a radially symmetric lens. For example, such a lens may not be radially symmetric which would allow for a vertical FOV greater than 50 degrees with 100 degree horizontal FOV.

The first image capture device 122 may acquire a plurality of first images relative to a scene associated with the vehicle 200. Each of the plurality of first images may be acquired as a series of image scan lines, which may be captured using a rolling shutter. Each scan line may include a plurality of pixels.

The first image capture device 122 may have a scan rate associated with acquisition of each of the first series of image scan lines. The scan rate may refer to a rate at which an image sensor can acquire image data associated with each pixel included in a particular scan line.

Image capture devices 122, 124, and 126 may contain any suitable type and number of image sensors, including CCD sensors or CMOS sensors, for example. In one embodiment, a CMOS image sensor may be employed along with a rolling shutter, such that each pixel in a row is read one at a time, and scanning of the rows proceeds on a row-by-row basis until an entire image frame has been captured. In some embodiments, the rows may be captured sequentially from top to bottom relative to the frame.

In some embodiments, one or more of the image capture devices (e.g., image capture devices 122, 124, and 126) disclosed herein may constitute a high resolution imager and may have a resolution greater than 5M pixel, 7M pixel, 10M pixel, or greater.

The use of a rolling shutter may result in pixels in different rows being exposed and captured at different times, which may cause skew and other image artifacts in the captured image frame. On the other hand, when the image capture device 122 is configured to operate with a global or synchronous shutter, all of the pixels may be exposed for the same amount of time and during a common exposure period. As a result, the image data in a frame collected from a system employing a global shutter represents a snapshot of the entire FOV (such as FOV 202) at a particular time. In contrast, in a rolling shutter application, each row in a frame is exposed and data is capture at different times. Thus, moving objects may appear distorted in an image capture device having a rolling shutter. This phenomenon will be described in greater detail below.

The second image capture device 124 and the third image capturing device 126 may be any type of image capture device. Like the first image capture device 122, each of image capture devices 124 and 126 may include an optical axis. In one embodiment, each of image capture devices 124 and 126 may include an Aptina M9V024 WVGA sensor with a global shutter. Alternatively, each of image capture devices 124 and 126 may include a rolling shutter. Like image capture device 122, image capture devices 124 and 126 may be configured to include various lenses and optical elements. In some embodiments, lenses associated with image capture devices 124 and 126 may provide FOVs (such as FOVs 204 and 206) that are the same as, or narrower than, a FOV (such as FOV 202) associated with image capture device 122. For example, image capture devices 124 and 126 may have FOVs of 40 degrees, 30 degrees, 26 degrees, 23 degrees, 20 degrees, or less.

Image capture devices 124 and 126 may acquire a plurality of second and third images relative to a scene associated with the vehicle 200. Each of the plurality of second and third images may be acquired as a second and third series of image scan lines, which may be captured using a rolling shutter. Each scan line or row may have a plurality of pixels. Image capture devices 124 and 126 may have second and third scan rates associated with acquisition of each of image scan lines included in the second and third series.

Each image capture device 122, 124, and 126 may be positioned at any suitable position and orientation relative to vehicle 200. The relative positioning of the image capture devices 122, 124, and 126 may be selected to aid in fusing together the information acquired from the image capture devices. For example, in some embodiments, a FOV (such as FOV 204) associated with image capture device 124 may overlap partially or fully with a FOV (such as FOV 202) associated with image capture device 122 and a FOV (such as FOV 206) associated with image capture device 126.

Image capture devices 122, 124, and 126 may be located on vehicle 200 at any suitable relative heights. In one instance, there may be a height difference between the image capture devices 122, 124, and 126, which may provide sufficient parallax information to enable stereo analysis. For example, as shown in FIG. 2A, the two image capture devices 122 and 124 are at different heights. There may also be a lateral displacement difference between image capture devices 122, 124, and 126, giving additional parallax information for stereo analysis by processing unit 110, for example. The difference in the lateral displacement may be denoted by dx, as shown in FIGS. 2C and 2D. In some embodiments, fore or aft displacement (e.g., range displacement) may exist between image capture devices 122, 124, and 126. For example, image capture device 122 may be located 0.5 to 2 meters or more behind image capture device 124 and/or image capture device 126. This type of displacement may enable one of the image capture devices to cover potential blind spots of the other image capture device(s).

Image capture devices 122 may have any suitable resolution capability (e.g., number of pixels associated with the image sensor), and the resolution of the image sensor(s) associated with the image capture device 122 may be higher, lower, or the same as the resolution of the image sensor(s) associated with image capture devices 124 and 126. In some embodiments, the image sensor(s) associated with image capture device 122 and/or image capture devices 124 and 126 may have a resolution of 640×480, 1024×768, 1280×960, or any other suitable resolution.

The frame rate (e.g., the rate at which an image capture device acquires a set of pixel data of one image frame before moving on to capture pixel data associated with the next image frame) may be controllable. The frame rate associated with image capture device 122 may be higher, lower, or the same as the frame rate associated with image capture devices 124 and 126. The frame rate associated with image capture devices 122, 124, and 126 may depend on a variety of factors that may affect the timing of the frame rate. For example, one or more of image capture devices 122, 124, and 126 may include a selectable pixel delay period imposed before or after acquisition of image data associated with one or more pixels of an image sensor in image capture device 122, 124, and/or 126. Generally, image data corresponding to each pixel may be acquired according to a clock rate for the device (e.g., one pixel per clock cycle). Additionally, in embodiments including a rolling shutter, one or more of image capture devices 122, 124, and 126 may include a selectable horizontal blanking period imposed before or after acquisition of image data associated with a row of pixels of an image sensor in image capture device 122, 124, and/or 126. Further, one or more of image capture devices 122, 124, and/or 126 may include a selectable vertical blanking period imposed before or after acquisition of image data associated with an image frame of image capture device 122, 124, and 126.

These timing controls may enable synchronization of frame rates associated with image capture devices 122, 124, and 126, even where the line scan rates of each are different. Additionally, as will be discussed in greater detail below, these selectable timing controls, among other factors (e.g., image sensor resolution, maximum line scan rates, etc.) may enable synchronization of image capture from an area where the FOV of image capture device 122 overlaps with one or more FOVs of image capture devices 124 and 126, even where the field of view of image capture device 122 is different from the FOVs of image capture devices 124 and 126.

Frame rate timing in image capture device 122, 124, and 126 may depend on the resolution of the associated image sensors. For example, assuming similar line scan rates for both devices, if one device includes an image sensor having a resolution of 640×480 and another device includes an image sensor with a resolution of 1280×960, then more time will be required to acquire a frame of image data from the sensor having the higher resolution.

Another factor that may affect the timing of image data acquisition in image capture devices 122, 124, and 126 is the maximum line scan rate. For example, acquisition of a row of image data from an image sensor included in image capture device 122, 124, and 126 will require some minimum amount of time. Assuming no pixel delay periods are added, this minimum amount of time for acquisition of a row of image data will be related to the maximum line scan rate for a particular device. Devices that offer higher maximum line scan rates have the potential to provide higher frame rates than devices with lower maximum line scan rates. In some embodiments, one or more of image capture devices 124 and 126 may have a maximum line scan rate that is higher than a maximum line scan rate associated with image capture device 122. In some embodiments, the maximum line scan rate of image capture device 124 and/or 126 may be 1.25, 1.5, 1.75, or 2 times or more than a maximum line scan rate of image capture device 122.

In another embodiment, image capture devices 122, 124, and 126 may have the same maximum line scan rate, but image capture device 122 may be operated at a scan rate less than or equal to its maximum scan rate. The system may be configured such that one or more of image capture devices 124 and 126 operate at a line scan rate that is equal to the line scan rate of image capture device 122. In other instances, the system may be configured such that the line scan rate of image capture device 124 and/or image capture device 126 may be 1.25, 1.5, 1.75, or 2 times or more than the line scan rate of image capture device 122.

In some embodiments, image capture devices 122, 124, and 126 may be asymmetric. That is, they may include cameras having different fields of view (FOV) and focal lengths. The fields of view of image capture devices 122, 124, and 126 may include any desired area relative to an environment of vehicle 200, for example. In some embodiments, one or more of image capture devices 122, 124, and 126 may be configured to acquire image data from an environment in front of vehicle 200, behind vehicle 200, to the sides of vehicle 200, or combinations thereof.

Further, the focal length associated with each image capture device 122, 124, and/or 126 may be selectable (e.g., by inclusion of appropriate lenses etc.) such that each device acquires images of objects at a desired distance range relative to vehicle 200. For example, in some embodiments image capture devices 122, 124, and 126 may acquire images of close-up objects within a few meters from the vehicle. Image capture devices 122, 124, and 126 may also be configured to acquire images of objects at ranges more distant from the vehicle (e.g., 25 m, 50 m, 100 m, 150 m, or more). Further, the focal lengths of image capture devices 122, 124, and 126 may be selected such that one image capture device (e.g., image capture device 122) can acquire images of objects relatively close to the vehicle (e.g., within 10 m or within 20 m) while the other image capture devices (e.g., image capture devices 124 and 126) can acquire images of more distant objects (e.g., greater than 20 m, 50 m, 100 m, 150 m, etc.) from vehicle 200.

According to some embodiments, the FOV of one or more image capture devices 122, 124, and 126 may have a wide angle. For example, it may be advantageous to have a FOV of 140 degrees, especially for image capture devices 122, 124, and 126 that may be used to capture images of the area in the vicinity of vehicle 200. For example, image capture device 122 may be used to capture images of the area to the right or left of vehicle 200 and, in such embodiments, it may be desirable for image capture device 122 to have a wide FOV (e.g., at least 140 degrees).

The field of view associated with each of image capture devices 122, 124, and 126 may depend on the respective focal lengths. For example, as the focal length increases, the corresponding field of view decreases.

Image capture devices 122, 124, and 126 may be configured to have any suitable fields of view. In one particular example, image capture device 122 may have a horizontal FOV of 46 degrees, image capture device 124 may have a horizontal FOV of 23 degrees, and image capture device 126 may have a horizontal FOV in between 23 and 46 degrees. In another instance, image capture device 122 may have a horizontal FOV of 52 degrees, image capture device 124 may have a horizontal FOV of 26 degrees, and image capture device 126 may have a horizontal FOV in between 26 and 52 degrees. In some embodiments, a ratio of the FOV of image capture device 122 to the FOVs of image capture device 124 and/or image capture device 126 may vary from 1.5 to 2.0. In other embodiments, this ratio may vary between 1.25 and 2.25.

System 100 may be configured so that a field of view of image capture device 122 overlaps, at least partially or fully, with a field of view of image capture device 124 and/or image capture device 126. In some embodiments, system 100 may be configured such that the fields of view of image capture devices 124 and 126, for example, fall within (e.g., are narrower than) and share a common center with the field of view of image capture device 122. In other embodiments, the image capture devices 122, 124, and 126 may capture adjacent FOVs or may have partial overlap in their FOVs. In some embodiments, the fields of view of image capture devices 122, 124, and 126 may be aligned such that a center of the narrower FOV image capture devices 124 and/or 126 may be located in a lower half of the field of view of the wider FOV device 122.

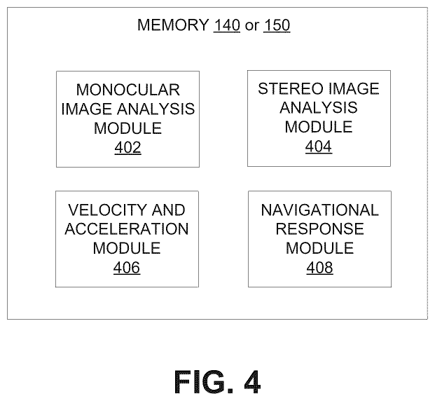

FIG. 2F is a diagrammatic representation of exemplary vehicle control systems, consistent with the disclosed embodiments. As indicated in FIG. 2F, vehicle 200 may include throttling system 220, braking system 230, and steering system 240. System 100 may provide inputs (e.g., control signals) to one or more of throttling system 220, braking system 230, and steering system 240 over one or more data links (e.g., any wired and/or wireless link or links for transmitting data). For example, based on analysis of images acquired by image capture devices 122, 124, and/or 126, system 100 may provide control signals to one or more of throttling system 220, braking system 230, and steering system 240 to navigate vehicle 200 (e.g., by causing an acceleration, a turn, a lane shift, etc.). Further, system 100 may receive inputs from one or more of throttling system 220, braking system 230, and steering system 24 indicating operating conditions of vehicle 200 (e.g., speed, whether vehicle 200 is braking and/or turning, etc.). Further details are provided in connection with FIGS. 4-7, below.

As shown in FIG. 3A, vehicle 200 may also include a user interface 170 for interacting with a driver or a passenger of vehicle 200. For example, user interface 170 in a vehicle application may include a touch screen 320, knobs 330, buttons 340, and a microphone 350. A driver or passenger of vehicle 200 may also use handles (e.g., located on or near the steering column of vehicle 200 including, for example, turn signal handles), buttons (e.g., located on the steering wheel of vehicle 200), and the like, to interact with system 100. In some embodiments, microphone 350 may be positioned adjacent to a rearview mirror 310. Similarly, in some embodiments, image capture device 122 may be located near rearview mirror 310. In some embodiments, user interface 170 may also include one or more speakers 360 (e.g., speakers of a vehicle audio system). For example, system 100 may provide various notifications (e.g., alerts) via speakers 360.

FIGS. 3B-3D are illustrations of an exemplary camera mount 370 configured to be positioned behind a rearview mirror (e.g., rearview mirror 310) and against a vehicle windshield, consistent with disclosed embodiments. As shown in FIG. 3B, camera mount 370 may include image capture devices 122, 124, and 126. Image capture devices 124 and 126 may be positioned behind a glare shield 380, which may be flush against the vehicle windshield and include a composition of film and/or anti-reflective materials. For example, glare shield 380 may be positioned such that the shield aligns against a vehicle windshield having a matching slope. In some embodiments, each of image capture devices 122, 124, and 126 may be positioned behind glare shield 380, as depicted, for example, in FIG. 3D. The disclosed embodiments are not limited to any particular configuration of image capture devices 122, 124, and 126, camera mount 370, and glare shield 380. FIG. 3C is an illustration of camera mount 370 shown in FIG. 3B from a front perspective.

As will be appreciated by a person skilled in the art having the benefit of this disclosure, numerous variations and/or modifications may be made to the foregoing disclosed embodiments. For example, not all components are essential for the operation of system 100. Further, any component may be located in any appropriate part of system 100 and the components may be rearranged into a variety of configurations while providing the functionality of the disclosed embodiments. Therefore, the foregoing configurations are examples and, regardless of the configurations discussed above, system 100 can provide a wide range of functionality to analyze the surroundings of vehicle 200 and navigate vehicle 200 in response to the analysis.

As discussed below in further detail and consistent with various disclosed embodiments, system 100 may provide a variety of features related to autonomous driving and/or driver assist technology. For example, system 100 may analyze image data, position data (e.g., GPS location information), map data, speed data, and/or data from sensors included in vehicle 200. System 100 may collect the data for analysis from, for example, image acquisition unit 120, position sensor 130, and other sensors. Further, system 100 may analyze the collected data to determine whether or not vehicle 200 should take a certain action, and then automatically take the determined action without human intervention. For example, when vehicle 200 navigates without human intervention, system 100 may automatically control the braking, acceleration, and/or steering of vehicle 200 (e.g., by sending control signals to one or more of throttling system 220, braking system 230, and steering system 240). Further, system 100 may analyze the collected data and issue warnings and/or alerts to vehicle occupants based on the analysis of the collected data. Additional details regarding the various embodiments that are provided by system 100 are provided below.

### Forward-Facing Multi-imaging System

As discussed above, system 100 may provide drive assist functionality that uses a multi-camera system. The multi-camera system may use one or more cameras facing in the forward direction of a vehicle. In other embodiments, the multi-camera system may include one or more cameras facing to the side of a vehicle or to the rear of the vehicle. In one embodiment, for example, system 100 may use a two-camera imaging system, where a first camera and a second camera (e.g., image capture devices 122 and 124) may be positioned at the front and/or the sides of a vehicle (e.g., vehicle 200). The first camera may have a field of view that is greater than, less than, or partially overlapping with, the field of view of the second camera. In addition, the first camera may be connected to a first image processor to perform monocular image analysis of images provided by the first camera, and the second camera may be connected to a second image processor to perform monocular image analysis of images provided by the second camera. The outputs (e.g., processed information) of the first and second image processors may be combined. In some embodiments, the second image processor may receive images from both the first camera and second camera to perform stereo analysis. In another embodiment, system 100 may use a three-camera imaging system where each of the cameras has a different field of view. Such a system may, therefore, make decisions based on information derived from objects located at varying distances both forward and to the sides of the vehicle. References to monocular image analysis may refer to instances where image analysis is performed based on images captured from a single point of view (e.g., from a single camera). Stereo image analysis may refer to instances where image analysis is performed based on two or more images captured with one or more variations of an image capture parameter. For example, captured images suitable for performing stereo image analysis may include images captured: from two or more different positions, from different fields of view, using different focal lengths, along with parallax information, etc.

For example, in one embodiment, system 100 may implement a three camera configuration using image capture devices 122, 124, and126. In such a configuration, image capture device 122 may provide a narrow field of view (e.g., 34 degrees, or other values selected from a range of about 20 to 45 degrees, etc.), image capture device 124 may provide a wide field of view (e.g., 150 degrees or other values selected from a range of about 100 to about 180 degrees), and image capture device 126 may provide an intermediate field of view (e.g., 46 degrees or other values selected from a range of about 35 to about 60 degrees). In some embodiments, image capture device 126 may act as a main or primary camera. Image capture devices 122, 124, and 126 may be positioned behind rearview mirror 310 and positioned substantially side-by-side (e.g., 6 cm apart). Further, in some embodiments, as discussed above, one or more of image capture devices 122, 124, and 126 may be mounted behind glare shield 380 that is flush with the windshield of vehicle 200. Such shielding may act to minimize the impact of any reflections from inside the car on image capture devices 122, 124, and 126.

In another embodiment, as discussed above in connection with FIGS. 3B and 3C, the wide field of view camera (e.g., image capture device 124 in the above example) may be mounted lower than the narrow and main field of view cameras (e.g., image devices 122 and 126 in the above example). This configuration may provide a free line of sight from the wide field of view camera. To reduce reflections, the cameras may be mounted close to the windshield of vehicle 200, and may include polarizers on the cameras to damp reflected light.

A three camera system may provide certain performance characteristics. For example, some embodiments may include an ability to validate the detection of objects by one camera based on detection results from another camera. In the three camera configuration discussed above, processing unit 110 may include, for example, three processing devices (e.g., three EyeQ series of processor chips, as discussed above), with each processing device dedicated to processing images captured by one or more of image capture devices 122, 124, and 126.

In a three camera system, a first processing device may receive images from both the main camera and the narrow field of view camera, and perform vision processing of the narrow FOV camera to, for example, detect other vehicles, pedestrians, lane marks, traffic signs, traffic lights, and other road objects. Further, the first processing device may calculate a disparity of pixels between the images from the main camera and the narrow camera and create a 3D reconstruction of the environment of vehicle 200. The first processing device may then combine the 3D reconstruction with 3D map data or with 3D information calculated based on information from another camera.

The second processing device may receive images from main camera and perform vision processing to detect other vehicles, pedestrians, lane marks, traffic signs, traffic lights, and other road objects. Additionally, the second processing device may calculate a camera displacement and, based on the displacement, calculate a disparity of pixels between successive images and create a 3D reconstruction of the scene (e.g., a structure from motion). The second processing device may send the structure from motion based 3D reconstruction to the first processing device to be combined with the stereo 3D images.

The third processing device may receive images from the wide FOV camera and process the images to detect vehicles, pedestrians, lane marks, traffic signs, traffic lights, and other road objects. The third processing device may further execute additional processing instructions to analyze images to identify objects moving in the image, such as vehicles changing lanes, pedestrians, etc.

In some embodiments, having streams of image-based information captured and processed independently may provide an opportunity for providing redundancy in the system. Such redundancy may include, for example, using a first image capture device and the images processed from that device to validate and/or supplement information obtained by capturing and processing image information from at least a second image capture device.

In some embodiments, system 100 may use two image capture devices (e.g., image capture devices 122 and 124) in providing navigation assistance for vehicle 200 and use a third image capture device (e.g., image capture device 126) to provide redundancy and validate the analysis of data received from the other two image capture devices. For example, in such a configuration, image capture devices 122 and 124 may provide images for stereo analysis by system 100 for navigating vehicle 200, while image capture device 126 may provide images for monocular analysis by system 100 to provide redundancy and validation of information obtained based on images captured from image capture device 122 and/or image capture device 124. That is, image capture device 126 (and a corresponding processing device) may be considered to provide a redundant sub-system for providing a check on the analysis derived from image capture devices 122 and 124 (e.g., to provide an automatic emergency braking (AEB) system). Furthermore, in some embodiments, redundancy and validation of received data may be supplemented based on information received from one more sensors (e.g., radar, lidar, acoustic sensors, information received from one or more transceivers outside of a vehicle, etc.).

One of skill in the art will recognize that the above camera configurations, camera placements, number of cameras, camera locations, etc., are examples only. These components and others described relative to the overall system may be assembled and used in a variety of different configurations without departing from the scope of the disclosed embodiments. Further details regarding usage of a multi-camera system to provide driver assist and/or autonomous vehicle functionality follow below.

FIG. 4 is an exemplary functional block diagram of memory 140 and/or 150, which may be stored/programmed with instructions for performing one or more operations consistent with the disclosed embodiments. Although the following refers to memory 140, one of skill in the art will recognize that instructions may be stored in memory 140 and/or 150.

As shown in FIG. 4, memory 140 may store a monocular image analysis module 402, a stereo image analysis module 404, a velocity and acceleration module 406, and a navigational response module 408. The disclosed embodiments are not limited to any particular configuration of memory 140. Further, application processor 180 and/or image processor 190 may execute the instructions stored in any of modules 402, 404, 406, and 408 included in memory 140. One of skill in the art will understand that references in the following discussions to processing unit 110 may refer to application processor 180 and image processor 190 individually or collectively. Accordingly, steps of any of the following processes may be performed by one or more processing devices.

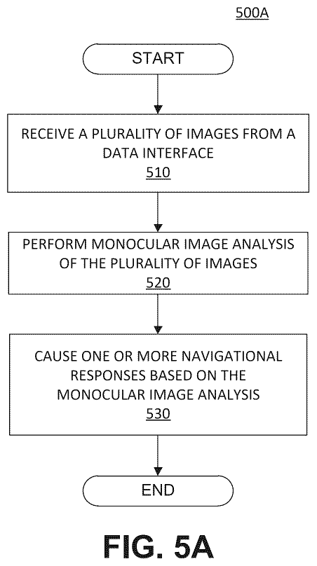

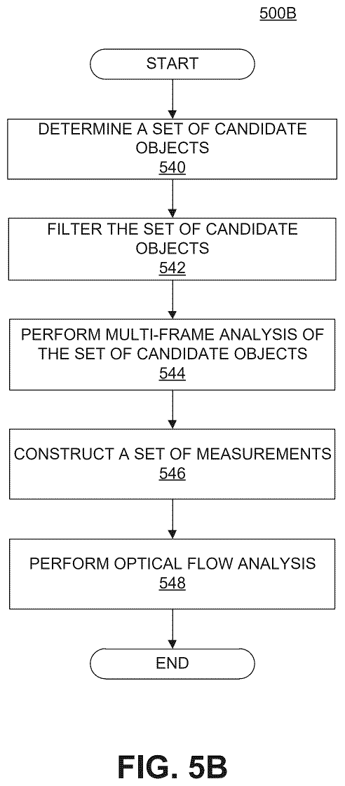

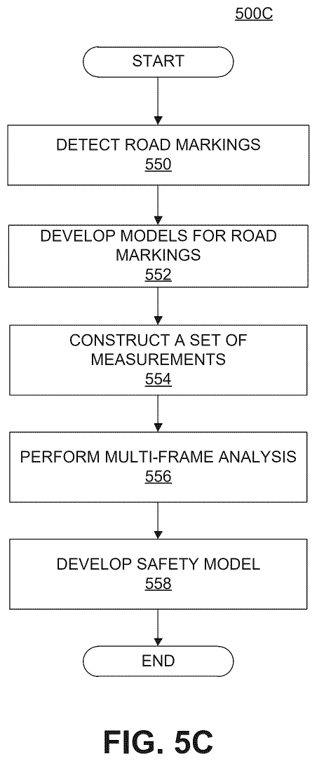

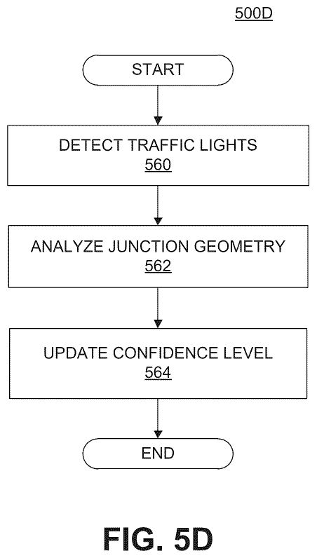

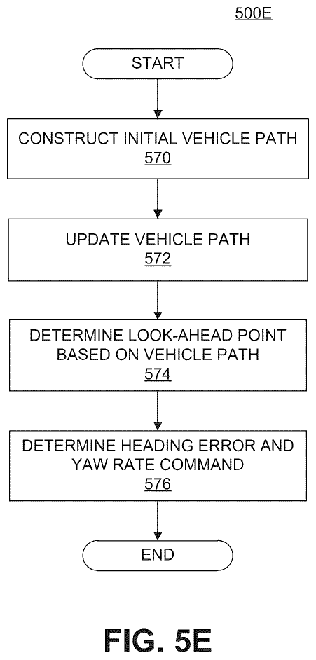

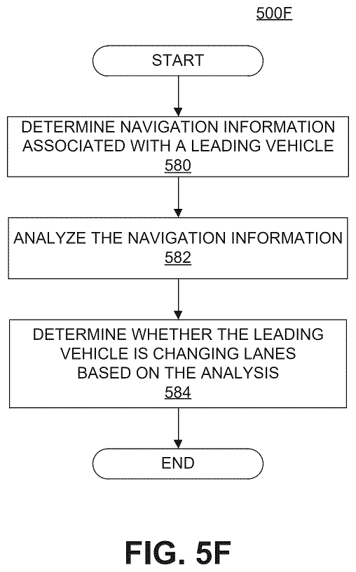

In one embodiment, monocular image analysis module 402 may store instructions (such as computer vision software) which, when executed by processing unit 110, performs monocular image analysis of a set of images acquired by one of image capture devices 122, 124, and 126. In some embodiments, processing unit 110 may combine information from a set of images with additional sensory information (e.g., information from radar, lidar, etc.) to perform the monocular image analysis. As described in connection with FIGS. 5A-5D below, monocular image analysis module 402 may include instructions for detecting a set of features within the set of images, such as lane markings, vehicles, pedestrians, road signs, highway exit ramps, traffic lights, hazardous objects, and any other feature associated with an environment of a vehicle. Based on the analysis, system 100 (e.g., via processing unit 110) may cause one or more navigational responses in vehicle 200, such as a turn, a lane shift, a change in acceleration, and the like, as discussed below in connection with navigational response module 408.

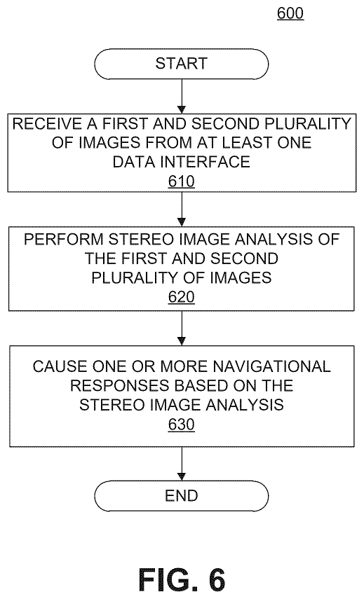

In one embodiment, stereo image analysis module 404 may store instructions (such as computer vision software) which, when executed by processing unit 110, performs stereo image analysis of first and second sets of images acquired by a combination of image capture devices selected from any of image capture devices 122, 124, and 126. In some embodiments, processing unit 110 may combine information from the first and second sets of images with additional sensory information (e.g., information from radar) to perform the stereo image analysis. For example, stereo image analysis module 404 may include instructions for performing stereo image analysis based on a first set of images acquired by image capture device 124 and a second set of images acquired by image capture device 126. As described in connection with FIG. 6 below, stereo image analysis module 404 may include instructions for detecting a set of features within the first and second sets of images, such as lane markings, vehicles, pedestrians, road signs, highway exit ramps, traffic lights, hazardous objects, and the like. Based on the analysis, processing unit 110 may cause one or more navigational responses in vehicle 200, such as a turn, a lane shift, a change in acceleration, and the like, as discussed below in connection with navigational response module 408. Furthermore, in some embodiments, stereo image analysis module 404 may implement techniques associated with a trained system (such as a neural network or a deep neural network) or an untrained system, such as a system that may be configured to use computer vision algorithms to detect and/or label objects in an environment from which sensory information was captured and processed. In one embodiment, stereo image analysis module 404 and/or other image processing modules may be configured to use a combination of a trained and untrained system.

In one embodiment, vlocity and acceleration module 406 may store software configured to analyze data received from one or more computing and electromechanical devices in vehicle 200 that are configured to cause a change in velocity and/or acceleration of vehicle 200. For example, processing unit 110 may execute instructions associated with velocity and acceleration module 406 to calculate a target speed for vehicle 200 based on data derived from execution of monocular image analysis module 402 and/or stereo image analysis module 404. Such data may include, for example, a target position, velocity, and/or acceleration, the position and/or speed of vehicle 200 relative to a nearby vehicle, pedestrian, or road object, position information for vehicle 200 relative to lane markings of the road, and the like. In addition, processing unit 110 may calculate a target speed for vehicle 200 based on sensory input (e.g., information from radar) and input from other systems of vehicle 200, such as throttling system 220, braking system 230, and/or steering system 240 of vehicle 200. Based on the calculated target speed, processing unit 110 may transmit electronic signals to throttling system 220, braking system 230, and/or steering system 240 of vehicle 200 to trigger a change in velocity and/or acceleration by, for example, physically depressing the brake or easing up off the accelerator of vehicle 200.

In one embodiment, navigational response module 408 may store software executable by processing unit 110 to determine a desired navigational response based on data derived from execution of monocular image analysis module 402 and/or stereo image analysis module 404. Such data may include position and speed information associated with nearby vehicles, pedestrians, and road objects, target position information for vehicle 200, and the like. Additionally, in some embodiments, the navigational response may be based (partially or fully) on map data, a predetermined position of vehicle 200, and/or a relative velocity or a relative acceleration between vehicle 200 and one or more objects detected from execution of monocular image analysis module 402 and/or stereo image analysis module 404. Navigational response module 408 may also determine a desired navigational response based on sensory input (e.g., information from radar) and inputs from other systems of vehicle 200, such as throttling system 220, braking system 230, and steering system 240 of vehicle 200. Based on the desired navigational response, processing unit 110 may transmit electronic signals to throttling system 220, braking system 230, and steering system 240 of vehicle 200 to trigger a desired navigational response by, for example, turning the steering wheel of vehicle 200 to achieve a rotation of a predetermined angle. In some embodiments, processing unit 110 may use the output of navigational response module 408 (e.g., the desired navigational response) as an input to execution of velocity and acceleration module 406 for calculating a change in speed of vehicle 200.

Furthermore, any of the modules (e.g., modules 402, 404, and 406) disclosed herein may implement techniques associated with a trained system (such as a neural network or a deep neural network) or an untrained system.

FIG. 5A is a flowchart showing an exemplary process 500A for causing one or more navigational responses based on monocular image analysis, consistent with disclosed embodiments. At step 510, processing unit 110 may receive a plurality of images via data interface 128 between processing unit 110 and image acquisition unit 120. For instance, a camera included in image acquisition unit 120 (such as image capture device 122 having field of view 202) may capture a plurality of images of an area forward of vehicle 200 (or to the sides or rear of a vehicle, for example) and transmit them over a data connection (e.g., digital, wired, USB, wireless, Bluetooth, etc.) to processing unit 110. Processing unit 110 may execute monocular image analysis module 402 to analyze the plurality of images at step 520, as described in further detail in connection with FIGS. 5B-5D below. By performing the analysis, processing unit 110 may detect a set of features within the set of images, such as lane markings, vehicles, pedestrians, road signs, highway exit ramps, traffic lights, and the like.

Processing unit 110 may also execute monocular image analysis module 402 to detect various road hazards at step 520, such as, for example, parts of a truck tire, fallen road signs, loose cargo, small animals, and the like. Road hazards may vary in structure, shape, size, and color, which may make detection of such hazards more challenging. In some embodiments, processing unit 110 may execute monocular image analysis module 402 to perform multi-frame analysis on the plurality of images to detect road hazards. For example, processing unit 110 may estimate camera motion between consecutive image frames and calculate the disparities in pixels between the frames to construct a 3D-map of the road. Processing unit 110 may then use the 3D-map to detect the road surface, as well as hazards existing above the road surface.

At step 530, processing unit 110 may execute navigational response module 408 to cause one or more navigational responses in vehicle 200 based on the analysis performed at step 520 and the techniques as described above in connection with FIG. 4. Navigational responses may include, for example, a turn, a lane shift, a change in acceleration, and the like. In some embodiments, processing unit 110 may use data derived from execution of velocity and acceleration module 406 to cause the one or more navigational responses. Additionally, multiple navigational responses may occur simultaneously, in sequence, or any combination thereof. For instance, processing unit 110 may cause vehicle 200 to shift one lane over and then accelerate by, for example, sequentially transmitting control signals to steering system 240 and throttling system 220 of vehicle 200. Alternatively, processing unit 110 may cause vehicle 200 to brake while at the same time shifting lanes by, for example, simultaneously transmitting control signals to braking system 230 and steering system 240 of vehicle 200.

FIG. 5B is a flowchart showing an exemplary process 500B for detecting one or more vehicles and/or pedestrians in a set of images, consistent with disclosed embodiments. Processing unit 110 may execute monocular image analysis module 402 to implement process 500B. At step 540, processing unit 110 may determine a set of candidate objects representing possible vehicles and/or pedestrians. For example, processing unit 110 may scan one or more images, compare the images to one or more predetermined patterns, and identify within each image possible locations that may contain objects of interest (e.g., vehicles, pedestrians, or portions thereof). The predetermined patterns may be designed in such a way to achieve a high rate of “false hits” and a low rate of “misses.” For example, processing unit 110 may use a low threshold of similarity to predetermined patterns for identifying candidate objects as possible vehicles or pedestrians. Doing so may allow processing unit 110 to reduce the probability of missing (e.g., not identifying) a candidate object representing a vehicle or pedestrian.

At step 542, processing unit 110 may filter the set of candidate objects to exclude certain candidates (e.g., irrelevant or less relevant objects) based on classification criteria. Such criteria may be derived from various properties associated with object types stored in a database (e.g., a database stored in memory 140). Properties may include object shape, dimensions, texture, position (e.g., relative to vehicle 200), and the like. Thus, processing unit 110 may use one or more sets of criteria to reject false candidates from the set of candidate objects.

At step 544, processing unit 110 may analyze multiple frames of images to determine whether objects in the set of candidate objects represent vehicles and/or pedestrians. For example, processing unit 110 may track a detected candidate object across consecutive frames and accumulate frame-by-frame data associated with the detected object (e.g., size, position relative to vehicle 200, etc.). Additionally, processing unit 110 may estimate parameters for the detected object and compare the object's frame-by-frame position data to a predicted position.

At step 546, processing unit 110 may construct a set of measurements for the detected objects. Such measurements may include, for example, position, velocity, and acceleration values (relative to vehicle 200) associated with the detected objects. In some embodiments, processing unit 110 may construct the measurements based on estimation techniques using a series of time-based observations such as Kalman filters or linear quadratic estimation (LQE), and/or based on available modeling data for different object types (e.g., cars, trucks, pedestrians, bicycles, road signs, etc.). The Kalman filters may be based on a measurement of an object's scale, where the scale measurement is proportional to a time to collision (e.g., the amount of time for vehicle 200 to reach the object). Thus, by performing steps 540-546, processing unit 110 may identify vehicles and pedestrians appearing within the set of captured images and derive information (e.g., position, speed, size) associated with the vehicles and pedestrians. Based on the identification and the derived information, processing unit 110 may cause one or more navigational responses in vehicle 200, as described in connection with FIG. 5A, above.

At step 548, processing unit 110 may perform an optical flow analysis of one or more images to reduce the probabilities of detecting a “false hit” and missing a candidate object that represents a vehicle or pedestrian. The optical flow analysis may refer to, for example, analyzing motion patterns relative to vehicle 200 in the one or more images associated with other vehicles and pedestrians, and that are distinct from road surface motion. Processing unit 110 may calculate the motion of candidate objects by observing the different positions of the objects across multiple image frames, which are captured at different times. Processing unit 110 may use the position and time values as inputs into mathematical models for calculating the motion of the candidate objects. Thus, optical flow analysis may provide another method of detecting vehicles and pedestrians that are nearby vehicle 200. Processing unit 110 may perform optical flow analysis in combination with steps 540-546 to provide redundancy for detecting vehicles and pedestrians and increase the reliability of system 100.

FIG. 5C is a flowchart showing an exemplary process 500C for detecting road marks and/or lane geometry information in a set of images, consistent with disclosed embodiments. Processing unit 110 may execute monocular image analysis module 402 to implement process 500C. At step 550, processing unit 110 may detect a set of objects by scanning one or more images. To detect segments of lane markings, lane geometry information, and other pertinent road marks, processing unit 110 may filter the set of objects to exclude those determined to be irrelevant (e.g., minor potholes, small rocks, etc.). At step 552, processing unit 110 may group together the segments detected in step 550 belonging to the same road mark or lane mark. Based on the grouping, processing unit 110 may develop a model to represent the detected segments, such as a mathematical model.

At step 554, processing unit 110 may construct a set of measurements associated with the detected segments. In some embodiments, processing unit 110 may create a projection of the detected segments from the image plane onto the real-world plane. The projection may be characterized using a 3rd-degree polynomial having coefficients corresponding to physical properties such as the position, slope, curvature, and curvature derivative of the detected road. In generating the projection, processing unit 110 may take into account changes in the road surface, as well as pitch and roll rates associated with vehicle 200. In addition, processing unit 110 may model the road elevation by analyzing position and motion cues present on the road surface. Further, processing unit 110 may estimate the pitch and roll rates associated with vehicle 200 by tracking a set of feature points in the one or more images.

At step 556, processing unit 110 may perform multi-frame analysis by, for example, tracking the detected segments across consecutive image frames and accumulating frame-by-frame data associated with detected segments. As processing unit 110 performs multi-frame analysis, the set of measurements constructed at step 554 may become more reliable and associated with an increasingly higher confidence level. Thus, by performing steps 550, 552, 554, and 556, processing unit 110 may identify road marks appearing within the set of captured images and derive lane geometry information. Based on the identification and the derived information, processing unit 110 may cause one or more navigational responses in vehicle 200, as described in connection with FIG. 5A, above.

At step 558, processing unit 110 may consider additional sources of information to further develop a safety model for vehicle 200 in the context of its surroundings. Processing unit 110 may use the safety model to define a context in which system 100 may execute autonomous control of vehicle 200 in a safe manner. To develop the safety model, in some embodiments, processing unit 110 may consider the position and motion of other vehicles, the detected road edges and barriers, and/or general road shape descriptions extracted from map data (such as data from map database 160). By considering additional sources of information, processing unit 110 may provide redundancy for detecting road marks and lane geometry and increase the reliability of system 100.

FIG. 5D is a flowchart showing an exemplary process 500D for detecting traffic lights in a set of images, consistent with disclosed embodiments. Processing unit 110 may execute monocular image analysis module 402 to implement process 500D. At step 560, processing unit 110 may scan the set of images and identify objects appearing at locations in the images likely to contain traffic lights. For example, processing unit 110 may filter the identified objects to construct a set of candidate objects, excluding those objects unlikely to correspond to traffic lights. The filtering may be done based on various properties associated with traffic lights, such as shape, dimensions, texture, position (e.g., relative to vehicle 200), and the like. Such properties may be based on multiple examples of traffic lights and traffic control signals and stored in a database. In some embodiments, processing unit 110 may perform multi-frame analysis on the set of candidate objects reflecting possible traffic lights. For example, processing unit 110 may track the candidate objects across consecutive image frames, estimate the real world position of the candidate objects, and filter out those objects that are moving (which are unlikely to be traffic lights). In some embodiments, processing unit 110 may perform color analysis on the candidate objects and identify the relative position of the detected colors appearing inside possible traffic lights.

At step 562, processing unit 110 may analyze the geometry of a junction. The analysis may be based on any combination of: (i) the number of lanes detected on either side of vehicle 200, (ii) markings (such as arrow marks) detected on the road, and (iii) descriptions of the junction extracted from map data (such as data from map database 160). Processing unit 110 may conduct the analysis using information derived from execution of monocular analysis module 402. In addition, Processing unit 110 may determine a correspondence between the traffic lights detected at step 560 and the lanes appearing near vehicle 200.

As vehicle 200 approaches the junction, at step 564, processing unit 110 may update the confidence level associated with the analyzed junction geometry and the detected traffic lights. For instance, the number of traffic lights estimated to appear at the junction as compared with the number actually appearing at the junction may impact the confidence level. Thus, based on the confidence level, processing unit 110 may delegate control to the driver of vehicle 200 in order to improve safety conditions. By performing steps 560, 562, and 564, processing unit 110 may identify traffic lights appearing within the set of captured images and analyze junction geometry information. Based on the identification and the analysis, processing unit 110 may cause one or more navigational responses in vehicle 200, as described in connection with FIG. 5A, above.

FIG. 5E is a flowchart showing an exemplary process 500E for causing one or more navigational responses in vehicle 200 based on a vehicle path, consistent with the disclosed embodiments. At step 570, processing unit 110 may construct an initial vehicle path associated with vehicle 200. The vehicle path may be represented using a set of points expressed in coordinates (x, z), and the distance di between two points in the set of points may fall in the range of 1 to 5 meters. In one embodiment, processing unit 110 may construct the initial vehicle path using two polynomials, such as left and right road polynomials. Processing unit 110 may calculate the geometric midpoint between the two polynomials and offset each point included in the resultant vehicle path by a predetermined offset (e.g., a smart lane offset), if any (an offset of zero may correspond to travel in the middle of a lane). The offset may be in a direction perpendicular to a segment between any two points in the vehicle path. In another embodiment, processing unit 110 may use one polynomial and an estimated lane width to offset each point of the vehicle path by half the estimated lane width plus a predetermined offset (e.g., a smart lane offset).

At step 572, processing unit 110 may update the vehicle path constructed at step 570. Processing unit 110 may reconstruct the vehicle path constructed at step 570 using a higher resolution, such that the distance dₖ between two points in the set of points representing the vehicle path is less than the distance dᵢ described above. For example, the distance dₖ may fall in the range of 0.1 to 0.3 meters. Processing unit 110 may reconstruct the vehicle path using a parabolic spline algorithm, which may yield a cumulative distance vector S corresponding to the total length of the vehicle path (i.e., based on the set of points representing the vehicle path).

At step 574, processing unit 110 may determine a look-ahead point (expressed in coordinates as (x1, zi)) based on the updated vehicle path constructed at step 572. Processing unit 110 may extract the look-ahead point from the cumulative distance vector S, and the look-ahead point may be associated with a look-ahead distance and look-ahead time. The look-ahead distance, which may have a lower bound ranging from 10 to 20 meters, may be calculated as the product of the speed of vehicle 200 and the look-ahead time. For example, as the speed of vehicle 200 decreases, the look-ahead distance may also decrease (e.g., until it reaches the lower bound). The look-ahead time, which may range from 0.5 to 1.5 seconds, may be inversely proportional to the gain of one or more control loops associated with causing a navigational response in vehicle 200, such as the heading error tracking control loop. For example, the gain of the heading error tracking control loop may depend on the bandwidth of a yaw rate loop, a steering actuator loop, car lateral dynamics, and the like. Thus, the higher the gain of the heading error tracking control loop, the lower the look-ahead time.

At step 576, processing unit 110 may determine a heading error and yaw rate command based on the look-ahead point determined at step 574. Processing unit 110 may determine the heading error by calculating the arctangent of the look-ahead point, e.g., arctan (xₗ/zₗ). Processing unit 110 may determine the yaw rate command as the product of the heading error and a high-level control gain. The high-level control gain may be equal to: (2/look-ahead time), if the look-ahead distance is not at the lower bound. Otherwise, the high-level control gain may be equal to: (2*speed of vehicle 200/look-ahead distance).

FIG. 5F is a flowchart showing an exemplary process 500F for determining whether a leading vehicle is changing lanes, consistent with the disclosed embodiments. At step 580, processing unit 110 may determine navigation information associated with a leading vehicle (e.g., a vehicle traveling ahead of vehicle 200). For example, processing unit 110 may determine the position, velocity (e.g., direction and speed), and/or acceleration of the leading vehicle, using the techniques described in connection with FIGS. 5A and 5B, above. Processing unit 110 may also determine one or more road polynomials, a look-ahead point (associated with vehicle 200), and/or a snail trail (e.g., a set of points describing a path taken by the leading vehicle), using the techniques described in connection with FIG. 5E, above.

At step 582, processing unit 110 may analyze the navigation information determined at step 580. In one embodiment, processing unit 110 may calculate the distance between a snail trail and a road polynomial (e.g., along the trail). If the variance of this distance along the trail exceeds a predetermined threshold (for example, 0.1 to 0.2 meters on a straight road, 0.3 to 0.4 meters on a moderately curvy road, and 0.5 to 0.6 meters on a road with sharp curves), processing unit 110 may determine that the leading vehicle is likely changing lanes. In the case where multiple vehicles are detected traveling ahead of vehicle 200, processing unit 110 may compare the snail trails associated with each vehicle. Based on the comparison, processing unit 110 may determine that a vehicle whose snail trail does not match with the snail trails of the other vehicles is likely changing lanes. Processing unit 110 may additionally compare the curvature of the snail trail (associated with the leading vehicle) with the expected curvature of the road segment in which the leading vehicle is traveling. The expected curvature may be extracted from map data (e.g., data from map database 160), from road polynomials, from other vehicles'snail trails, from prior knowledge about the road, and the like. If the difference in curvature of the snail trail and the expected curvature of the road segment exceeds a predetermined threshold, processing unit 110 may determine that the leading vehicle is likely changing lanes.

In another embodiment, processing unit 110 may compare the leading vehicle's instantaneous position with the look-ahead point (associated with vehicle 200) over a specific period of time (e.g., 0.5 to 1.5 seconds). If the distance between the leading vehicle's instantaneous position and the look-ahead point varies during the specific period of time, and the cumulative sum of variation exceeds a predetermined threshold (for example, 0.3 to 0.4 meters on a straight road, 0.7 to 0.8 meters on a moderately curvy road, and 1.3 to 1.7 meters on a road with sharp curves), processing unit 110 may determine that the leading vehicle is likely changing lanes. In another embodiment, processing unit 110 may analyze the geometry of the snail trail by comparing the lateral distance traveled along the trail with the expected curvature of the snail trail. The expected radius of curvature may be determined according to the calculation: (δ_{z}²+δₓ²)/2/(δₓ), where δₓ represents the lateral distance traveled and δ_{z} represents the longitudinal distance traveled. If the difference between the lateral distance traveled and the expected curvature exceeds a predetermined threshold (e.g., 500 to 700 meters), processing unit 110 may determine that the leading vehicle is likely changing lanes. In another embodiment, processing unit 110 may analyze the position of the leading vehicle. If the position of the leading vehicle obscures a road polynomial (e.g., the leading vehicle is overlaid on top of the road polynomial), then processing unit 110 may determine that the leading vehicle is likely changing lanes. In the case where the position of the leading vehicle is such that, another vehicle is detected ahead of the leading vehicle and the snail trails of the two vehicles are not parallel, processing unit 110 may determine that the (closer) leading vehicle is likely changing lanes.

At step 584, processing unit 110 may determine whether or not leading vehicle 200 is changing lanes based on the analysis performed at step 582. For example, processing unit 110 may make the determination based on a weighted average of the individual analyses performed at step 582. Under such a scheme, for example, a decision by processing unit 110 that the leading vehicle is likely changing lanes based on a particular type of analysis may be assigned a value of “1” (and “0” to represent a determination that the leading vehicle is not likely changing lanes). Different analyses performed at step 582 may be assigned different weights, and the disclosed embodiments are not limited to any particular combination of analyses and weights.

FIG. 6 is a flowchart showing an exemplary process 600 for causing one or more navigational responses based on stereo image analysis, consistent with disclosed embodiments. At step 610, processing unit 110 may receive a first and second plurality of images via data interface 128. For example, cameras included in image acquisition unit 120 (such as image capture devices 122 and 124 having fields of view 202 and 204) may capture a first and second plurality of images of an area forward of vehicle 200 and transmit them over a digital connection (e.g., USB, wireless, Bluetooth, etc.) to processing unit 110. In some embodiments, processing unit 110 may receive the first and second plurality of images via two or more data interfaces. The disclosed embodiments are not limited to any particular data interface configurations or protocols.

At step 620, processing unit 110 may execute stereo image analysis module 404 to perform stereo image analysis of the first and second plurality of images to create a 3D map of the road in front of the vehicle and detect features within the images, such as lane markings, vehicles, pedestrians, road signs, highway exit ramps, traffic lights, road hazards, and the like. Stereo image analysis may be performed in a manner similar to the steps described in connection with FIGS. 5A-5D, above. For example, processing unit 110 may execute stereo image analysis module 404 to detect candidate objects (e.g., vehicles, pedestrians, road marks, traffic lights, road hazards, etc.) within the first and second plurality of images, filter out a subset of the candidate objects based on various criteria, and perform multi-frame analysis, construct measurements, and determine a confidence level for the remaining candidate objects. In performing the steps above, processing unit 110 may consider information from both the first and second plurality of images, rather than information from one set of images alone. For example, processing unit 110 may analyze the differences in pixel-level data (or other data subsets from among the two streams of captured images) for a candidate object appearing in both the first and second plurality of images. As another example, processing unit 110 may estimate a position and/or velocity of a candidate object (e.g., relative to vehicle 200) by observing that the object appears in one of the plurality of images but not the other or relative to other differences that may exist relative to objects appearing if the two image streams. For example, position, velocity, and/or acceleration relative to vehicle 200 may be determined based on trajectories, positions, movement characteristics, etc. of features associated with an object appearing in one or both of the image streams.

At step 630, processing unit 110 may execute navigational response module 408 to cause one or more navigational responses in vehicle 200 based on the analysis performed at step 620 and the techniques as described above in connection with FIG. 4. Navigational responses may include, for example, a turn, a lane shift, a change in acceleration, a change in velocity, braking, and the like. In some embodiments, processing unit 110 may use data derived from execution of velocity and acceleration module 406 to cause the one or more navigational responses. Additionally, multiple navigational responses may occur simultaneously, in sequence, or any combination thereof.

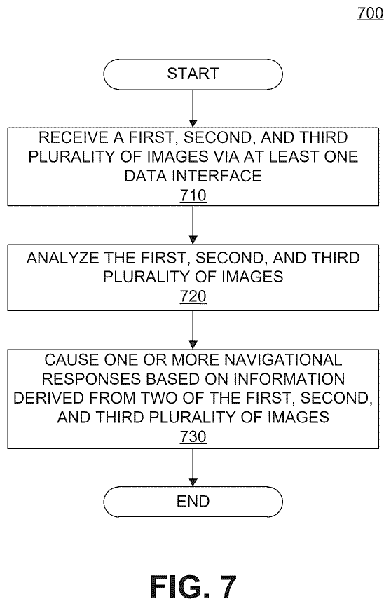

FIG. 7 is a flowchart showing an exemplary process 700 for causing one or more navigational responses based on an analysis of three sets of images, consistent with disclosed embodiments. At step 710, processing unit 110 may receive a first, second, and third plurality of images via data interface 128. For instance, cameras included in image acquisition unit 120 (such as image capture devices 122, 124, and 126 having fields of view 202, 204, and 206) may capture a first, second, and third plurality of images of an area forward and/or to the side of vehicle 200 and transmit them over a digital connection (e.g., USB, wireless, Bluetooth, etc.) to processing unit 110. In some embodiments, processing unit 110 may receive the first, second, and third plurality of images via three or more data interfaces. For example, each of image capture devices 122, 124, 126 may have an associated data interface for communicating data to processing unit 110. The disclosed embodiments are not limited to any particular data interface configurations or protocols.

At step 720, processing unit 110 may analyze the first, second, and third plurality of images to detect features within the images, such as lane markings, vehicles, pedestrians, road signs, highway exit ramps, traffic lights, road hazards, and the like. The analysis may be performed in a manner similar to the steps described in connection with FIGS. 5A-5D and 6, above. For instance, processing unit 110 may perform monocular image analysis (e.g., via execution of monocular image analysis module 402 and based on the steps described in connection with FIGS. 5A-5D, above) on each of the first, second, and third plurality of images. Alternatively, processing unit 110 may perform stereo image analysis (e.g., via execution of stereo image analysis module 404 and based on the steps described in connection with FIG. 6, above) on the first and second plurality of images, the second and third plurality of images, and/or the first and third plurality of images. The processed information corresponding to the analysis of the first, second, and/or third plurality of images may be combined. In some embodiments, processing unit 110 may perform a combination of monocular and stereo image analyses. For example, processing unit 110 may perform monocular image analysis (e.g., via execution of monocular image analysis module 402) on the first plurality of images and stereo image analysis (e.g., via execution of stereo image analysis module 404) on the second and third plurality of images. The configuration of image capture devices 122, 124, and 126—including their respective locations and fields of view 202, 204, and 206—may influence the types of analyses conducted on the first, second, and third plurality of images. The disclosed embodiments are not limited to a particular configuration of image capture devices 122, 124, and 126, or the types of analyses conducted on the first, second, and third plurality of images.

In some embodiments, processing unit 110 may perform testing on system 100 based on the images acquired and analyzed at steps 710 and 720. Such testing may provide an indicator of the overall performance of system 100 for certain configurations of image capture devices 122, 124, and 126. For example, processing unit 110 may determine the proportion of “false hits” (e.g., cases where system 100 incorrectly determined the presence of a vehicle or pedestrian) and “misses.”

At step 730, processing unit 110 may cause one or more navigational responses in vehicle 200 based on information derived from two of the first, second, and third plurality of images. Selection of two of the first, second, and third plurality of images may depend on various factors, such as, for example, the number, types, and sizes of objects detected in each of the plurality of images. Processing unit 110 may also make the selection based on image quality and resolution, the effective field of view reflected in the images, the number of captured frames, the extent to which one or more objects of interest actually appear in the frames (e.g., the percentage of frames in which an object appears, the proportion of the object that appears in each such frame, etc.), and the like.

In some embodiments, processing unit 110 may select information derived from two of the first, second, and third plurality of images by determining the extent to which information derived from one image source is consistent with information derived from other image sources. For example, processing unit 110 may combine the processed information derived from each of image capture devices 122, 124, and 126 (whether by monocular analysis, stereo analysis, or any combination of the two) and determine visual indicators (e.g., lane markings, a detected vehicle and its location and/or path, a detected traffic light, etc.) that are consistent across the images captured from each of image capture devices 122, 124, and 126. Processing unit 110 may also exclude information that is inconsistent across the captured images (e.g., a vehicle changing lanes, a lane model indicating a vehicle that is too close to vehicle 200, etc.). Thus, processing unit 110 may select information derived from two of the first, second, and third plurality of images based on the determinations of consistent and inconsistent information.

Navigational responses may include, for example, a turn, a lane shift, a change in acceleration, and the like. Processing unit 110 may cause the one or more navigational responses based on the analysis performed at step 720 and the techniques as described above in connection with FIG. 4. Processing unit 110 may also use data derived from execution of velocity and acceleration module 406 to cause the one or more navigational responses. In some embodiments, processing unit 110 may cause the one or more navigational responses based on a relative position, relative velocity, and/or relative acceleration between vehicle 200 and an object detected within any of the first, second, and third plurality of images. Multiple navigational responses may occur simultaneously, in sequence, or any combination thereof.

### Pseudo LIDAR

This disclosure provides systems and methods that may infer depth information in the pixels of images captured by one or more groups of cameras. For example, in some embodiments, a host vehicle may include a group of cameras, which may include three cameras, namely, a center camera, a left surround camera, and a right surround camera. The FOV of the center camera may at least partially overlap with both a FOV of the left surround camera and a FOV of the right surround camera. The center camera may be configured to capture one or more images (also referred to herein as center images) of at least in a portion of the environment of the host vehicle in the FOV of the center camera. The left surround camera may be configured to capture one or more images (also referred to herein as left surround images) of at least in a portion of the environment of the host vehicle in the FOV of the left surround camera. The right surround camera may be configured to capture one or more images (also referred to herein as right surround images) of at least in a portion of the environment of the host vehicle in the FOV of the right surround camera. The host vehicle may receive a captured center image from the center camera, a captured left surround image from the left surround camera, and a captured right surround image from the right surround camera. The host vehicle may also provide the received images to an analysis module, which may be configured to generate an output relative to the center image based on analysis of the center, left surround, and right surround images. In some embodiments, the generated output may include per-pixel depth information for at least one region of the center image. The host vehicle may further take at least one navigational action based on the generated output including the per-pixel depth information for the at least one region of the center image.

FIG. 8 illustrates an exemplary vehicle 800 consistent with disclosed embodiments. The disclosed systems and methods may be implemented using one or more components of vehicle 800. As illustrated in FIG. 8, vehicle 800 may include at least one processor (e.g., processor 801), memory 802, at least one storage device (e.g., storage device 803), a communications port 804, an I/O device 805, a plurality of cameras 806, a LIDAR system 807, and a navigation system 808.

Processor 801 may be programmed to perform one or more functions of vehicle 800 described in this disclosure. Processor 801 may include a microprocessor, preprocessors (such as an image preprocessor), a graphics processing unit (GPU), a central processing unit (CPU), support circuits, digital signal processors, integrated circuits, memory, or any other types of devices suitable for running applications or performing a computing task. In some embodiments, processor 801 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures (e.g., x86 processor, ARM®, etc.). Any of the processing devices disclosed herein may be configured to perform certain functions. Configuring a processing device, such as any of the described processors or other controller or microprocessor, to perform certain functions may include programming of computer-executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

Vehicle 800 may also include memory 802 that may store instructions for various components of vehicle 800. For example, memory 802 may store instructions that, when executed by processor 801, may be configured to cause processor 801 to perform one or more functions of processor 801 described herein. Memory 802 may include any number of random-access memories, read-only memories, flash memories, disk drives, optical storage, tape storage, removable storage, and other types of storage. In one instance, memory 802 may be separate from processor 801. In another instance, memory 802 may be integrated into processor 801. In some embodiments, memory 802 may include software for performing one or more computing tasks, as well as a trained system, such as a neural network (e.g., a trained deep neural network), or a deep neural network. For example, memory 802 may include an analysis module accessible by processor 801 for receiving images and generating output relative to one of the images, as described elsewhere in this disclosure.

In some embodiments, the analysis module may include at least one trained model trained based on training data including a combination of a plurality of images captured by cameras with at least partially overlapping fields and LIDAR point cloud information corresponding with at least some of the plurality of images. For example, each of the training data sets may include three images, each of which may be captured by one of a group of cameras (including a center camera, a left surround camera, and a right surround camera) mounted on a training vehicle. The FOV of the center camera may at least partially overlap with the FOV of the left surround camera and the FOV of the right surround camera. The training data set may also include point cloud information captured by a LIDAR system mounted on the same vehicle, which may provide measured depth information associated with the images captured by the group of cameras. The point cloud information may be treated as the reference depth information (or true depth values) for training the neural network. The images in the training data set (and/or extracted image features) may be input into a preliminary (or untrained) neural network, which may generate an output including calculated per-pixel depth information for at least one region of the center image. The calculated per-pixel depth information may be compared with the corresponding depth information of the point cloud information to determine whether the neural network has the model parameters or weights meeting or exceeding a predetermined accuracy level for generating per-pixel depth information. For example, the training system for training the neural network may generate an accuracy score of the neural network based on the comparison of the calculated depth information and the corresponding depth information in the point cloud information (included in training data sets). If the accuracy score equals or exceeds a threshold, the training process may stop, and the training system may save the trained neural network into a local storage device and/or transmit the trained neural network to one or more vehicles (e.g., vehicle 800). On the other hand, if the accuracy score is below the threshold, the training system may adjust one or more parameters or weights of the neural network and repeat the training process using training data sets until an accuracy score of the neural network equal to or exceeding the threshold is reached (and/or a predetermined number of training cycles has been reached).

In some embodiments, when training a neural network, a combination of score functions (or losses) may be used, which may include a photometric loss providing a score for the depth information calculated by the network based on the images of the training data set. For the proper depth, the difference in appearance between corresponding image patches may be minimized, which may provide guidance in image regions in which there exist texture features. Additionally, a sparser score function may be computed using a projection of LIDAR point measurements collected by the LIDAR system of the training vehicle. These points may be aggregated on one or more static objects in the scene using the vehicle's computed ego-motion. The projection may account for the time differences between the moment at which the pixel intensity of the image in which the depth information is to be calculated by the neural network during the training process may be recorded, and the capture time of the LIDAR data may also be recorded. Static objects may be determined based on monocular image object detectors to minimize the false negative rate (at the price of a large false positive rate). In some embodiments, the neural network may also be trained to predict a confidence score of the calculated depth information by regressing the magnitude of its own geometric error, which may be optimized at training time using the LIDAR's geometric labeling.

In some embodiments, vehicle 800 may receive the analysis module from a server via a network and store the analysis module in memory 802 and/or storage device 803.

Storage device 803 may be configured to store various data and information for one or more components of vehicle 800. Storage device 803 may include one or more hard drives, tapes, one or more solid-state drives, any device suitable for writing and read data, or the like, or a combination thereof. For example, storage device 803 may be configured to store data of one or more maps. By way of example, storage device 803 may store data of a sparse map, which may include one or more landmarks associated with a road segment and one or more target trajectories associated with the road segment. As another example, storage device 803 may be configured to store images captured by camera 806 and/or LIDAR data captured by LIDAR system 807.

Communications port 804 may be configured to facilitate data communications between vehicle 800 and other devices. For example, communications port 804 may be configured to receive data from and transmit data to a server (e.g., one or more servers described in this disclosure) via one or more public or private networks, including the Internet, an Intranet, a WAN (Wide-Area Network), a MAN (Metropolitan-Area Network), a wireless network compliant with the IEEE 802.11a/b/g/n Standards, a leased line, or the like.

I/O device 805 may be configured to receive input from the user of vehicle 800, and one or more components of vehicle 800 may perform one or more functions in response to the input received. In some embodiments, I/O device 805 may include an interface displayed on a touchscreen. I/O device 805 may also be configured to output information and/or data to the user. For example, I/O device 805 may include a display configured to display a map.

Cameras 806 may be configured to capture one or more images of the environment of vehicle 800. Cameras 806 may include any type of device suitable for capturing at least one image from an environment. In some embodiments, cameras 806 may be similar to image capture devices 122, 124, and 126 illustrated in FIG. 1 and described above. For purposes of brevity, detailed descriptions are not repeated here.

Cameras 806 may be positioned at any suitable location on vehicle 800. For example, a camera 806 may be located behind a windshield of vehicle 800, in a vicinity of a front bumper of vehicle 800, a vicinity of the rearview mirror of vehicle 800, one or both of the side mirrors of vehicle 800, on the roof of vehicle 800, on the hood of vehicle 800, on the trunk of vehicle 800, on the sides of vehicle 800, mounted on, positioned behind, or positioned in front of any of the windows of vehicle 800, and mounted in or near light figures on the front and/or back of vehicle 800, etc.

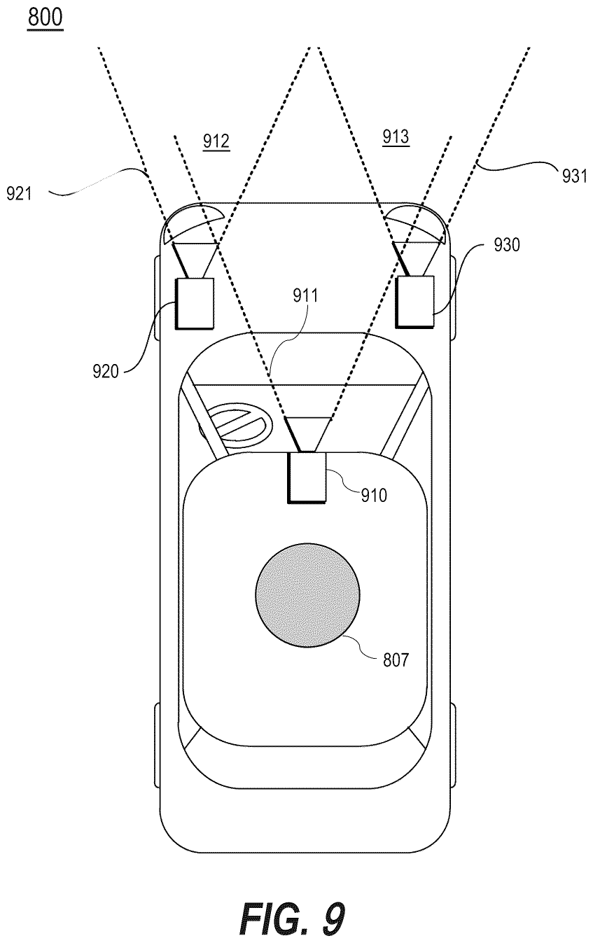

In some embodiments, cameras 806 may include one or more groups of cameras. Each group of cameras may include three cameras, namely a center camera, a left surround camera, and a right surround camera. By way of example, as illustrated in FIG. 9, vehicle 800 may include a group of cameras, including a center camera 910, a left surround camera 920, and a right surround camera 930. Center camera 910 may be positioned in the vicinity of the rearview mirror and/or near the driver of vehicle 800. Left surround camera 920 and right surround camera 930 may be positioned on or in a bumper region of vehicle 800. Other configurations are also possible. For example, center camera 910, left surround camera 920, and right surround camera 930 may be positioned in the vicinity of the rearview mirror and/or near the driver seat of vehicle 800.

In some embodiments, the FOV of center camera 910 may at least partially overlap with both the FOV of left surround camera 920 and a FOV of right surround camera 930. By way of example, as illustrated in FIG. 9, center camera 910 may have a center camera FOV 911, left surround camera 920 may have a left surround FOV 921, and right surround camera 930 may have a right surround FOV 931. Center camera FOV 911 may at least partially overlap with left surround FOV 921 and right surround FOV 931. For example, there may be an overlapping region 912 of center camera FOV 911 and left surround FOV 921, and an overlapping region 913 of center camera FOV 911 and right surround FOV 931. In some embodiments, two or more of center camera 910, left surround camera 920, and right surround camera 930 may have different FOVs (as illustrated in FIG. 9).

In some embodiments, two or more of center camera 910, left surround camera 920, and right surround camera 930 may have different focal lengths. In some embodiments, the focal lengths of center camera 910, left surround camera 920, and right surround camera 930 may be selected with a wide range of angular overlap between adjacent FOVs such that the system can infer depth information from the images captured by center camera 910, left surround camera 920, and right surround camera 930.

In some embodiments, vehicle 800 may include two or more groups of cameras. For example, vehicle 800 may include a first group of cameras, including center camera 910, left surround camera 920, and right surround camera 930. Vehicle 800 may also include a second group of cameras, including a center camera located in a vicinity of the rearview mirror of vehicle 800, a left surround camera located at the left, back side of vehicle 800, and a right surround camera located at the right, back side of vehicle 800. In some embodiments, the FOVs of the (two or more) groups of cameras may form a total FOV covering 360 degrees.

In some embodiments, the groups of cameras may share at least one camera. For example, instead of having another center camera in the example provided above, the second group of cameras may include center camera 910 (of the first group) as the center camera of the second group of cameras. As another example, vehicle 800 may include three or more groups of cameras, and the right surround camera of the first camera group may serve as the left surround camera of the second camera group and the left surround camera of the first camera group may server as a right surround camera of a third camera group. Alternatively or additionally, at least one of the left surround camera or the right surround camera of the first camera group may serve as a center camera for a camera group other than the first camera group. One skilled in the art will understand that the above examples of the configurations of the cameras are for illustration purposes only and they are not intended to limit the scope of the disclosure; other configurations of cameras and/or camera groups may also be used for implementing the disclosed systems and methods.

LIDAR system 807 may include one or more LIDAR units. In some embodiments, the one or more LIDAR units may be positioned on a roof of vehicle 800. Such a unit may include a rotating unit configured to gather LIDAR reflection information within a 360-degree field of view around vehicle 800 or from any sub-segment of the 360-degree field of view (e.g., one or more FOVs each representing less than 360 degrees). The data collected by LIDAR system 807 may be provided to processor 801. Alternatively or additionally, the data may be transmitted to a server described in this disclosure via a network.

In some embodiments, a LIDAR unit may be positioned at a forward location on vehicle 800 (e.g., near the headlights, in the front grill, near the fog lamps, in a forward bumper, or at any other suitable location). In some cases, one or more LIDAR units installed on a forward portion of vehicle 800 may collect reflection information from a field of view in an environment forward of vehicle 800. In other embodiments, a LIDAR unit may be located in other locations.

For example, a LIDAR unit may be located behind a windshield of vehicle 800, in a vicinity of a front bumper of vehicle 800, a vicinity of the rearview mirror of vehicle 800, one or both of the side mirrors of vehicle 800, on the roof of vehicle 800, on the hood of vehicle 800, on the trunk of vehicle 800, on the sides of vehicle 800, mounted on, positioned behind, or positioned in front of any of the windows of vehicle 800, and mounted in or near light figures on the front and/or back of vehicle 800, etc. By way of example, LIDAR system 807 may be located on the roof of vehicle 800, as illustrated in FIG. 9.

Any suitable type of LIDAR unit may be included in vehicle 800. In some cases, LIDAR system 807 may include one or more flash (also referred to herein as static) LIDAR units (e.g., 3D flash LIDAR) where an entire LIDAR field of view (FOV) is illuminated with a single laser pulse, and a sensor including rows and columns of pixels to record returned light intensity and time of flight/depth information. Such flash systems may illuminate a scene and collect LIDAR “images”multiple times per second. Scanning LIDAR units may also be employed. Such scanning LIDAR units may rely on one or more techniques for dispersing a laser beam over a particular FOV. In some cases, a scanning LIDAR unit may include a scanning mirror that deflects and directs a laser beam toward objects within the FOV. Scanning mirrors may rotate through a full 360 degrees or may rotate along a single axis or multiple axes over less than 360 degrees to direct the laser toward a predetermined FOV. In some cases, LIDAR units may scan one horizontal line. In other cases, a LIDAR unit may scan multiple horizontal lines within an FOV, effectively rastering a particular FOV multiple times per second.

The LIDAR units in LIDAR system 807 may include any suitable laser source. In some embodiments, the LIDAR units may employ a continuous laser. In other cases, the LIDAR units may use pulsed laser emissions. Additionally, any suitable laser wavelength may be employed. In some cases, a wavelength of between about 600 nm to about 1000 nm may be used.

The LIDAR unit(s) in LIDAR system 807 may also include any suitable type of sensor and provide any suitable type of output. In some cases, sensors of the LIDAR units may include solid state photodetectors, such as one or more photodiodes or photomultipliers. The sensors may also include one or more CMOS or CCD devices including any number of pixels. These sensors may be sensitive to laser light reflected from a scene within the LIDAR FOV. The sensors may enable various types of output from a LIDAR unit. In some cases, a LIDAR unit may output raw light intensity values and time of flight information representative of the reflected laser light collected at each sensor or at each pixel or sub-component of a particular sensor. Additionally or alternatively, a LIDAR unit may output a point cloud (e.g., a 3D point cloud) that may include light intensity and depth/distance information relative to each collected point). LIDAR units may also output various types of depth maps representative of light reflection amplitude and distance to points within a field of view. LIDAR units may provide depth or distance information relative to particular points within an FOV by noting a time at which light from the LIDAR's light source was initially projected toward the FOV and recording a time at which the incident laser light is received by a sensor in the LIDAR unit. The time difference may represent a time of flight, which may be directly related to the round trip distance that the incident laser light traveled from the laser source to a reflecting object and back to the LIDAR unit. Monitoring the time of flight information associated with individual laser spots or small segments of a LIDAR FOV may provide accurate distance information for a plurality of points within the FOV (e.g., mapping to even very small features of objects within the FOV). In some cases, LIDAR units may output more complex information, such as classification information that correlates one or more laser reflections with a type of object from which the laser reflection was acquired.

Navigation system 808 may be configured to assist a driver of vehicle 800 to operate vehicle 800. For example, navigation system 808 may determine that vehicle 800 is currently deviating from a target trajectory and generate a notification to the driver indicating the deviation from the target trajectory, which may be displayed on a display (e.g., displaying the target trajectory and an estimated travel path determined based on vehicle 800's current position and heading direction). Alternatively, navigation system 808 may include an autonomous vehicle navigation system configured to control the movement of vehicle 800, as described elsewhere in this disclosure. For example, navigation system 808 may implement a navigation action determined by processor 801 as vehicle 800 traverses a road segment (e.g., one or more of steering, braking, or acceleration of the vehicle). In some embodiments, navigation system 808 may include an advanced driver-assistance system (ADAS) system. In some embodiments, navigation system 808 may be configured to cause activation of one or more actuators associated with a steering system, a braking system, or a drive system of vehicle 800 according to one or more navigational actions.

In some embodiments, vehicle 800 may also include one or more sensors configured to collect information relating to vehicle 800 and/or the environment of vehicle 800. Exemplary sensors may include a positioning device (e.g., a Global Positioning System (GPS) device), an accelerometer, a gyro sensor, a speedometer, or the like, or a combination thereof. For example, vehicle 800 may include a GPS device configured to collect positioning data associated with positions of vehicle 800 over a period of time.

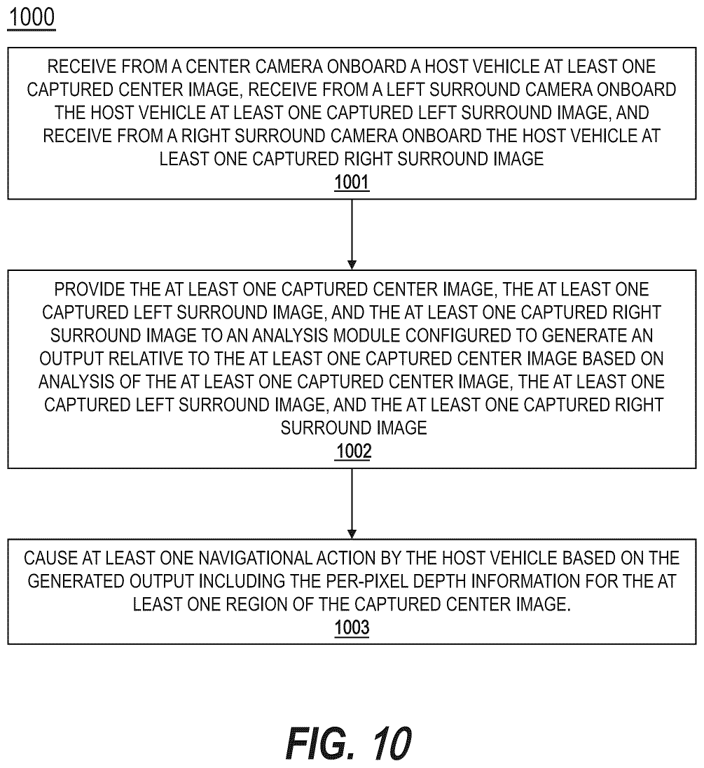

FIG. 10 is a flowchart showing an exemplary process 1000 for determining a navigational action for a host vehicle consistent with disclosed embodiments. While some of the descriptions of process 1000 below are provided with reference to center camera 910, left surround camera 920, and right surround camera 930 illustrated in FIG. 9, one skilled in the art will understand that one or more of cameras 806 may be located in other locations of vehicle 800.

At step 1001, processor 801 may be programmed to receive from center camera 910 at least one captured center image, which may include a representation of at least a portion of an environment of vehicle 800. Processor 801 may also be configured to receive from left surround camera 920 at least one captured left surround image, which may include a representation of at least a portion of the environment of vehicle 800. Processor 801 may further be configured to receive from right surround camera 930 at least one captured right surround image, which may include a representation of at least a portion of the environment of vehicle 800. In some embodiments, the FOV of center camera 910 may at least partially overlap with both the FOV of left surround camera 920 and a FOV of right surround camera 930. By way of example, as illustrated in FIG. 9, center camera 910 may include a center camera FOV 911, left surround camera 920 may include a left surround FOV 921, and right surround camera 930 may include a right surround FOV 931. Center camera FOV 911 may at least partially overlap with left surround FOV 921 and right surround FOV 931. For example, there may be an overlapping region 912 of center camera FOV 911 and left surround FOV 921, and an overlapping region 913 of center camera FOV 911 and right surround FOV 931.

Referring to FIG. 10, at step 1002, processor 801 may be programmed to provide the at least one captured center image, the at least one captured left surround image, and the at least one captured right surround image to an analysis module configured to generate an output relative to the at least one captured center image based on analysis of the at least one captured center image, the at least one captured left surround image, and the at least one captured right surround image. The generated output may include per-pixel depth information for at least one region of the captured center image.

In some embodiments, the analysis module may include at least one trained model. The trained model may include a trained neural network, which may be trained based on training data including a combination of a plurality of images captured by cameras with at least partially overlapping fields and LIDAR point cloud information corresponding with at least some of the plurality of images. For example, each of the training data sets may include three images, each of which may be captured by one of a group of cameras (including a center camera, a left surround camera, and a right surround camera) mounted on a training vehicle. The FOV of the center camera may at least partially overlap with the FOV of the left surround camera and the FOV of the right surround camera. The training data set may also include point cloud information captured by a LIDAR system mounted on the same vehicle, which may provide measured depth information associated with the images captured by the group of cameras. The point cloud information may be treated as the reference depth information (or true depth values) for training the neural network. The images in the training data set (and/or extracted image features) may be input into a preliminary (or untrained) neural network, which may generate an output including calculated per-pixel depth information for at least one region of the center image. The calculated per-pixel depth information may be compared with the corresponding depth information of the point cloud information to determine whether the neural network has the model parameters or weights meeting or exceeding a predetermined accuracy level for generating per-pixel depth information. For example, the training system for training the neural network may generate an accuracy score of the neural network based on the comparison of the calculated depth information and the corresponding depth information in the point cloud information (included in training data sets). If the accuracy score equals or exceeds a threshold, the training process may stop, and the training system may save the trained neural network into a local storage device and/or transmit the trained neural network to one or more vehicles (e.g., vehicle 800). On the other hand, if the accuracy score is below the threshold, the training system may adjust one or more parameters or weights of the neural network and repeat the training process using training data sets until the accuracy score of the neural network is equal to or exceeding the threshold is reached (and/or a predetermined number of training cycles has been reached).

In some embodiments, before providing the images to the analysis module, processor 801 may generate a set of synthetic pinhole images sharing the orientations of the image axes and the direction of the images'principal axes, based on the images and the parameters of the cameras (e.g., the orientations of their image axes and the direction of their principal axis). This preprocessing step may allow for an efficient warp (homogeneous image scale-translate). Processor 801 may also input the generated synthetic pinhole images (rather than the original images) into the analysis module to generate an output.

In some embodiments, processor 801 may input the images into the analysis module, which may be run by processor 801. The analysis module may generate an output including per-pixel depth information for at least one region of the captured center image.

In some embodiments, vehicle 800 may receive the analysis module from a server via a network and store the analysis module in memory 802 and/or storage device 803.

In some embodiments, the generated output by the analysis module may include per-pixel depth information for at least one region (or all regions) of the captured center image. In some embodiments, the per-pixel depth information for the at least one region of the captured center image may provide or include depth information for one or more objects represented in the captured center image. In some cases, the one or more objects may not contact a ground surface (e.g., a road surface). For monocular systems, a ground plane may be needed to obtain the depth information through a process such as structure in motion, which may not be needed in the disclosed systems herein. In some embodiments, the one or more objects may be associated with a target vehicle (or being carried by the target vehicle).

In some embodiments, the per-pixel depth information for the at least one region of the captured center image may provide or include depth information for a surface of at least one object represented in the captured center image, and the surface of the at least one object may include a reflection of one or more other objects, as the analysis module may recognize surfaces based at least in part on edges of the surfaces and can recognize that reflections are on the surface and not indicative of a farther object beyond the surface.

In some embodiments, the per-pixel depth information for the at least one region of the captured center image may provide or include depth information relative to an object that is at least partially obscured from view in one or more of the at least one captured center image, the at least one captured left surround image, or the at least one captured right surround image, as the analysis module may provide depth information even where an object is partially occluded from view in one or more of the captured images.

In some embodiments, as described above, vehicle 800 may include two or more groups of cameras. For example, vehicle 800 may include a first group of cameras, including center camera 910, left surround camera 920, and right surround camera 930. Vehicle 800 may also include a second group of cameras, including a center camera located in a vicinity of the rearview mirror of vehicle 800, a left surround camera located at the left, back side of vehicle 800, and a right surround camera located at the right, back side of vehicle 800. The analysis module may be further configured to generate another output relative to at least one center image captured by the center camera of the second camera group, based on analysis of at least one captured center image, at least one captured left surround image, and at least one captured right surround image received from the cameras of the second camera group, and the another generated output may include per-pixel depth information for at least one region of the center image captured by the center camera of the second camera group. In some embodiments, the analysis module may be configured to generate per pixel depth information for at least one image captured by at least one camera in each of the first camera group and the at least a second camera group, to provide a 360-degree image-generated point cloud surrounding vehicle.

At step 1003, processor 801 may be programmed to cause at least one navigational action by vehicle 800 based on the generated output including the per-pixel depth information for the at least one region of the captured center image. For example, processor 801 may analyze the generated output including the per-pixel depth information for the at least one region of the captured center image and detect one or more objects based on the generated output. Processor 801 may also be configured to determine at least one navigational action by vehicle 800 based on the detected object(s), as described elsewhere in this disclosure. Processor 801 may further be configured to cause vehicle 800 to implement the determined navigational action, as described elsewhere in this disclosure. For example, processor 801 may determine at least one of maintaining a current heading direction and speed for vehicle 800, changing a current heading direction for vehicle 800 (e.g., turning vehicle 800), or changing a speed of vehicle 800 (e.g., accelerating or braking vehicle 800). By way of example, processor 801 may analyze the generated output and identify an object that is within a predetermined safety distance based on the analysis of the generated output. Processor 801 may also be configured to determine a navigational action for vehicle 800 to slow vehicle 800 or steer away from the identified object. Processor 801 may further be configured to control navigation system 808 to cause activation of one or more actuators associated with a steering system, a braking system, or a drive system of vehicle 800 according to one or more navigational actions.

In some embodiments, processor 801 may be configured to determine the at least one navigational action based on a combination of the per-pixel depth information for the at least one region of the captured center image and point cloud information received from LIDAR system 807. In some embodiments, processor 801 may average the depth values associated with an object appearing in both the per-pixel depth information for the at least one region of the captured center image and corresponding point cloud information received from LIDAR system 807 to obtain averaged depths values associated with the object. Processor 801 may also determine a navigational action based on the averaged depths associated with the object (e.g., maintaining the current speed and the heading direction). Alternatively or additionally, processor 801 may apply different weights to the depth values obtained from the per-pixel depth information for the at least one region of the captured center image and the depth values obtained from point cloud information received from LIDAR system 807 (which may be similar to a process described in connection with step 4104 above). Processor 801 may also be configured to determine at least one navigational action based on weighted depth values. For example, as described above, a LIDAR system may perform better in a sun glare environment (or a highly reflective environment, or a low light condition during night time without street lights, etc.) than cameras. In a sun glare environment (or a highly reflective environment, or a low light condition during night time without street lights, etc.), processor 801 may apply a higher weight to the depth values obtained based on the point cloud information received from LIDAR system 807 than the weight applied to the depth values obtained from the per-pixel depth information for the at least one region of the captured center image. On the other hand, cameras may perform better on a foggy or rainy day than a LIDAR system, and in such an environment, processor 801 apply a lower weight to the depth values obtained based on the point cloud information received from LIDAR system 807 than the weight applied to the depth values obtained from the per-pixel depth information for the at least one region of the captured center image.

### Confidence-Driven Height/Range Estimation

An autonomous or semi-autonomous vehicle traveling a road may encounter various objects on or in the vicinity of the road. In some instances, these objects may include other vehicles that are traveling on the road, other vehicles that are parked on the side of the road, objects on the road surface, and/or structures near the road, etc. In other instances, these objects may include smaller objects, such as debris (e.g., trash, boxes, etc.). When encountering an object, the autonomous or semi-autonomous vehicle may determine a range and/or height of a particular object to safely navigate.

To determine the range and/or height of a particular object, the vehicle may analyze one or more images captured by a camera onboard the vehicle. However, on some occasions, analysis of the one or more images may identify features in an environment of the vehicle that are not actual objects. For example, a false positive may occur due to a shadow cast from a nearby object that is not actually present at the shadow's location. As another example, a false positive may occur due to a substance on the road such as a puddle of water. As yet another example, a false positive may occur due to noise in a data set that is analyzed by one or more systems of the vehicle. In any of these situations, a false positive may pose challenges to the vehicle when assessing whether a certain feature constitutes an object that warrants further attention and/or a navigational response by the vehicle. To address these challenges, the vehicle navigation system may be configured to accurately assess the range and/or height of road objects and filter out false positives to navigate efficiently and safely. The disclosed embodiments are aimed at addressing these challenges.

In the disclosed embodiments, a host vehicle (e.g., an autonomous or semi-autonomous vehicle) may include one or more systems configured to estimate a range and/or height of a feature within an image by inferring range (and/or depth) information in the pixels of images captured by one or more cameras. For example, the disclosed one or more systems may identify an object in one or more images captured by a camera associated with the host vehicle and estimate the range (or height) of the object. Alternatively, or additionally, the disclosed one or more systems may analyze data output by any one or more sensors associated with the host vehicle (e.g., one or more cameras, LIDARs, and radars, etc.).

Regarding the terms range and depth, a range to an object may refer to a distance between a sensor (e.g., a camera, LIDAR, etc.) location and a point on a detected object. The term depth may refer to the distance between a sensor location and a plane including a point on a detected object, where the plane is normal to a central axis associated with the sensor (e.g., an optical axis of a camera). Where a particular point of a detected object lies on the central axis of the sensor, the range and depth (e.g., Z coordinate) to the particular point are the same. Where a particular point is located away from the central axis of the sensor, the range and depth values will be different, but each is derivable from the other via trigonometric relationships. For convenience, and unless otherwise specified, the terms range and depth will be treated as synonymous for purposes of this disclosure.

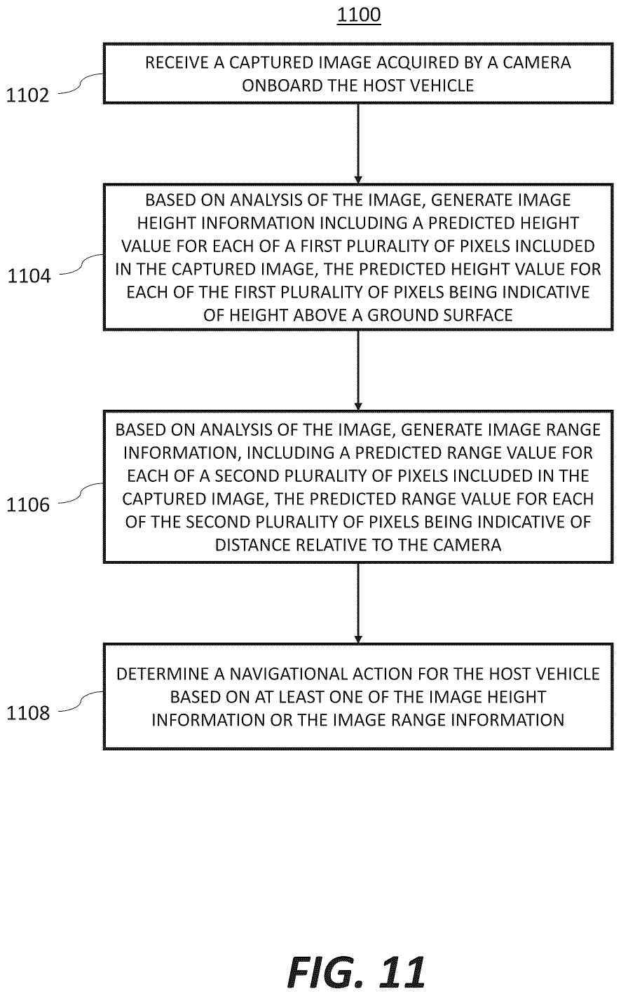

FIG. 11 is a flowchart showing an exemplary process 1100 for navigating a host vehicle relative to a road segment, consistent with the disclosed embodiments. More specifically, process 1100 may enable the generation of image height information and image range information. In accordance with the disclosed embodiments, such a process may be executed by at least one processor or processing unit, such as processor 801 included in vehicle 800 or processing unit 110 of system 100 (implemented in host vehicle 200). The host vehicle (e.g., host vehicle 800) may include one or more cameras 806 (e.g., cameras 910, 920, and 930). While process 1100 is described below using vehicle 800 as an example, one skilled in the art would understand that a server (e.g., one or more servers described in this disclosure) may also be configured to perform one or more steps of process 1100. For example, vehicle 800 may transmit at least one image captured by one or more cameras 806 to a server via a network. The server may then be configured to generate, based on the at least one captured image, image height information and image range information. The server may also be configured to transmit such image range and height information to vehicle 800 for further processing. Consistent with other disclosed embodiments, a non-transitory computer-readable storage media may store program instructions, which are executed by at least one processing device to perform process 1100.

At step 1102, processor 801 may receive a captured image acquired by a camera onboard the host vehicle. Consistent with the disclosed embodiment, the captured image may include a representation of at least a portion of the environment of the host vehicle. For example, processor 801 may receive a plurality of images captured by camera 910 from the environment of host vehicle 800. In some embodiments, the camera may include a plurality of cameras configured to capture a plurality of images of the environment of the host vehicle. For example, referring to FIG. 9, processor 801 may receive a first plurality of images captured by center camera 910, a second plurality of images captured by left surround camera 920, and a third plurality of images captured by right surround camera 930 from the environment of host vehicle 800. As described elsewhere in this disclosure, in some embodiments, the Field OF View (FOV) of center camera 910 may at least partially overlap with both the FOV of left surround camera 920 and the FOV of right surround camera 930.

At step 1104, processor 801 may, based on analysis of the image (e.g., the image captured by one of cameras 806 of host vehicle 800), generate image height information including a predicted height value for each of a first plurality of pixels included in the captured image. In some embodiments, the predicted height value for each of the first plurality of pixels may be indicative of height above a ground surface. For example, these predicted height values may indicate the height of objects or features located in the environment of the host vehicle above the ground surface. Additionally in some embodiments, the ground surface may correspond to a road surface associated with the road segment (e.g., the road segment in which the host vehicle is traveling on).

At step 1106, processor 801 may, based on analysis of the image (e.g., the image captured by one of cameras 806 of host vehicle 800), generate image range information, including a predicted range value for each of a second plurality of pixels included in the captured image. In some embodiments, the predicted range value for each of the second plurality of pixels may be indicative of distance relative to the camera. For example, these predicted range values may indicate the distance of objects or features located in the environment of the host vehicle relative to the camera. By extension, the range relative to the foremost part of the vehicle may be determined based on the predicted range values relative to the camera. As used herein, range refers to the distance from the camera to a specific point or object in the scene represented in the captured image, while depth refers to the distance of a point or object in the scene from a reference plane, typically the camera's image plane. Although these two values are distinct, the determination of one can be intertwined with the determination of the other. Consequently, both depth and range may be determined concurrently, with the range being influenced by the depth value and vice versa.

In some embodiments, the first plurality of pixels (for which height information is generated) may coincide with the second plurality of pixels (for which range information is generated). Alternatively, in some other embodiments, the first plurality of pixels may be different from the second plurality of pixels. As used herein, different pluralities or sets of pixels may refer to mutually exclusive sets (i.e., there are no common pixels between the two sets) or partially overlapping sets (i.e., there is at least one common pixel between the two sets). In other words, the first and second pluralities of pixels may in some situations be the same, meaning the same pixels are used to determine both height and range. In other cases, they may be different, with some overlap or entirely distinct. Furthermore, in some embodiments, at least one of the first plurality of pixels or the second plurality of pixels may include all pixels of the captured image. Alternatively, in some other embodiments, at least one of the first plurality of pixels or the second plurality of pixels may include less than all pixels of the captured image. Therefore, the first and second pluralities of pixels may sometimes be identical and represent the entire captured image or a portion of it. In other situations, the first and second pluralities of pixels may be mutually exclusive and collectively exhaustive (i.e., representing the entire captured image), distinct and not representing the entire captured image, overlapping and covering the entire or a portion of the captured image, or one plurality may be included within the other.

Accordingly, selecting the first and second pluralities of pixels may involve determining the areas of interest in the captured image for which height and/or range information is relevant. This determination may involve the use of a pre-segmentation algorithm. These algorithms may scan the image to identify and segment different features or objects, such as vehicles, pedestrians, or obstacles. Based on the output of such pre-segmentation, processor 801 may decide which features or objects require height and/or range information. The choice of pixels may be based on the need for height and/or range information to understand the 3D structure and distances in the host vehicle's environment. In some situations, the number of objects or features within the image may be sufficiently important to trigger the analysis of the entire image (in which case either or both of the first and second pluralities of pixels include all pixels of the captured images). In some other scenarios, only specific areas of interest may be identified (in which case either or both of the first and second pluralities of pixels represent portions of the captured image). By focusing on specific areas of interest, processor 801 may more accurately interpret valuable information needed for navigation. This targeted approach may help in avoiding unnecessary processing of irrelevant parts of the image, thus optimizing the vehicle's decision-making process and ensuring safe and efficient operation.

Generating per-pixel height information and/or per-pixel range information from a captured image may involve several techniques to infer the 3D structure of a scene (e.g., in the environment of the host vehicle). For example, as described elsewhere in this disclosure, stereo vision analysis, which involves two or more cameras at different angles (e.g., camera 910, 920, and 930 of host vehicle 800), may be used to calculate range and/or height by comparing the disparity between images. In another scenario, Structure from Motion (SfM) may be employed to reconstruct the 3D scene from a sequence of images taken from different positions as the host vehicle moves. In yet another example, LIDAR sensors (e.g., LIDAR system 807 included in host vehicle 800) which provide distance measurements, may be fused with camera images to create dense range/height 3D maps. Implementing these methods entails capturing and preprocessing multiple images, detecting and matching features, estimating range and/or height, postprocessing the 3D maps, and potentially incorporating data from other sensors.

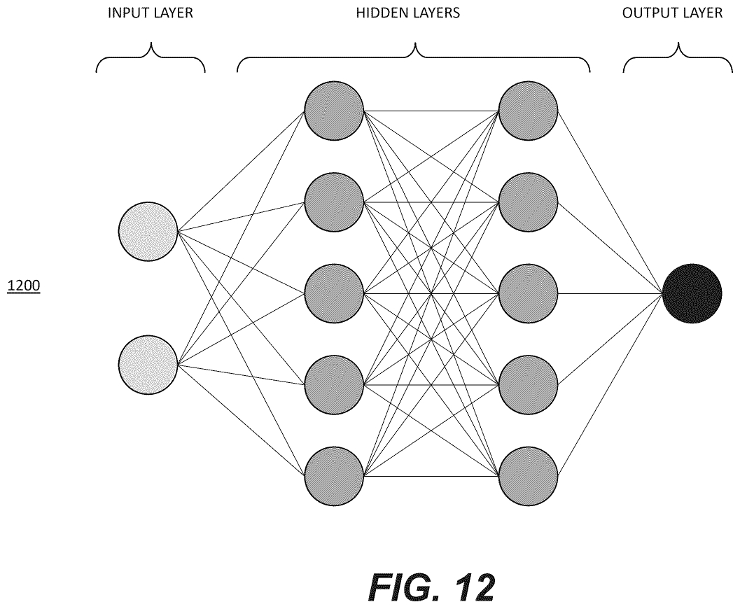

Alternatively, when relying on a single image captured by a single camera, models such as machine learning, deep learning, or neural networks, trained on extensive datasets, may predict range and/or height. These models may analyze the image and learn patterns to estimate the spatial characteristics of objects and surfaces depicted within it. By leveraging these trained models, accurate range and/or height information may be inferred from a single image, enabling efficient and effective scene understanding for autonomous navigation systems. For example, in some embodiments, a trained neural network may be configured to generate both the image height information for each of the first plurality of pixels and the image range information for each of the second plurality of pixels based on receiving the captured image as input. As used herein, a trained neural network may refer to any set of interconnected input/output units (nodes), where each connection may be assigned a weight, each node may be assigned a specific activation function, and which is “trained” by processing each of a plurality of examples with known input and output in order to learn and improve its accuracy. A general purpose of a trained neural network may be to solve complex problems, such as summarizing a large quantity of data or recognizing patterns/features in a set of images/data. Trained neural network nodes may be arranged in different layers, such as an input layer, one or more hidden layers, and an output layer. Activation functions define the output of a node given an input and decide whether or not a node should be activated, i.e. whether the node's contribution to the trained network is relevant. For example, if the output of any neural network node is above a specific threshold value, that node is activated, sending data to the next layer of the network. FIG. 12 illustrates an exemplary trained neural network architecture 1200 including an input layer comprising two nodes, two hidden layers each comprising five nodes, and an output layer with a single node. The trained neural network shown in FIG. 12 is an example, and the number of nodes, layers, type of nodes, and arrangement of the nodes may differ from one trained neural network to another. Indeed, as the purpose of each trained neural network may be different, the architecture employed may vary accordingly. Examples of types of neural networks may include feedforward neural networks, recurrent neural networks, and convolutional neural networks. In terms of hardware implementation, the range of possible hardware components is equally wide, from general-purpose processors to fully customized hardware chips. Examples of hardware components used to implement a trained neural network may include, CPUs (central processing units) GPUs (graphics processing units), ASICs (application-specific integrated circuits), FPGAs (field-programmable gate arrays), CMOS microcontrollers, neurochips or neurocomputers. Such a trained neural network could be integrated into the functionality of processor 801, stored within memory 802 of the system, or alternatively, it might be housed on a remote server accessible to processor 801 via communication port 804 for data exchange. This setup allows processor 801 to access the neural network model and perform range and/or height prediction tasks efficiently, either locally or remotely.

To train a neural network such as neural network 1200 for determining pixel range and/or height information, a training dataset comprising images paired with corresponding ground truth range or height maps may be used. This dataset should encompass diverse scenes and environments, covering various lighting and weather conditions, alongside different object types. Each image in the dataset may be annotated with its accurate range and/or height values for every pixel, achieved through meticulous data annotation. To enhance the dataset's diversity and model robustness, data augmentation techniques like random transformations and noise addition can be applied. Additionally, in some cases, the training dataset may include range and/or height information provided by point clouds generated by a LIDAR system. Subsequently, the dataset may be split into training, validation, and test sets, with the training set utilized to train the neural network, the validation set for hyperparameter tuning and progress monitoring, and the test set for evaluating model performance. Preprocessing steps such as resizing, normalization, and any necessary data transformations may be applied to the images and corresponding range/height maps. The neural network may be then trained using appropriate loss functions and optimization algorithms, aiming to minimize the disparity between its predictions and the ground truth values provided in the training data. Through this process, the neural network learns to infer range and/or height values for pixels in new images encountered during inference.

In some embodiments, the generation of the range information may be based, at least in part, upon previously generated height information. Conversely, in other embodiments, the generation of height information may be based, at least partially, upon previously generated range information. This reciprocal relationship suggests that the trained neural network may utilize insights gleaned from one aspect of the scene (either height or range) to inform and refine its predictions regarding the other aspect. For instance, by incorporating height information, the network may better estimate the distance to objects in the scene, aiding in the generation of accurate range information. Similarly, utilizing range information may enhance the network's ability to determine the vertical position of objects, thereby improving the generation of height information. For instance, within the framework of perspective projection, a pixel coordinate (e.g., v from a couple of 2D coordinates (u, v)) associated with an image height is given by the ratio of the corresponding 3D world coordinate (e.g., Y from a set of 3D coordinates (X, Y, Z)) in the camera frame (representing height above a ground surface) with the coordinate representing the depth (e.g., Z), multiplied by the focal distance (e.g., f) of the camera system (i.e., v=Y/fZ).

Consequently, for a given pixel coordinate, two unknowns exist: the pixel's height information and its corresponding depth and therefore range. In this scenario, multiple combinations of pixel depth/range and height information may correspond to the same pixel position due to the inherent ambiguity of the relationship. However, if the trained neural network initially determines the height information (Y), this knowledge can refine the estimation of depth (Z), or vice versa. This bidirectional interaction underscores the interconnectedness of range and height estimation tasks and highlights the adaptive nature of the neural network in leveraging multiple sources of information to refine its predictions.

In some embodiments, a first-trained neural network may be configured to generate the image height information based on receiving the captured image as input, and a second-trained neural network may be configured to generate the image range information based on receiving the captured image as input. In other words, rather than having a single trained neural network configured to generate both height and range information, two distinct neural networks, a first and a second, may be employed. Each network may be specifically designed: the first for generating image height information and the second for generating image range information, both based on receiving the captured image as input. With two distinct neural networks in place—one dedicated to height and the other to range—the system may benefit from specialized models trained and optimized for their respective tasks, potentially enhancing accuracy and efficiency in range and/or height perception tasks. Consistent with the disclosed embodiments, the first and second trained neural networks could be integrated into the functionality of processor 801, stored within memory 802 of the system, or alternatively, housed on a remote server accessible to processor 801 via communication port 804 for seamless data exchange. This setup enables processor 801 to access both the first and second trained neural networks, facilitating range and/or height prediction tasks, whether performed locally or remotely.

Additionally, in some embodiments, the generation of the range information by the second trained neural network may be based, at least in part, upon the height information generated by the first trained neural network. Conversely, the generation of the height information by the first trained neural network may be based, at least in part, upon the range information generated by the second trained neural network. In other words, one of the first or second neural networks may utilize the output of the other neural network, in addition to the captured images, as input. For instance, the second neural network tasked with generating range information may incorporate the height information generated by the first neural network into its calculations, alongside the captured images. Conversely, the first neural network responsible for generating height information may utilize the range information produced by the second neural network, along with the captured images, to refine its predictions. This collaborative approach may enable each neural network to benefit from the insights provided by the other, resulting in more accurate range and/or height perception and improved overall performance.

In some embodiments, processor 801 may be further programmed to determine a confidence level associated with the range and/or height information generated for the captured images. This confidence level can provide an indication of the reliability and accuracy of the inferred data. By evaluating various factors, such as the quality of the input image, the consistency of the inferred data with prior knowledge or other sensor inputs, and the performance metrics of the neural networks used, processor 801 can assign a confidence score to each range and height estimation. This confidence level can then be used to make more informed decisions, such as prioritizing high-confidence data for critical navigational tasks or flagging low-confidence data for further review or supplementary sensing.

In some embodiments, the confidence level may represent a prediction or an estimate that at least one object constitutes an actual object (as opposed to, e.g., a shadow, puddle of water, or noise in the analyzed data set). In some embodiments, processor 801 may be further configured to filter out per-pixel height and/or range information for one or more objects based on a comparison of the per-pixel height and/or depth information for the one or more objects to a threshold. For example, processor 801 may filter one or more objects that do not meet or exceed the threshold. In some embodiments, the threshold may be user-selectable (e.g., provided by an input device or by a voice command). In other embodiments, the threshold may be determined by one or more systems associated with the host vehicle. For example, in some instances, the threshold may be based on historical information indicating a reliability of a data set. In other instances, the one or more parameters may relate to conditions present at a particular location associated with the host vehicle (e.g., light conditions, weather conditions, etc., which may result in potential false positives).

At step 1108, processor 801 may determine a navigational action for the host vehicle based on at least one of the image height information or the image range information. For example, processor 801 may determine the at least one navigational action by using a navigation module or system (e.g., navigational system 808). In some embodiments, the navigational action may include at least one of slowing the host vehicle or changing a heading direction of the host vehicle. Additionally, processor 801 may be further programmed to cause at least one actuator associated with the host vehicle to implement the navigational action. For example, processor 801 may cause the activation of one or more actuators associated with a steering system (e.g., maintaining or changing a current heading direction), a braking system (e.g., reducing a current speed), or a drive system of vehicle 800 (e.g., accelerating, deaccelerating, reducing a current speed).

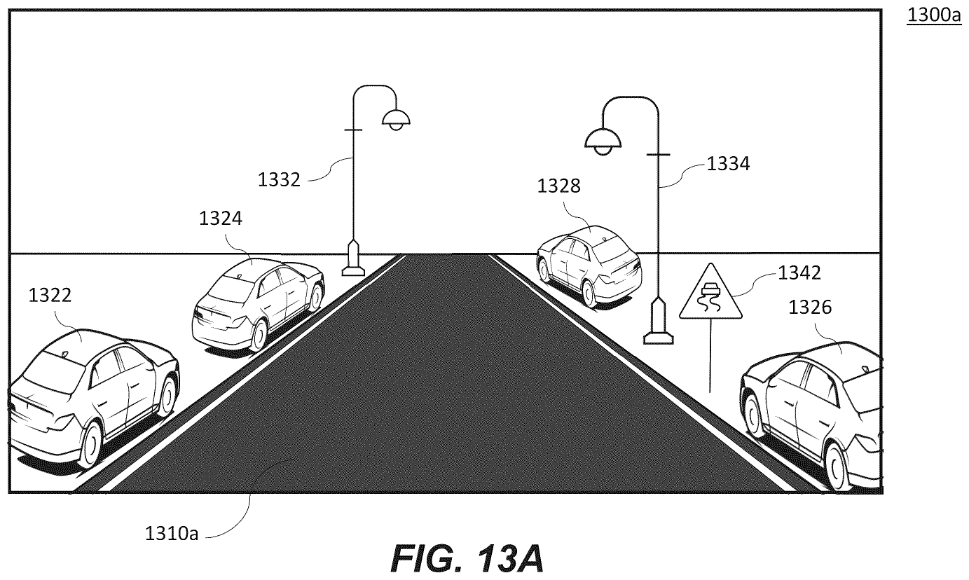

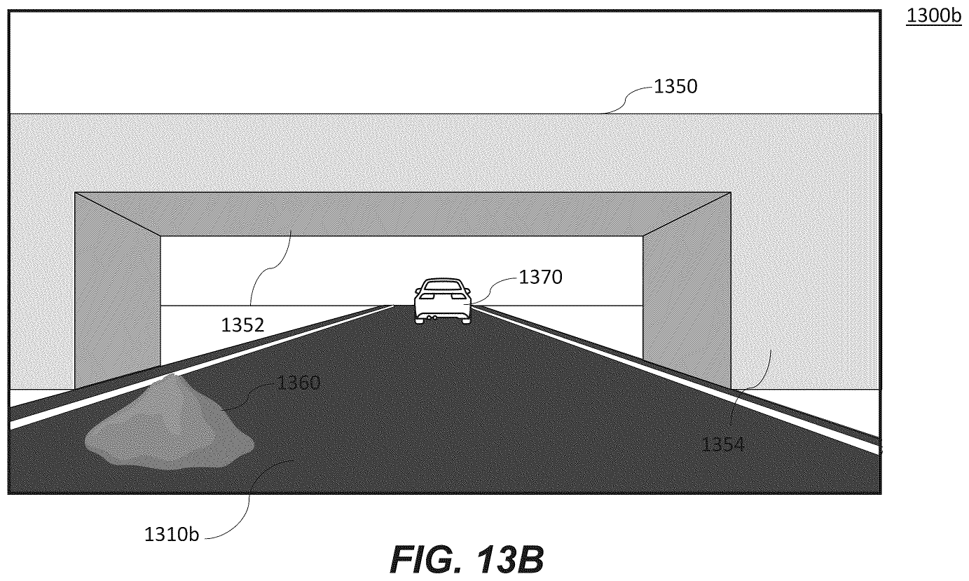

FIGS. 13A and 13B illustrate two exemplary images, 1300a and 1300b, captured by an onboard camera (e.g., camera 910) in host vehicle 800 traveling on road segments 1310a and 1310b. Consistent with the disclosed embodiments, both images 1300a and 1300b depict the environment surrounding host vehicle 800 and include representations of various objects or features within that environment. In the example shown in FIG. 13A, multiple vehicles—1322, 1324, 1326, and 1328—are parked on both sides of road segment 1310. The scene also includes other objects such as lamp posts 1332 and 1334, as well as a road sign 1342. In the scenario depicted in FIG. 13B, road segment 1310b passes under a bridge structure 1350. The scene further includes additional objects such as road debris 1360 (a sand pile in this example) and a target vehicle 1370 traveling in front of host vehicle 800.

Consistent with the disclosed embodiments, once received by processing unit 801, both images 1300a and 1300b may be analyzed to generate image height information, including a predicted height value for each of a first plurality of pixels in the captured images. This predicted height value for each of the first plurality of pixels may indicate the height above a ground surface (e.g., road surface associated with road segment 1310a or 1310b). Additionally, image range information may be generated, including a predicted range value for each of a second plurality of pixels in the captured images, with the predicted range value indicating the distance relative to the camera. As mentioned earlier, the first and second pluralities of pixels may be identical or different and may represent either a portion or the entirety of images 1300a and 1300b. The selection of these pixel pluralities may be based on areas of interest and the determination of whether height and/or range information is relevant. For example, referring to FIG. 13B, it may be beneficial to determine both height and range information for road debris 1360, but only range information for the facade 1354 of bridge structure 1350, and height information for the central deck 1352. Once the image height and/or image range information associated with images 1300a and 1300b has been generated, processor 801 may determine a navigation action for host vehicle 800. Processor 801 may then cause one or more actuators associated with host vehicle 800 to implement the navigational action, ensuring that host vehicle 800 responds appropriately to the environment represented in the scenes of images 1300a and 1300b.

In some embodiments, the determined navigational action may include an evasive maneuver if the height information indicates that an object in an environment of the host vehicle has a height above a predetermined threshold. As defined herein, this predetermined threshold could correspond to a height value associated with one or more specific components of the host vehicle. For example, in some embodiments, the predetermined threshold may be less than a ground clearance of the host vehicle. Consequently, if the system detects an object with a height exceeding this predetermined threshold, it would trigger an evasive maneuver to avoid potential collision or obstruction, as the host vehicle could not travel on top or above of such an object. This proactive approach may ensure the safety of the vehicle and its occupants by preemptively addressing height-related hazards in the surrounding environment. For example, referring to FIG. 13B, if the height of road debris 1360 is above a predetermined threshold (e.g., the ground clearance of host vehicle 800), processor 801 may determine a navigational action that entails an evasive maneuver to avoid colliding with road debris 1360. This could involve altering the vehicle's trajectory to steer clear of the debris and maintain safe passage along road segment 1310b.

Conversely, in some embodiments, the determined navigational action may involve initiating an evasive maneuver if the height information indicates that an object in the host vehicle's environment hangs below another predetermined threshold. In this context, the predetermined threshold could represent a minimum clearance level set to ensure safe passage beneath obstacles, such as the vehicle's height. For example, if the system detects an object with a height below this predetermined threshold, it may trigger an evasive maneuver to prevent the vehicle from colliding with or becoming entangled in the hanging obstacle. For instance, referring to FIG. 13B, if the maximum height required to pass under bridge structure 1350 is below the vehicle's height, processor 801 may determine a navigational action that involves an evasive maneuver to avoid passing under bridge structure 1350.

In some embodiments, processor 801 may be further programmed to identify an object in an environment of the host vehicle based, at least in part, on the height information. This identification process may involve analyzing the generated image height information data to recognize patterns and features characteristic of various objects. By leveraging the image height information including predicted height values, processor 801 may enhance object detection accuracy, distinguishing between different types of objects based on their height profiles. Additionally, in some other embodiments, this identification process may be integrated with other derived data, such as image range information, to provide a comprehensive understanding of the surroundings of the host vehicle. This multi-faceted approach may enable processor 801 to make more informed decisions for navigation, obstacle avoidance, and safety measures with respect to host vehicle 800. As described elsewhere in this disclosure, the identified objects may then be tracked and monitored, enabling the host vehicle to respond dynamically to changes in the environment.

In some embodiments, the (identified) object may include at least one projecting portion suspended above the ground surface. This could include a variety of objects that have elements protruding above the ground surface while being supported by structures anchored to the road at the level of the ground surface. Accurately identifying these projecting portions may enhance the navigation system's spatial awareness, enabling the host vehicle to navigate safely under or around these suspended structures. This capability may be beneficial for avoiding collisions with low-hanging objects (i.e., objects at a height below the host vehicle's height) and ensuring the vehicle's path remains clear and obstacle-free.

For example, in some embodiments, the at least one projecting portion may be associated with a boom gate. Boom gates are often installed at entrances or exits to restricted areas, such as parking lots or toll booths, and are characterized by a horizontal arm that can be raised or lowered to control vehicle access. By recognizing the presence of a boom gate based on its projecting portion, processor 801 may interpret the operational status of access control systems. This information may enable the host vehicle to navigate securely through controlled access points, ensuring adherence to traffic regulations and facilitating seamless passage through restricted areas.

In some other embodiments, wherein the at least one projecting portion may be associated with a road sign or a lamp post. A road sign or a lamp is typically supported by a pole, bridge, or other structure securely anchored into the ground away from the road surface, while the signboard or the lamp fixture (or other portion of the sign or lamp) extends above the road surface. Identifying these distinctive features allows the host vehicle to assess the safety of traveling on the road segment without risk of collision, particularly if the lamp/lamp post is low or the road sign is excessively protruding onto the road segment. For example, referring to FIG. 13A, processing unit 801 may identify lamp posts 1332 and 1334 as well as road sign 1342 and determine whether or not the path of the host vehicle is clear. This analysis enables the vehicle to make appropriate navigation decisions, avoiding potential obstacles and ensuring safe passage along road 1310a.

Alternatively, in some other embodiments, the at least one projecting portion may be associated with a parked vehicle. These projecting elements could encompass various features, such as an open door or a wide load on a truck, which extend beyond the typical dimensions of the vehicle. An open door indicates the presence of a stationary vehicle, potentially obstructing part of the roadway. Similarly, a wide load on a truck poses a significant spatial obstacle due to its protruding cargo, requiring careful navigation to avoid collisions. Referring to FIG. 13A, if the door of vehicle 1324 were opened, the processing unit 801 would identify the opened door and deduce that the path of the host vehicle is obstructed. Consequently, processing unit 801 would determine and initiate an evasive maneuver to avoid a potential collision with the open door.

In some embodiments, the (identified) object may include at least one suspended portion extending above the ground surface. This could include a variety of objects that have distinct elements suspended above the ground surface and not directly anchored into the ground. By recognizing these suspended elements, the system gains valuable spatial awareness, enabling it to navigate safely under or around these structures. This capability may be beneficial for ensuring the host vehicle can maneuver effectively through environments where overhead obstacles may pose risks to clearance or safety.

For example, in some embodiments, the at least one suspended portion may be associated with a bridge structure. Bridges typically comprise overhead elements, such as arches, beams, or cables, that extend across the road surface without direct support from the ground. By recognizing these suspended components, the system may enhance its spatial awareness, enabling it to navigate safely under or around bridge structures. For example, referring to FIG. 13B, processor 801 may identify central deck 1354 and determine whether or not the path of the host vehicle is clear.

In some other embodiments, the at least one suspended portion may be associated with a road access control structure. These structures often feature suspended elements that extend above the road surface to control traffic flow. For example, in some embodiments, the road access control structure may include a cable or a chain. Alternatively, in some other embodiments, the road access control structure may include a suspended gate. By recognizing these suspended components, the system may enhance its spatial awareness, enabling it to navigate safely under or around road access control structures. This capability may ensure that the host vehicle can pass through controlled access points without encountering obstacles or disruptions to its route.

In some embodiments, processor 801 may be further programmed to determine, based on the height information, a height associated with a closest approach point associated with an object in an environment of the host vehicle. In this context, the “closest approach point” refers to the point on the object in the environment of the host vehicle where the distance between the host vehicle and the object is minimal during a given maneuver or trajectory. It may represent the closest distance between the host vehicle and the object along their respective paths of travel, or along the path of travel of the host vehicle if the object is fixed. This notion may enable to determine whether the vehicle can safely pass by or navigate around the object without risk of collision or obstruction. Processor 801 may then analyze the height information to determine the height associated with this closest approach point, providing valuable insight into the spatial relationship between the host vehicle and surrounding objects to facilitate safe navigation.

In some embodiments, the closest approach point may be associated with an open door of a parked vehicle. In such a scenario the closest approach point associated with an open door of a parked vehicle would be the point where the door extends furthest into the path of the host vehicle, representing the closest potential point of contact. The height determined would correspond to the vertical distance between the point where the door extends furthest into the path of the host vehicle and the ground surface.

In some embodiments, the closest approach point may be associated with a side of a parked vehicle. In this case, the closest approach point associated with a side of a parked vehicle would be the point where the vehicle's side extends closest to the path of the host vehicle, indicating the closest potential proximity. The height determined would correspond to the vertical distance between the closest point of the vehicle's side to the ground surface.

In some embodiments, the closest approach point may be associated with a target vehicle. In this scenario, the closest approach point associated with a target vehicle would be the point where the target vehicle is closest to the path of the host vehicle, indicating the point of potential closest encounter. The height determined would correspond to the vertical distance between the point of closest encounter and the ground surface.

In some embodiments, the closest approach point may be associated with a portion of a curb along the road segment. For a curb along the road segment, the closest approach point would be the point where the curb protrudes closest to the path of the host vehicle, representing the closest potential point of contact. The height determined would correspond to the vertical distance between the point where the curb protrudes closest to the path of the host vehicle and the ground surface.

In some embodiments, the closest approach point may be associated with a roadside barrier positioned relative to the road segment. In this scenario, the closest approach point associated with a roadside barrier would be the point where the barrier is nearest to the path of the host vehicle, representing the closest potential obstruction. The height determined would correspond to the vertical distance between the barrier and the ground surface.

In some embodiments, the closest approach point may be associated with a cargo loaded on a transport vehicle. For cargo loaded on a transport vehicle, the closest approach point would be the point where the cargo extends closest to the path of the host vehicle, indicating the closest potential interference. The height determined would correspond to the vertical distance between the point of the cargo and the ground surface.

In some embodiments, the closest approach point may be associated with an overhanging edge of an object disposed in a vicinity of the road segment. In this case, the closest approach point associated with an overhanging edge of an object would be the point where the edge hangs closest to the path of the host vehicle, representing the closest potential obstacle overhead. The height determined would correspond to the vertical distance between the lowest point of the overhanging edge and the ground surface.

In any of the above-mentioned scenarios, the determined height associated with the closest point of approach may enable the determination of a free space region associated with a road segment. This determined height may facilitate the demarcation of a region where the host vehicle can maneuver freely, unimpeded by potential obstacles or hazards. For instance, the identified free space region may encompass the road surface area that remains accessible and safe for navigation by the host vehicle. By leveraging the determined height associated with the closest point of approach, the system may define the boundaries of this navigable space, enabling the host vehicle to traverse the road segment with enhanced awareness and safety precautions. This delineation of the free space region may contribute to optimized route planning and execution, ensuring smooth and unobstructed travel along the designated path.

While the previous description illustrates processor 801 capability of determining both image height information and image range information, it is to be appreciated that in certain scenarios, processor 801 may possess the capacity to ascertain only either image height information or image range information. This variation in functionality may be attributed to specific system configurations or operational requirements tailored to different use cases. For instance, in applications where depth or range perception is of primary importance, processor 801 may solely focus on generating image range information to accurately gauge distances within the environment. Conversely, in situations where assessing vertical dimensions is of primary importance, processor 801 may prioritize the derivation of image height information to understand elevation variations and potential obstructions. This adaptability highlights the system's versatility in accommodating diverse operational needs, ensuring its effectiveness across a spectrum of autonomous vehicle functionalities.

Processor 801 determination of whether height information or range information takes precedence may rely on several factors associated with the operational context. Task requirements may serve as a guide, directing the focus based on the specific demands of the navigational task at hand. Concurrently, processor 801 may assess the environmental nuances captured by sensors, discerning whether height details or range distances hold greater significance in ensuring safe navigation. Additionally, user input or pre-programmed directives may inform processor 801 decision-making process, offering valuable insights into prioritization preferences. This decision framework may be further enriched by real-time feedback, allowing processor 801 to adapt its prioritization strategy based on observed outcomes, thereby continuously optimizing navigation efficacy. Through this holistic approach, processor 801 may determine the balance between height and range information, strategically allocating resources to fulfill the primary objectives of safe and efficient navigation.

### Velocity from Images

Autonomous vehicle (AV) navigation relies on accurate perception of the environment of the host vehicle. As noted, the disclosed systems are configured to include an image-based machine-vision component such that a host vehicle navigation system can receive captured images representative of the environment of the host vehicle, automatically analyze the captured images (or portions of the captured images, secondary representations of objects or features represented in the captured images, etc.), and based on the analysis, extract or derive information associated with one or more aspects of the environment of the host vehicle. One challenge in the domain of image-based machine vision is detecting or identifying moving objects. The challenge increases in cases where the moving objects are slow-moving, as, across a series of captured images, the image motion effects associated with motion of a slow-moving object (e.g., changes in image location of a representation of the slow-moving object across a series of two or more images) may be masked by image motion effects associated with ego-motion of the host vehicle. For example, it may be difficult or impossible in some cases to determine based on analysis of a series of images whether apparent image motion effects associated with an identified object are caused by real-world motion of the identified object, noise in a measurement of image motion effects attributed to motion of the host vehicle, a combination of these factors, or other factors. In other words, as an AV traverses a road segment, it may capture a series of images where the relative real-world positions of objects change due to both the motion of the objects and the AV's own movement (ego-motion). This dual motion may obscure the detection of certain objects (especially slow-moving objects), making it difficult to quantify their motion, especially when the motion effects (e.g., changes in image position of those objects over a series of images) are subtle and masked by the AV's ego-motion. Traditional optical flow and homography algorithms, traditionally used for motion detection in image analysis, have inherent limitations that exacerbate this issue in cases where the sensor capturing the images is itself in motion —-a commonplace situation experienced by AVs and advanced driver-assistance systems (ADAS) equipped vehicles. These limitations may become even more pronounced with noisy images, which are often encountered in real-world scenarios. Thus, there is a need for an improved image-based machine-vision system that can more accurately identify the motion characteristics of objects in an environment of a host vehicle, especially in cases where the host vehicle is in motion. The need for such a system is especially acute where objects moving in the environment of the host vehicle are slow-moving, such that image motion characteristics of image representations of those objects may be masked by effects of host vehicle ego motion. The disclosed embodiments are aimed at addressing these challenges.

In the disclosed embodiments, a host vehicle (e.g., an autonomous or semi-autonomous vehicle) may include one or more systems configured to determine movement information associated with at least one object represented in images captured by a camera. Furthermore, the disclosed one or more systems may take into account the host vehicle ego-motion when determining movement information associated with the at least one object (e.g., whether an object is in motion, a speed or velocity of the object, etc.). Alternatively, or additionally, the disclosed one or more systems may analyze data output by any one or more sensors associated with the host vehicle (e.g., one or more cameras, LIDARs, and radars, etc.) in determining the movement information associated with the at least one object.

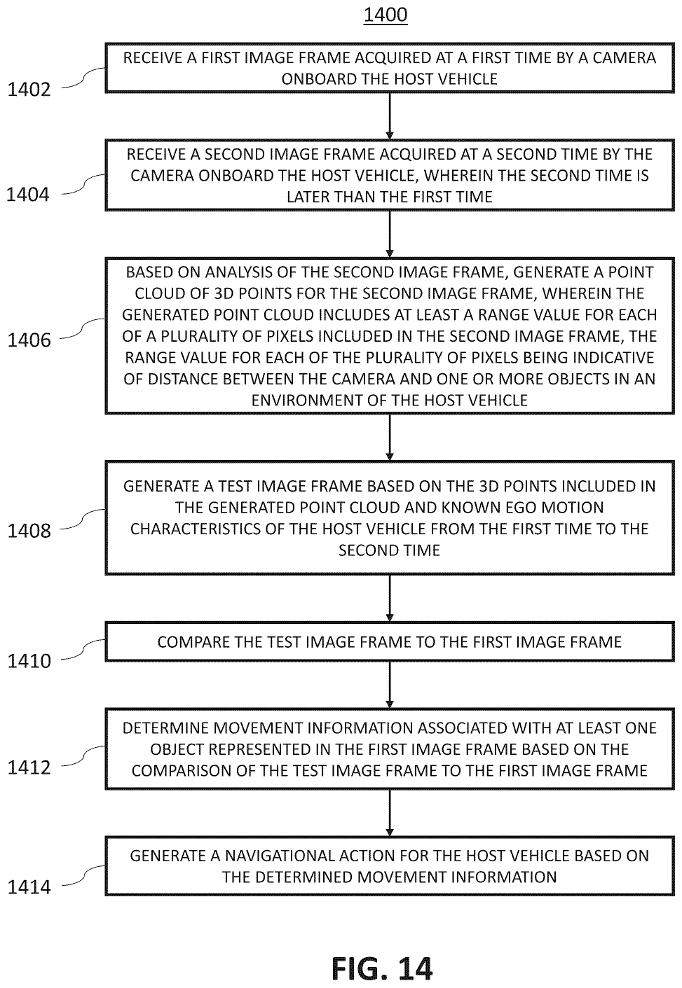

FIG. 14 is a flowchart showing an exemplary process 1400 for navigating a host vehicle relative to a road segment, consistent with the disclosed embodiments. More specifically, process 1400 may enable the determination of movement information associated with at least one object in the environment of the host vehicle. In accordance with the disclosed embodiments, such a process may be executed by at least one processor or processing unit, such as processor 801 included in vehicle 800 or processing unit 110 of system 100 (implemented in host vehicle 200). The host vehicle (e.g., host vehicle 800) may include one or more cameras 806 (e.g., cameras 910, 920, and 930). While process 1400 is described below using vehicle 800 as an example, one skilled in the art would understand that a server (e.g., one or more servers described in this disclosure) may also be configured to perform one or more steps of process 1400. For example, vehicle 800 may transmit at least one image captured by one or more cameras 806 to a server via a network. The server may then be configured to generate movement information associated with at least one object. The server may also be configured to transmit such movement information to vehicle 800 for further processing. Consistent with other disclosed embodiments, a non-transitory computer-readable storage media may store program instructions, which are executed by at least one processing device to perform process 1400.

At step 1402, processor 801 may receive a first image frame acquired at a first time by a camera onboard the host vehicle. Consistent with the disclosed embodiments, the acquired first image frame may include a representation of at least a portion of the environment of the host vehicle. For example, processor 801 may receive a first image frame captured by camera 910 from the environment of host vehicle 800. In some embodiments, the acquired first image frame may be associated with a first timestamp, indicative of the first time at which the first image frame was acquired. For example, this first timestamp may be included in metadata associated with the image frame.

At step 1404, processor 801 may receive a second image frame acquired at a second time by the camera onboard the host vehicle. The second time may be later than the first time. Consistent with the disclosed embodiment, the acquired second image frame may include a representation of at least a portion of the environment of the host vehicle. For example, processor 801 may receive a second image frame captured by camera 910 from the environment of host vehicle 800. In some embodiments, the first and the second image frames may include the same or a substantially similar representation of the at least one portion of the environment of the host vehicle, thereby allowing for a comparative analysis between the two frames, which may be useful for various applications such as detecting changes or identifying moving objects. In some embodiments, the first and second image frames may differ in their representation, at least in part due to the host vehicle's ego-motion and/or the relative motion of objects within the host vehicle's environment.

In some embodiments, the acquired second image frame may be associated with a second timestamp, indicative of the second time at which the second image frame was acquired. For example, this second timestamp may be included in metadata associated with the image frame. Consistent with the disclosed embodiments, the second time at which the second image frame was acquired may be later than the first time at which the first image frame was acquired, thereby ensuring a chronological sequence in the captured data. This sequential capturing of image frames may allow processor 801 to track changes over time within the host vehicle's environment, enhancing situational awareness and supporting functions such as navigation, obstacle detection, and autonomous decision-making. In some embodiments, the first and second image frames may be consecutive. In other words, the second image frame may correspond to the image frame acquired immediately after the first image frame. The time difference between the first and second frames may therefore be determined by the parameters of the onboard camera. For example, if camera 910 onboard host vehicle 800 is capturing images at 30 frames per second (fps), the time difference between the first and second image frames would be approximately 33.3 milliseconds. Additionally or alternatively, in some embodiments, the time difference between the first and second image frames may be an adjustable parameter. Accordingly, the second image frame may correspond to an image frame acquired 2, 5, 10, or any other suitable number of frames after the first image frame. Furthermore, in some embodiments, the time difference between the first and second image frames may be selected based on the host vehicle's ego-motion. For example, in situations where the vehicle is moving at high speed, a shorter time difference may be selected to account for the significant changes caused by the host vehicle's motion. Conversely, if the vehicle is traveling at a slower speed, the impact of the ego-motion may be less pronounced, allowing for a larger time difference to be selected.

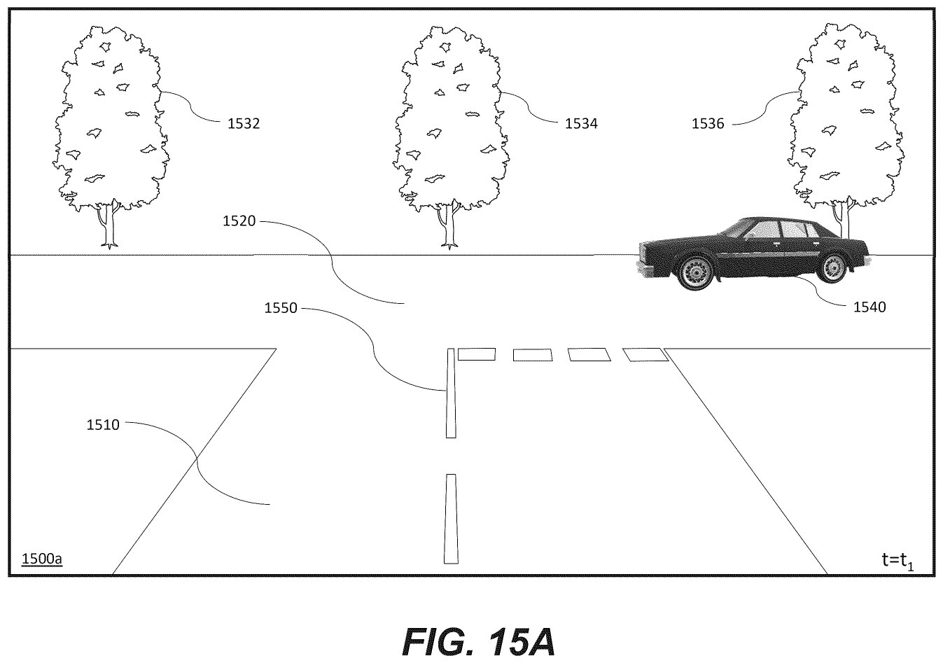

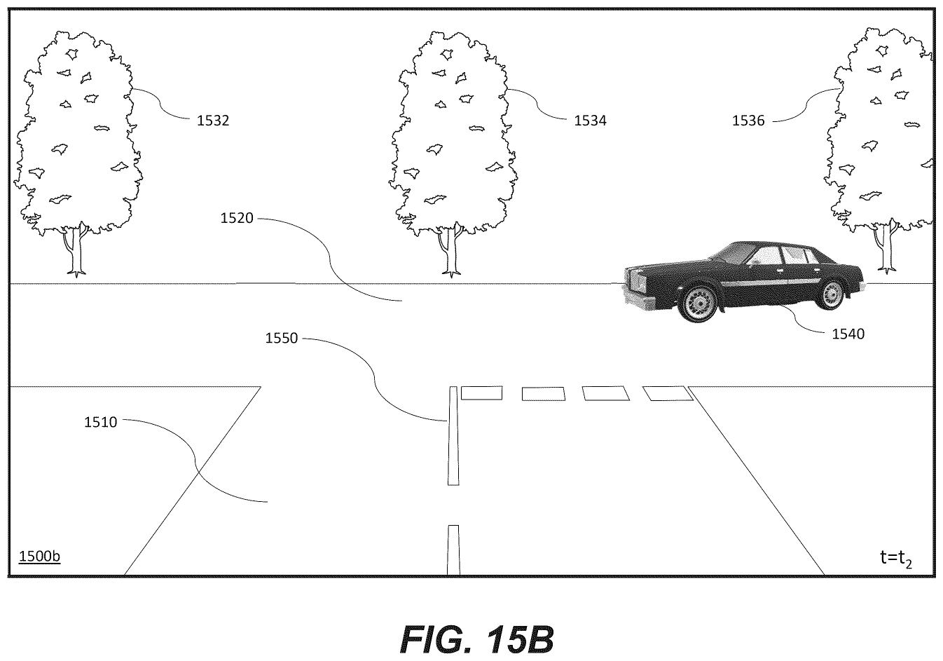

FIGS. 15A and 15B are exemplary illustrations representing a first image frame 1500a acquired at time t₁ and a second image frame 1500b acquired at time t₂, where t₂>t₁. Both frames are captured by camera 910 onboard host vehicle 800. Image frames 1500a and 1500b include representations of the environment surrounding host vehicle 800 as it travels along road segment 1510 towards an intersection 1520. These frames depict various objects within the environment, such as trees 1532, 1534, and 1536, a target vehicle 1540 approaching the intersection and about to turn at intersection 1520, and road markings 1550. Consistent with the disclosed embodiments, second image frame 1500b is captured at a later time (t₂) than first image frame 1500a (t₁). Consequently, due to the ego-motion of host vehicle 800 (moving towards intersection 1520), the scene depicted in second image frame 1500b differs from the depiction in first image frame 1500a. Trees 1532, 1534, and 1536, as well as target vehicle 1540 and road markings 1550, appear larger and closer in the second image frame 1500b compared to first image frame 1500a. In addition to these differences, the position of target vehicle 1540 in the second image frame 1500b has shifted slightly to the left as it begins to turn at the intersection, starting to face host vehicle 800. This change in the position of target vehicle 1540 is the result of a combination of its own relative motion with respect to host vehicle 800 and the ego-motion of host vehicle 800 itself. The relative motion of the target vehicle involves its approach to the intersection and initiation of a turn, which alters its position and orientation within the frame. Simultaneously, the ego-motion of host vehicle 800, as it travels towards the intersection, contributes to the shifting perspective in the captured image frames 1500a and 1500b.

In some cases, such as when vehicle 1540 is waiting to make a left turn and only slightly moving forward, it may be difficult to detect changes in the image position and orientation within the frames of target vehicle 1540 (especially in view of the image effects on the frames caused by the host vehicle ego motion). As a result, it may be difficult to determine whether target vehicle 1540 is moving or to determine motion characteristics of target vehicle 1540. The presently described system can forward warp the first captured image or reverse warp the second captured image to significantly reduce or remove the image effects between frames caused by the host vehicle ego motion. Using this technique, stationary objects will appear unchanged in a comparison of the warped image and an actual captured image frame (e.g., the first image if the second image is reverse warped, or the second image if the first image is forward warped based on the host vehicle ego motion). The image effects associated with moving objects (even slowly moving objects), however, will be more readily detectable between the warped frame and a captured image frame. Further, as described in more detail in the sections below, motion characteristics of detected objects represented in the image frames (e.g., target vehicle 1540) can be determined based on the comparison between the warped frame and a captured image frame.

At step 1406, processor 801 may, based on analysis of the second image frame, generate a point cloud of 3D points for the second image frame. The generated point cloud may include at least a range value for each of a plurality of pixels included in the second image frame. The range value for each of the plurality of pixels may be indicative of distance between the camera and one or more objects (or portions of objects) in an environment of the host vehicle. As used herein, a point cloud refers to a collection of data points defined in a three-dimensional coordinate system. Each point in the cloud may represent a specific location in space and may be defined by three coordinates: X, Y, and Z. For example, in some embodiments, each of the 3D points may include a Z coordinate defined by the predicted range value, and an X and Y coordinate associated with an image location in the second image frame of a particular one of the plurality of pixels. More specifically, the Z coordinate may represent the distance of a point or object in the scene from a reference plane, typically the camera's image plane, effectively providing the depth information. The X and Y coordinates may be derived (e.g., using perspective projection) from the position of the pixel in the 2D image frame (second image frame), indicating where the point is located horizontally and vertically in the image. By combining these coordinates, processor 801 may create a comprehensive 3D map of the environment, translating the 2D image frame into a spatial representation that includes depth, allowing for accurate distance measurements and spatial analysis. While the concept of a point cloud is mentioned here, it is to be appreciated that a point cloud is just one example of how 3D information may be represented. In some other embodiments, alternative 3D representations may also be employed, such as range maps (or depth maps), voxel grids and/or meshes. Each of these 3D representations possesses its strength and may be chosen based on the specific requirements of the application. For example, point clouds are efficient for capturing precise spatial locations of objects but may be data-intensive, range maps may provide depth information directly aligned with image pixels, but may be best suited for certain real-time applications etc. Therefore, the choice of 3D representation may depend on factors such as accuracy requirements or computational resources.

When relying on a single image captured by a single camera, models such as machine learning, deep learning, or neural networks, trained on extensive datasets, may predict 3D information (e.g., range value). These models may analyze the image and learn patterns to estimate the spatial characteristics of objects and surfaces depicted within it. By leveraging these trained models, accurate range, depth, and/or height information may be inferred from a single image, enabling efficient and effective scene understanding for autonomous navigation systems. For example, in some embodiments, generation of the point cloud of 3D points for the second image frame may be performed by at least one trained neural network. As described elsewhere in this disclosure, a trained neural network may refer to any set of interconnected input/output units (nodes), where each connection may be assigned a weight, each node may be assigned a specific activation function, and which is “trained” by processing each of a plurality of examples with known input and output in order to learn and improve its accuracy. An exemplary trained neural network architecture 1200 is depicted in FIG. 12. Such a trained neural network configured to determine 3D information and output for example a point cloud of 3D points could be integrated into the functionality of processor 801, stored within memory 802 of the system, or alternatively, it might be housed on a remote server accessible to processor 801 via communication port 804 for data exchange. This setup allows processor 801 to access the neural network model and perform 3D information determination tasks efficiently, either locally or remotely.

To train a neural network such as neural network 1200 for determining 3D information, a training dataset comprising images paired with corresponding ground truth range or height maps may be used. This dataset should encompass diverse scenes and environments, covering various lighting and weather conditions, alongside different object types. Each image in the dataset may be annotated with its accurate 3D information for every pixel, achieved through meticulous data annotation. To enhance the dataset's diversity and model robustness, data augmentation techniques like random transformations and noise addition can be applied. Additionally, in some cases, the training dataset may include range and/or height information provided by point clouds generated by a LIDAR system. Subsequently, the dataset may be split into training, validation, and test sets, with the training set utilized to train the neural network, the validation set for hyperparameter tuning and progress monitoring, and the test set for evaluating model performance. Preprocessing steps such as resizing, normalization, and any necessary data transformations may be applied to the images and corresponding 3D information. The neural network may be then trained using appropriate loss functions and optimization algorithms, aiming to minimize the disparity between its predictions and the ground truth values provided in the training data. Through this process, the neural network learns to infer range and/or height values for pixels in new images encountered during inference.

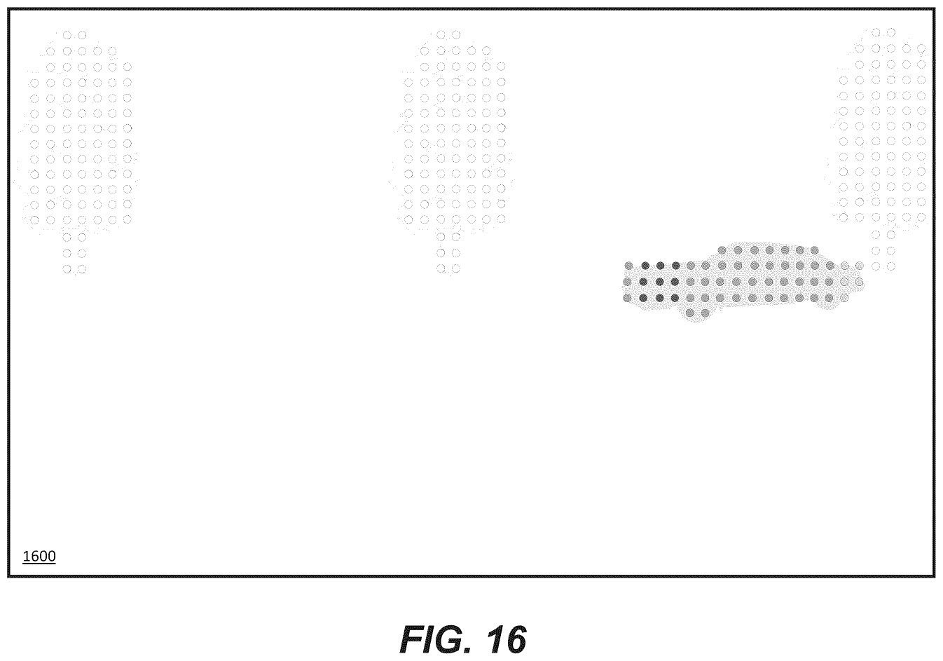

FIG. 16 represents an exemplary point cloud of 3D points 1600, generated from the second image frame 1500b. According to the disclosed embodiments, point cloud 1600, includes a range value associated with each of a plurality of pixels found in the second image frame 1500b. Specifically in this representation, these pixels correspond to various objects visible in the second image frame 1500b, such as trees 1532, 1534, and 1536, along with the target vehicle 1540. For clarity, other elements like road markings 1550 or road segment 1510 are omitted from FIG. 16, though a more comprehensive 3D presentation may encompass data for the entire scene depicted in second image frame 1500b. Additionally, the semi-transparent overlay of second image frame 1500b in the background of point cloud 1600 serves purely illustrative purposes, aiding in the understanding of the correlation between pixels from the second image frame and 3D points within point cloud 1600. The intensity or darkness of points within point cloud 1600 are indicative of the proximity of the objects or portions of objects they represent relative to the camera. In other words, darker points indicate objects or portions of objects closer to the camera, whereas lighter points denote objects or portions of objects farther away. This intensity gradient provides a visual representation of the spatial relationships and distances between the host vehicle's camera and the objects within its environment.

At step 1408, processor 801 may generate a test image frame based on the 3D points included in the generated point cloud and known ego-motion characteristics of the host vehicle from the first time to the second time. In this context, a test image frame refers to a synthetic image frame having one or more computer-generated alterations or differences as compared to an image acquired by a camera. In some cases, a synthetic image is one not acquired by a camera onboard the host vehicle but one that is created based at least in part from data included in image frames (e.g., first image frame and/or second image frame) acquired by a camera onboard the host vehicle. Synthetic images may include the forward-warped or reverse-warped images previously described. As described elsewhere in this disclosure, ego-motion refers to the self-motion of the host vehicle, including, for example, its translation (movement in space) and rotation (change in orientation) over time. In this context, known ego-motion characteristics refer to parameters describing how the host vehicle moves. For example, the known ego-motion characteristics may describe how the host vehicle moves from the first time instant (when the first image frame was captured) to the second time instant (when the second image frame was captured).

In some embodiments, the known ego-motion characteristics of the host vehicle may include at least one of a speed, velocity, heading direction, or acceleration of the host vehicle. As used herein, the speed may refer to the magnitude of the vehicle's velocity, indicating how fast the host vehicle is moving along its current path. The heading direction may denote the orientation or compass direction in which the host vehicle is traveling. It may provide information about the angle relative to a reference axis, such as north. Velocity may include both the speed and the direction of motion (heading direction). It may specify how quickly and in which direction the host vehicle is moving relative to a reference point. Acceleration describes the rate of change of velocity over time. It may indicate whether the vehicle is speeding up, slowing down, or changing direction. Additionally, in some embodiments, the known ego-motion characteristics may be determined based on output from one or more sensors. For example, in some embodiments, the one or more sensors may include at least one of a speedometer (capable of providing a measure of the host vehicle speed), an accelerometer (capable of detecting changes in speed and/or heading direction), a GPS unit (capable of providing global position and velocity information), or a wheel encoder (capable of tracking the rotation of each wheel, enabling the calculation of distance traveled based on the number of wheel rotations and the wheel circumference). By integrating data from these one or more sensors, processor 801 may accurately determine and/or continuously update the ego-motion characteristics of host vehicle 800. This data may be provided by the one or more sensors to processor 801 via any sort of communication channel (e.g., by using communication port 804).

By integrating the known ego-motion characteristics and the 3D points from the point cloud during the generation of the test image frame at step 1408, processor 801 may simulate how the environment around the host vehicle would appear (or appeared) from the perspective of the onboard camera at the time the first image frame was captured, accounting for continuous movement and changes in direction. For instance, processor 801 may extrapolate from a 3D point (e.g., with 3D coordinates X₂, Y₂, Z₂) included in the point cloud generated for the second image frame (e.g., originating from a pixel with 2D coordinates u2, v2) and associated with the second time instant, a corresponding 3D point (e.g., with 3D coordinates X₁, Y₁, Z₁) associated with the first image frame and the first time instant, using the known ego-motion characteristics. This process may involve retroactively adjusting for time (effectively going backward in time) using the ego-motion data and employing techniques (e.g., homography) to establish or project corresponding 3D points at the first time, given their positions at the second time. Through this approach, processor 801 may interpret the 3D points derived from the second image frame as representations of objects or parts of objects that remain stationary, with their previous positions relative to the first image frame influenced solely by the host vehicle's ego motion. Once this projected point cloud from an earlier time has been established, processor 801 may generate the test image frame by using data from the second image frame. For example, processor 801 may sample pixel data from the second image frame to populate the test image frame (which may start as an empty image/canvas) at pixel coordinates corresponding to the newly generated projected point cloud (e.g., the 3D point with 3D coordinates X₁, Y₁, Z₁ may be translated into a pixel with 2D coordinates u1, v1). For example, colors from pixels in the second image frame associated with corresponding pre-warped 3D points may subsequently be associated with the post-warped 3D points. Then, populating the test frame pixels may be accomplished using the pixel colors associated with the post-warped 3D points and determined pixel locations in the test image corresponding to the post-warped 3D points. It should be noted, however, that other techniques for populating the pixels of the test image, including sampling pixels from regions of the first image, etc., may also be employed. This approach may facilitate the creation of a simulated view that accurately reflects how the scene would have appeared initially at the first time instant, taking into account how objects would have appeared from the camera's perspective before any movement of the host vehicle occurred. This approach may also enable the decorrelation of the relative motion of objects from the ego motion of the host vehicle by depicting the positions of objects in the test image as they would have appeared in the first image frame, considering them as fixed. In some embodiments, the generation of the test image from the newly projected point cloud of 3D points, which may correspond to an operation inverse to step 1406, may be performed by at least one trained neural network (e.g., a trained neural network used to determine the point cloud of 3D point for the second image frame or a different trained neural network). This neural network is configured to determine pixel coordinates based on the 3D information included in the new 3D point cloud, such as range and/or depth values.

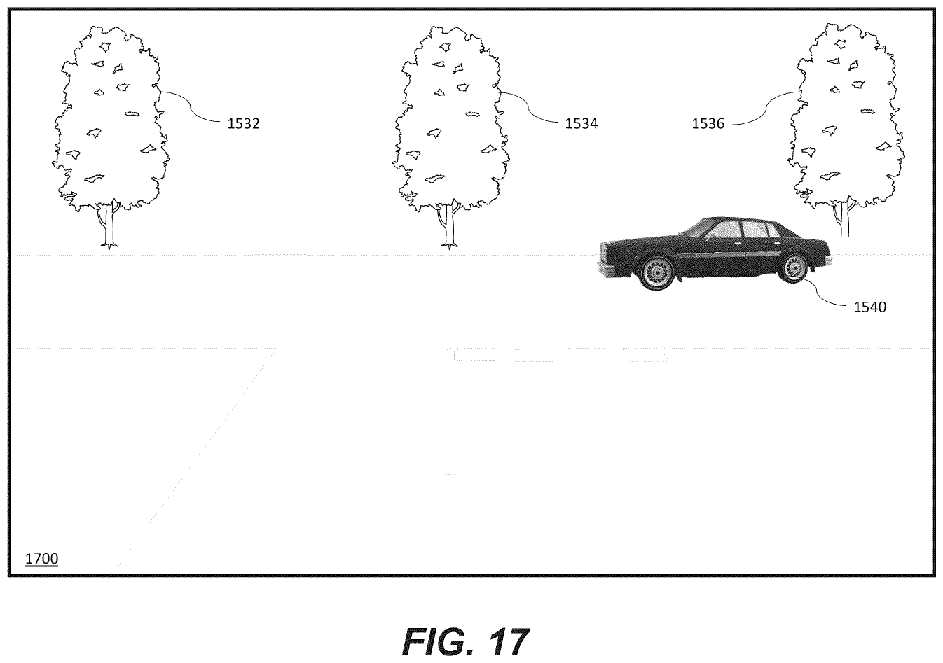

FIG. 17 illustrates a test image frame 1700 generated using the point cloud of 3D points 1600 and the known ego-motion characteristics of host vehicle 800 between times ti and t2. In this representation, test image frame 1700 includes representations of objects observed in first image frame 1500a, such as trees 1532, 1534, and 1536, and the target vehicle 1540. Notably, certain features from the first image frame 1500a, like road markings 1550 and road segment 1510, are absent from test image frame 1700. This omission occurs because corresponding 3D points for these features were not included in point cloud 1600, which is reflected in their increased transparency in test image 1700 for illustrative purposes only.

In some embodiments, not all 3D points from the point cloud may be translated into the test image due to orientation changes caused by the host vehicle's ego motion. This situation can arise when the host vehicle undergoes rapid changes in its heading direction relative to the time difference between the first and second image frames. As a result of these rapid changes, certain features will only appear in the second image frame due to the altered orientation. These particular features may have corresponding 3D points (e.g., determined after step 1406). However, when these 3D points are projected back to the initial time instant corresponding to the first image frame, they may correspond to pixel positions that are outside the first frame's coverage. This scenario occurs because the projection of 3D points back in time, considering the host vehicle's dynamic orientation changes, can lead to certain features or objects appearing in the point cloud but not being visible in the first image frame due to their spatial location relative to the camera's viewpoint. Consequently, these features will not be represented in the test image, thereby accounting for the absence of certain elements that were observable only after the host vehicle's orientation shifted between the capture times of the first and second image frames.

At step 1410, processor 801 may compare the test image frame to the first image frame. This process may involve evaluating the similarities and differences between the test image frame, which is generated based on the projected 3D point cloud and the known ego-motion characteristics, and the original first image frame captured at the first time instant. By comparing these two images, processor 801 may assess how accurately the test image frame replicates the real scene as it was seen by the onboard camera at the first time instant. This comparison can help identify any discrepancies, validate the correctness of the simulated environment reconstruction, or identify objects or portions of objects that may have moved independently of the host vehicle's ego-motion. Stationary objects should appear identical or nearly identical in the captured first image frame and the test image frame. Moving objects, however, should appear different in the first image frame and the test image frame. For example, in some embodiments, the comparison of the test image frame to the first image frame may include determining a difference in image position of a representation of the at least one object (or portion of an object) in the first image frame versus an image position of a representation of the at least one object (or portion of the object) in the test image frame. Such differences may indicate whether the object has moved due to its own motion rather than being affected solely by the host vehicle's motion. This detailed analysis helps in understanding the dynamic changes in the environment and improving the accuracy of the vehicle's perception system. Processor 801 may use various image processing techniques and algorithms to quantify these differences, such as calculating the pixel displacement or using methods like image registration and alignment. By doing so, processor 801 may ensure that the simulated view (test image frame) aligns as closely as possible with the real-world scenario captured initially.

Additionally or alternatively, in some embodiments, the comparison of the test image frame to the first image frame may be performed by a trained neural network configured to receive the test image frame and the first image frame as input. Such a neural network (which may be different from the trained neural network used for generating the point cloud of 3D points for the second image frame and/or generating the test image) may be trained on large datasets of image pairs, enabling it to learn how to effectively compare and contrast images to detect discrepancies, validate the reconstructed environment, and identify independent object movements. The neural network may use various deep learning techniques such as convolutional layers to extract features from both the test image frame and the first image frame. These features could include edges, textures, and patterns that represent different objects (or portions thereof) and their positions within the frames. By processing these features, the neural network may generate a detailed comparison, highlighting areas where the images differ. For instance, the neural network may output a difference map that visually represents the differences between the two frames, pinpointing changes in the positions of objects or portions of objects. This difference map could be further analyzed to determine if these changes are due to the host vehicle's motion or the independent motion of the objects.

Additionally, in some embodiments, the trained neural network may be configured to output an indicator of motion associated with the at least one object represented in the first image frame. As used herein, an “indicator of motion” refers to a quantitative or qualitative measure that describes the movement of an object (or portion thereof) over time. This indicator may include various parameters that provide information on the nature of the object's motion. For example, in some embodiments, the indicator of motion may correspond to at least one of a velocity, a speed, an acceleration, a displacement vector, a trajectory, or a rotational motion of the at least one object represented in the first image frame. Once the neural network has detected discrepancies between the test image frame and the first image frame, it may analyze the trajectory and displacement of the object's representations. By doing so, the trained neural network may calculate the velocity of the object, which includes both the speed at which the object is moving and the direction of its movement. This velocity information may be valuable for applications such as collision avoidance, path planning, and object tracking within the autonomous driving system. Moreover, the neural network might also provide additional motion-related metrics, such as acceleration or rotational movement. This metric may be useful in dynamic environments where objects not only move linearly but also change their orientation over time. By providing comprehensive motion indicators, the neural network may enhance the vehicle's ability to understand and react to its surroundings effectively. In some cases, the described technique may allow for detection and quantitative characterization of even very slowly moving vehicles, which can assist a vehicle navigation system in determining, for example, whether a parked vehicle is in the process of exiting a parking space, whether a target vehicle has initiated a turn or other type of maneuver, whether a target vehicle is entering an intersection or entering a section of road in a path of the host vehicle, etc.

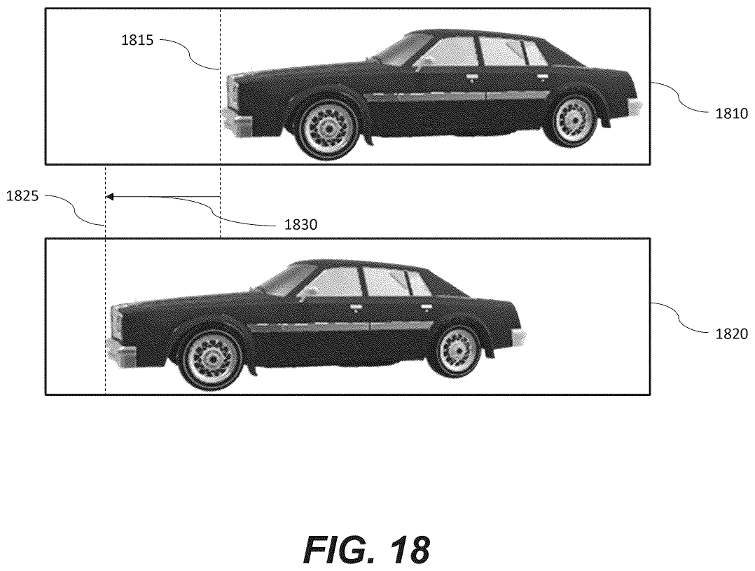

Referring to first image frame 1500a shown in FIG. 15A and test image frame 1700 provided in FIG. 17, processor 801 may determine a change in the position of target vehicle 1540 by comparing these two image frames. FIG. 18 provides a comparison of these two image frames by juxtaposing a portion 1810 of the first image frame 1500a, which includes and focuses on a representation of target vehicle 1540, and a portion 1820 of the test image frame 1700, which also includes and focuses on a representation of target vehicle 1540. As the target vehicle 1540 is turning at the intersection, its position has changed between the first time instant (t₁) and the second time instant (t₂). By projecting back the position of target vehicle 1540 using the known ego-motion characteristics of host vehicle 800 between t₁ and t₂, and utilizing point cloud 1600 (thus considering target vehicle 1540 as a stationary object during this process), the resulting position of target vehicle 1540 in test image frame 1700 differs from its position in first image frame 1500a. Specifically, the position of target vehicle 1540 in test image frame 1700 is slightly shifted to the left compared to its position in first image frame 1500a. This leftward shift in position indicates that target vehicle 1540 has moved between t₁ and t₂. The target vehicle 1540 is turning at intersection 1520, thus progressing to the left. The comparison highlights the motion of target vehicle 1540: its relative movement is evidenced as its representation in test image frame 1700, generated under the assumption of stationarity, does not align perfectly with its actual captured position in the first image frame 1500a. This analysis may provide information about the movement dynamics of target vehicle 1540, aiding in the understanding of its behavior and the potential impact on the host vehicle's navigation and decision-making processes. By performing these projections, processor 801 has effectively decorrelated the effect of target vehicle 1540 own motion from the effect of the host vehicle 800 ego motion on the change in position of target vehicle 1540 between first image frame 1500a and second image frame 1500b.

Additionally, as a result of this comparison, processor 801 may also determine or confirm which objects in first image frame 1500a were actually stationary. Static objects, when projected back and included in the test image frame, will have positions in the test image frame 1700 that align with their positions in the first image frame 1500a (or substantially align, allowing for minor artifacts or noise that may appear in the process). For example, if trees 1532, 1534, and 1536 are truly stationary, their projected 3D points, once mapped onto test image frame 1700, will cause the generation of representations that coincide with their representations in the first image frame. This alignment indicates that these objects have not moved relative to the host vehicle's motion and confirms their static nature. On the other hand, any discrepancies in the positions of these objects between the test image frame and the first image frame could suggest either minor errors in the projection process or external influences that have caused these objects to appear to move, such as environmental factors (e.g., wind) or inaccuracies in the ego-motion data. By identifying these stationary objects accurately, processor 801 may refine its understanding of the environment, providing a stable reference frame against which the motion of other, non-stationary objects may be identified and/or measured.

At step 1412, processor 801 may determine movement information associated with at least one object represented in the first image frame based on the comparison of the test image frame to the first image frame. In this context, movement information refers to data that describes the motion characteristics of an object over a period of time (e.g., between the first and the second time instants). For example, in some embodiments, the movement information may include at least one of a velocity, a speed, an acceleration, a displacement vector, a trajectory, or a rotational motion of the at least one object represented in the first image frame. In some embodiments, processor 801 may derive the movement information using the output (e.g., an indicator of motion) of a trained neural network performing the comparison of the first image frame to the test image frame. Alternatively, processor 801 may determine the movement information by identifying distinctive features of the object and tracking their positional changes between the two image frames. For example, as illustrated in FIG. 18, if the target vehicle 1540 is observed in different positions between the first image frame 1500a and the test image frame 1700, processor 801 can calculate its velocity by measuring the distance it has traveled over the time interval between ti and t2. This calculation may involve tracking the shift between position 1815 of the front of target vehicle 1540 in the first image frame portion 1810 and position 1825 of the front of target vehicle 1540 in the corresponding portion of the test image frame 1820. The outcome of this comparison may provide a velocity vector 1830, indicating both the speed and heading direction of the target vehicle 1540 between the first and second time instants. This velocity vector may serve as valuable movement information, facilitating accurate assessments of object dynamics, prediction of future positions, and informed decision-making for vehicle navigation and interaction with its environment.

At step 1514, processor 801 may generate a navigational action for the host vehicle based on the determined movement information. For example, processor 801 may determine the at least one navigational action by using a navigation module or system (e.g., navigational system 808). This process may involve leveraging the insights gleaned about the motion characteristics of objects in the environment, particularly how they evolve over time between the initial and subsequent time instants. In some embodiments, the navigational action may include at least one of slowing the host vehicle or changing a heading direction of the host vehicle. Additionally, processor 801 may be further programmed to cause at least one actuator associated with the host vehicle to implement the navigational action. For example, processor 801 may cause the activation of one or more actuators associated with a steering system (e.g., maintaining or changing a current heading direction), a braking system (e.g., reducing a current speed), or a drive system of vehicle 800 (e.g., accelerating, deaccelerating, reducing a current speed).

Using the calculated movement information, which includes parameters such as velocity, speed, acceleration, displacement vector, trajectory, or rotational motion of pertinent objects like the target vehicle 1540, processor 801 may formulate appropriate navigational directives. These navigational actions may be designed to optimize the host vehicle's response and interaction with its surroundings. For instance, referring to FIG. 18, if the determined velocity vector 1830 indicates that the target vehicle 1540 is moving at a specific speed and heading direction between the first and second time instants (e.g., target vehicle 1540 progressing to the left), processor 801 may generate navigational actions such as adjusting the host vehicle's speed, changing its trajectory, or planning for maneuvers that ensure safe navigation and efficient route adherence. This approach may enhance the vehicle's ability to anticipate and adapt to dynamic scenarios on the road, thereby enhancing overall safety and operational efficiency. In particular, by effectively separating the motion of objects from the host vehicle's own movement, processor 801 can improve the detection and identification of slow-moving objects, such as target vehicle 1540 decelerating (or accelerating from a stop) to make a turn at intersection 1520. As previously discussed, traditional methods like optical flow face challenges in accurately detecting slow-moving objects due to the host vehicle ego-motion which may be prevalent. In contrast, by integrating information from the point cloud and leveraging known ego-motion characteristics, processor 801 achieves a more robust understanding of object dynamics. This allows for precise differentiation between the host vehicle's movement and the movements of other objects in its vicinity. Moreover, by accurately identifying slow-moving objects and distinguishing their motion from background movement, processor 801 contributes to smoother and more efficient navigation strategies. This includes preemptive adjustments in speed, trajectory planning, and collision avoidance measures, thereby ensuring seamless and secure operations of autonomous or assisted driving systems. Ultimately, the ability to decorrelate object motion from ego motion not only improves object detection capabilities but also enhances the vehicle's overall responsiveness and adaptability to varying road conditions.

While the preceding description demonstrates processor 801 capability to decorrelate the host vehicle's ego-motion from objects'relative motion using a projection backward in time, it is to be appreciated that in certain scenarios, processor 801 can achieve the same outcome by employing a projection forward in time. Referring to FIG. 14, after receiving a first image frame acquired at a first time by a camera onboard the host vehicle (step 1402) and a second image frame acquired at a second time by the camera onboard the host vehicle, the second time being later than the first time (step 1404), processor 801 may, in place of step 1406, be configured to analyze the first image frame and generate a point cloud of 3D points associated with the first image frame. This generated point cloud may include a range value for each of the plurality of pixels within the first image frame, indicating the distance between the camera and objects in the host vehicle's environment.

Processor 801 may then (e.g., in place of step 1408) proceed to generate a test image frame based on these 3D points from the point cloud and the known ego-motion characteristics of the host vehicle from the first time to the second time. This simulation may replicate how the environment surrounding the host vehicle would appear from the onboard camera's perspective at the time the second image frame was captured, accounting for continuous movement and changes in direction. For instance, processor 801 may extrapolate a 3D point (e.g., with coordinates X₁, Y₁, Z₁) from the point cloud generated for the first image frame (originating from a pixel with coordinates u₁, v₁) associated with the first time instant, to a corresponding 3D point (e.g., with coordinates X₂, Y₂, Z₂) associated with the second image frame and the second time instant, using the known ego-motion characteristics. This process may involve projecting forward in time, adjusting using ego-motion data, and employing techniques such as homography to establish or project corresponding 3D points at the second time, based on their positions at the first time. Through this method, processor 801 may interpret the 3D points derived from the first image frame as representations of stationary objects or parts of objects, anticipating their future positions relative to the second image frame influenced solely by the host vehicle's ego motion. Once this projected point cloud from a future time has been established, processor 801 may generate the test image frame using data from the first image frame. For instance, processor 801 may sample pixel data from the first image frame to populate the test image frame, starting as an empty canvas, at pixel coordinates corresponding to the newly projected point cloud (e.g., translating the 3D point with coordinates X₂, Y₂, Z₂ into pixel coordinates u₂, v₂). This approach may facilitate the creation of a simulated view that accurately reflects how the scene will appear at the second time instant, considering how objects will appear from the camera's perspective after the host vehicle has moved. Moreover, this approach may equally enable the decorrelation of objects'relative motion from the ego motion of the host vehicle by depicting object positions in the test image as they would have appeared in the second image frame, considering them as fixed.

Following the generation of the test image frame, processor 801 may (e.g., in place of step 1410) proceed with comparing it to the second image frame, assessing similarities and differences. For example, in some embodiments, the comparison of the test image frame to the second image frame may include determining a difference in image position of a representation of the at least one object (or portion of an object) in the second image frame versus an image position of a representation of the at least one object (or portion of the object) in the test image frame. Such differences may indicate whether the object has moved due to its own motion rather than being affected solely by the host vehicle's motion. This detailed analysis may help in understanding the dynamic changes in the environment and improving the accuracy of the vehicle's perception system. Processor 801 may use various image processing techniques and algorithms to quantify these differences, such as calculating the pixel displacement or using methods like image registration and alignment. By doing so, processor 801 may ensure that the simulated view (test image frame) aligns as closely as possible with the real-world scenario captured at the second time instant. Additionally or alternatively, in some embodiments, the comparison of the test image frame to the second image frame may be performed by a trained neural network configured to receive the test image frame and the second image frame as input. As mentioned earlier, the trained neural network may be configured to output an indicator of motion associated with the at least one object represented in the second image frame.

Subsequently, based on the comparison of the test image frame to the second image frame, processor 801 may (e.g., in place of step 1412) determine movement information associated with at least one object represented in the second image frame. This movement information may encompass various parameters such as velocity, speed, acceleration, displacement vector, trajectory, or rotational motion of the object, derived from the comparison of the test image frame to the second image frame. Based on this determined movement information processor 801 may generate a navigation action (a process similar to step 1414 of process 1400 shown in FIG. 14).

In brief, processor 801 may use forward and backward projection in time to achieve similar outcomes in simulating and analyzing the scene as captured by the onboard camera at different time instants. In some embodiments, similar techniques may be employed for the forward and backward projections (e.g., use of one or more trained neural networks).

### 3D Bounding Boxes from Images

In the realm of autonomous vehicle (AV) navigation systems, the accurate identification and localization of objects within captured images may be required for safe and efficient operation. Traditional approaches, including bounding boxes generated through image analysis techniques or via certain trained neural networks (NNs), have proven effective in identifying object representations in 2D space. However, these methods lack 3D information, which significantly restricts their utility in comprehensive scene understanding and navigation tasks. The absence of 3D information (e.g., depth, range, height, etc.) associated with generated bounding boxes can limit the autonomous vehicle's ability to perceive spatial relationships, distances, and occlusion scenarios accurately, valuable information for making informed decisions in dynamic environments. Accordingly, there is a need for determining and incorporating 3D information into object identification frameworks (e.g., 3D bounding boxes) for enhancing navigation precision, system capabilities, safety, and overall operational efficiency. The disclosed embodiments address these challenges.

In the disclosed embodiments, a host vehicle (e.g., an autonomous or semi-autonomous vehicle) may include one or more systems configured to determine 3D information associated with at least one object included in images captured by a camera. Furthermore, the disclosed one or more systems may determine a bounding box associated with the at least one object and a plurality of three-dimensional locators indicative of a location in real-world coordinates of the determined bounding box. Alternatively, or additionally, the disclosed one or more systems may analyze data output by any one or more sensors associated with the host vehicle (e.g., one or more cameras, LIDARs, and radars, etc.).

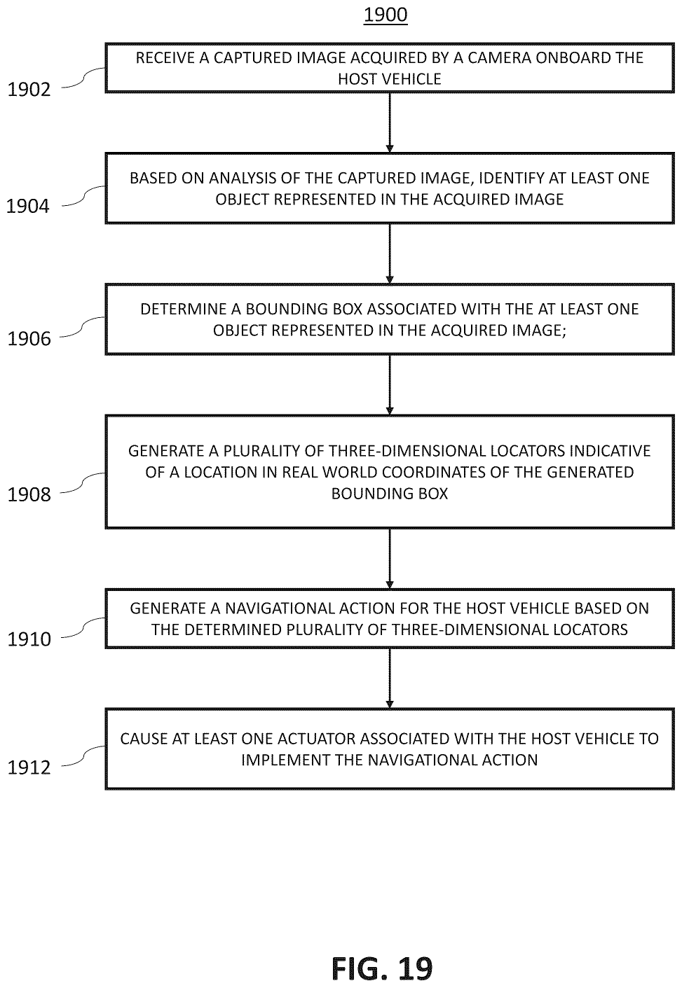

FIG. 19 is a flowchart showing an exemplary process 1490 for navigating a host vehicle relative to a road segment, consistent with the disclosed embodiments. More specifically, process 1900 may enable the determination of a bounding box associated with at least one object in the environment of the host vehicle (and represented in one at least one captured image). Process 1900 also enables determination of a plurality of three-dimensional locators indicative of a location in real-world coordinates of the determined bounding box. Thus, the generated bounding box may be described both by 2D image coordinates (e.g., X and Y coordinates of points associated with an image representation of the bounding box, which in some cases may be overlaid on a captured image) and by 3D real world coordinates (e.g., X, Y, and Z coordinates of points on a real-world projection of the bounding box). In accordance with the disclosed embodiments, such a process may be executed by at least one processor or processing unit, such as processor 801 included in vehicle 800 or processing unit 110 of system 100 (implemented in host vehicle 200). The host vehicle (e.g., host vehicle 800) may include one or more cameras 806 (e.g., cameras 910, 920, and 930). While process 1900 is described below using vehicle 800 as an example, one skilled in the art would understand that a server (e.g., one or more servers described in this disclosure) may also be configured to perform one or more steps of process 1900. For example, vehicle 800 may transmit at least one image captured by one or more cameras 806 to a server via a network. The server may then be configured to generate a bounding box associated with at least one object and to determine a plurality of three-dimensional locators indicative of a location in real-world coordinates of the determined bounding box. The server may also be configured to transmit such plurality of three-dimensional locators to vehicle 800 for further processing. Consistent with other disclosed embodiments, a non-transitory computer-readable storage media may store program instructions, which are executed by at least one processing device to perform process 1500.

At step 1902, processor 801 may receive a captured image acquired by a camera onboard the host vehicle. Consistent with the disclosed embodiment, the captured image may include a representation of at least a portion of the environment of the host vehicle. For example, processor 801 may receive an image captured by camera 910 from the environment of host vehicle 800. In some embodiments, the camera may include a plurality of cameras configured to capture a plurality of images of the environment of the host vehicle. For example, referring to FIG. 9, processor 801 may receive a first plurality of images captured by center camera 910, a second plurality of images captured by left surround camera 920, and a third plurality of images captured by right surround camera 930 from the environment of host vehicle 800. As described elsewhere in this disclosure, in some embodiments, the Field OF View (FOV) of center camera 910 may at least partially overlap with both the FOV of left surround camera 920 and the FOV of right surround camera 930.

At step 1904, processor 801 may, based on analysis of the captured image, identify at least one object represented in the acquired image. This process may involve applying advanced image analysis techniques, potentially including machine learning algorithms and neural networks, to parse the captured image data and detect objects (or portions thereof). Processor 801 may use various methods such as edge detection, pattern recognition, and segmentation to differentiate objects from the background and each other. The analysis might involve extracting features such as shape, size, color, and texture to accurately identify and categorize objects. In some embodiments, the at least one object (or portion thereof) may include at least one of a vehicle, a vulnerable road user (e.g., pedestrian), a traffic sign, a traffic light, a traffic cone, a barrier, a road edge, a foreign object debris, a building, a billboard, a utility pole, vegetation, etc.

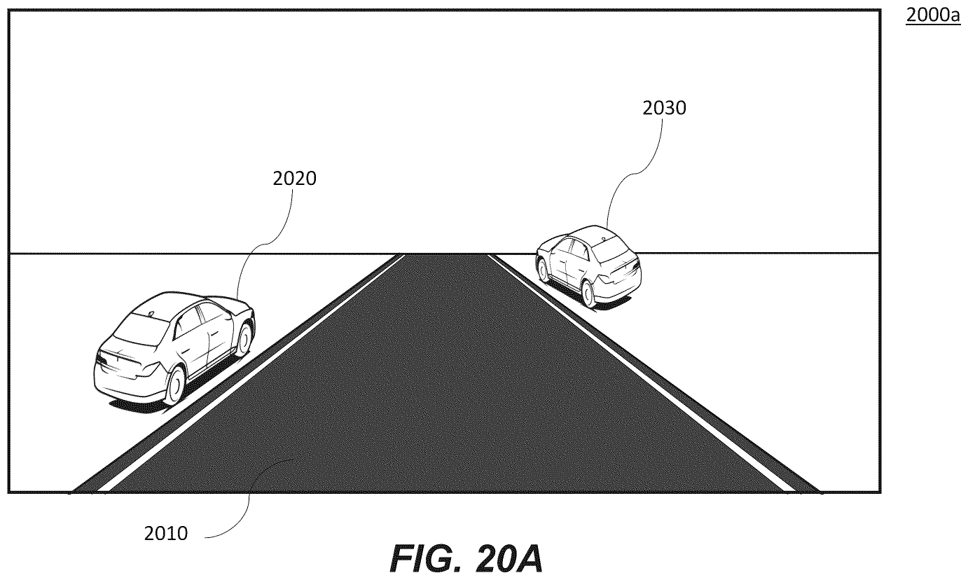

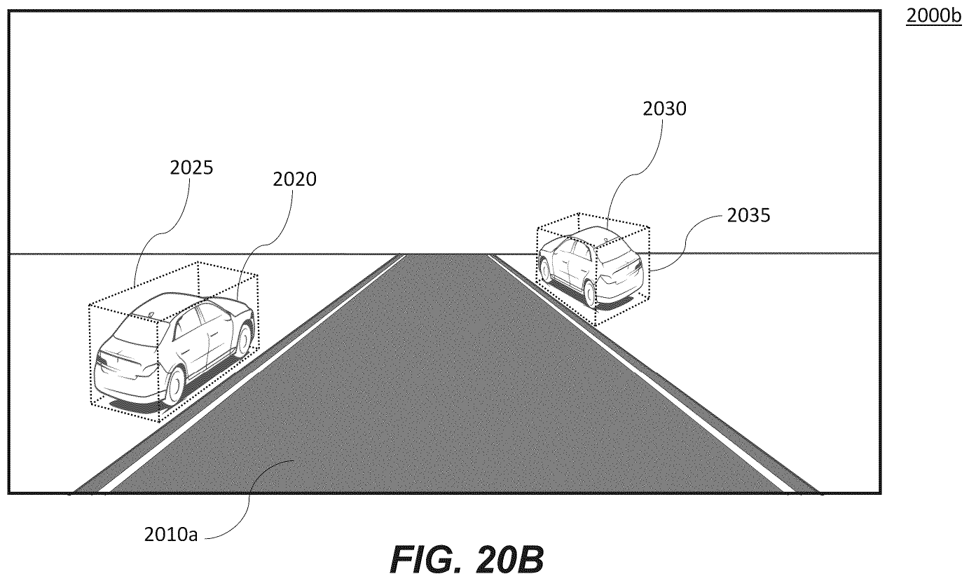

FIG. 20A is an illustration of an exemplary image 2000a captured by a camera (e.g., camera 910) onboard host vehicle 800. Image 2000a depicts a scene occurring as host vehicle 800 travels on road segment 2010, showcasing at least a portion of the environment surrounding host vehicle 800 during its journey. In addition to road segment 2010 and its associated features, such as road markings, image 2000a includes two distinct objects: vehicle 2020 and vehicle 2030, parked on the left and right sides of road segment 2010, respectively. Consistent with the disclosed embodiments, processor 801, upon receiving image 2000a, may analyze the captured image to identify image representations of vehicle 2020 and vehicle 2030 within the captured image 2000a.

At step 1906, processor 801 may determine a bounding box associated with the at least one object represented in the captured image. Within the context of this disclosure, a bounding box refers to any border used to identify the position and spatial extent of an object within an image. This bounding box may serve to encapsulate the object, making it easier for the system and processor 801 to analyze and track the object within the image. By determining the bounding box for the identified object(s), processor 801 may delineate the precise area within the captured image that each object occupies, facilitating further processing tasks such as object tracking, classification, and distance estimation.

In some embodiments, the bounding box may consist of a parallelepiped, a cube, a regular polyhedron, or any other polyhedron. These geometric shapes can be used to represent the spatial extent of objects in three-dimensional space, enhancing the precision of object detection and tracking. A parallelepiped refers to a three-dimensional geometric figure with six faces (parallelograms), used to encapsulate objects with varied lengths, widths, and heights. A cube represents a special type of parallelepiped with all sides equal. More complex bounding shapes may include regular polygons, such as tetrahedrons, octahedrons, and dodecahedrons. These shapes can be used to enclose objects with more complex geometries, offering a higher level of detail and accuracy. Alternatively, any other polyhedron may be used depending on the specifics of the object detection and representation tasks. These shapes may accommodate various object geometries, providing flexibility in how objects may be bounded within the image or 3D space. By utilizing these different types of polyhedral bounding boxes, processor 801 may achieve a more precise and contextually appropriate representation of objects within the captured image, facilitating advanced analyses and operations such as collision avoidance, navigation, and scene understanding in autonomous vehicle systems. For example, processor 801 may use a parallelepiped as a bounding box for a building on the side of a road segment, providing a straightforward and efficient way to encapsulate the building's volume. In contrast, processor 801 might use a more complex irregular polyhedron for a lamp post or a road sign, as these objects often have more intricate shapes that do not conform to simple geometric forms. In some embodiments, the bounding box may consist of a sphere or an ellipsoid. These shapes are advantageous in scenarios where the object being delineated possesses a spherical or elliptical form, thereby offering a more accurate representation of its spatial extent compared to polyhedrons. This approach may enable a better encapsulation of object dimensions and spatial orientation, facilitating a more precise spatial analysis.

FIG. 20B is an illustration of an exemplary image 2000b corresponding to captured image 2000a (with increased transparency), on top of which bounding boxes 2025 and 2035 (black dashed lines) have been drawn for vehicles 2020 and 2030, respectively. These bounding boxes are determined based on the identification of vehicles 2020 and 2030 in captured image 2000a. As shown, bounding boxes 2025 and 2035 are parallelepipeds, providing a simplified and efficient way to encapsulate the volume of the vehicles. However, as mentioned earlier, more complex polyhedrons may be used for vehicles 2020 and 2030, such as polyhedrons that follow the different surfaces of vehicles 2020 or 2030 as represented in captured image 2000a. This approach may offer a more accurate representation of the vehicles'shapes and volumes, enhancing the precision of object detection and spatial awareness in the autonomous vehicle's navigation system.

Image 2000b is provided here for illustrative purposes; however, it is to be appreciated that processor 801 need not output such a representation in the form of an image.

Instead, processor 801 may determine the bounding box associated with the at least one object and generate and/or output a data structure (e.g., an array, a table, a list, etc.) that includes information related to the determined bounding box. In some embodiments, such a data structure may include one or more pixel or image (2D) coordinates associated with the captured image and/or one or more features of the determined bounding box. For example, the data structure might contain the coordinates of the corners of the bounding box in the 2D plane of the captured image, providing the location and extent of the object within the image. Referring to FIG. 20B, processor 801 may determine 2D pixel or image coordinates for one or more corners of bounding boxes 2025 and 2035. In some other scenarios, the data structure may include the coordinates associated with a center of a face of the bounding box (e.g., left or right lateral face, front face, back face, etc.). Additionally or alternatively, the data structure may include the dimensions (height, width, depth) of the bounding box, describing its size and shape in the 2D image plane. Furthermore, the data structure may also store attributes such as the type of polyhedron used for the bounding box, the object's classification (e.g., vehicle, pedestrian, sign), and confidence levels for the detection and bounding box accuracy. By generating this detailed data structure, processor 801 may provide a comprehensive set of information that can be utilized for various tasks, such as path planning, collision avoidance, and situational awareness, without the need to visualize the bounding boxes as images. This method may ensure that the bounding box data is efficiently integrated into the vehicle's operational processes, enhancing overall performance and safety.

At step 1908, processor 801 may generate a plurality of three-dimensional locators indicative of a location in real-world coordinates of the determined bounding box. As used herein, a three-dimensional locator refers to a set of coordinates or markers that specify the position of a point or object in a three-dimensional space, providing a precise real-world location relative to a reference point, such as the vehicle's current position or a global coordinate system. These locators effectively translate the 2D information from the captured image into 3D spatial data, making it possible to understand the object's placement, orientation, and dimensions in the physical environment of the host vehicle. Accordingly, this process of a three-dimensional locator generator may involve converting any of the 2D information related to the determined bounding box into corresponding 3D information. To achieve this, processor 801 may apply any of the techniques described elsewhere in this disclosure (e.g., techniques used in connection with steps 1104 and 1106 of process 1100, and/or step 1406 of process 1400). For example, in some embodiments, processor 801 may use depth data obtained from sensors such as LIDAR systems or stereo cameras, combined with the intrinsic and extrinsic parameters of the camera. The intrinsic parameters include the camera's focal length and optical center, while the extrinsic parameters describe the camera's position and orientation relative to the vehicle. By applying these parameters, processor 801 may transform 2D coordinates, e.g., (u, v) associated with the bounding box in the image into 3D coordinates (X, Y, Z) in the real world.

Alternatively, when relying on a single image captured by a single camera, and therefore on a single set of 2D coordinates (2D information from a single source), models such as machine learning, deep learning, or neural networks can be employed to predict 3D information (e.g., range, depth, or height values). These models, trained on extensive datasets, can analyze the image to learn patterns that estimate the spatial characteristics of objects and surfaces depicted within it, particularly for determining bounding boxes. By leveraging these trained models, accurate range, depth, and/or height information associated with a bounding box can be inferred from a single image (e.g., using the pseudo LIDAR technique described above). For example, in some embodiments, a trained neural network may be configured to receive (e.g., from processor 801 or directly from the onboard camera) the captured image as input and provide as output the plurality of three-dimensional locators indicative of the location in real-world coordinates of the determined bounding box. As described elsewhere in this disclosure, a trained neural network may refer to any set of interconnected input/output units (nodes), where each connection may be assigned a weight, each node may be assigned a specific activation function, and which is “trained” by processing each of a plurality of examples with known input and output in order to learn and improve its accuracy. An exemplary trained neural network architecture 1200 is depicted in FIG. 12. Such a trained neural network configured to determine 3D information and output a plurality of three-dimensional locators indicative of the location in real-world coordinates of a determined bounding box could be integrated into the functionality of processor 801, stored within memory 802 of the system, or alternatively, it might be housed on a remote server accessible to processor 801 via communication port 804 for data exchange. This setup allows processor 801 to access the neural network model and perform 3D information determination tasks efficiently, either locally or remotely.

To train a neural network such as neural network 1200 for determining 3D information and output a plurality of three-dimensional locators indicative of the location in real-world coordinates of a determined bounding box, a training dataset comprising images paired with corresponding ground truth range, depth or height maps may be used. This dataset should encompass diverse scenes and environments, covering various lighting and weather conditions, alongside different object types. Each image in the dataset may be annotated with its accurate 3D information for every pixel, achieved through meticulous data annotation. To enhance the dataset's diversity and model robustness, data augmentation techniques like random transformations and noise addition can be applied. Additionally, in some cases, the training dataset may include 3D information provided by point clouds generated by a LIDAR system. Subsequently, the dataset may be split into training, validation, and test sets, with the training set utilized to train the neural network, the validation set for hyperparameter tuning and progress monitoring, and the test set for evaluating model performance. Preprocessing steps such as resizing, normalization, and any necessary data transformations may be applied to the images and corresponding 3D information. The neural network may be then trained using appropriate loss functions and optimization algorithms, aiming to minimize the disparity between its predictions and the ground truth values provided in the training data. Through this process, the neural network learns to infer a plurality of three-dimensional locators associated with determined bounding boxes for new images encountered during inference.

Additionally, in some embodiments, the trained neural network may be further configured to identify the at least one object represented in the acquired image. This identification task may involve the neural network analyzing the features and patterns within the captured image to recognize and classify objects of interest, such as vehicles, pedestrians, road signs, or buildings. By leveraging its learned representations and classification abilities, the neural network may accurately label and distinguish different objects within the scene. Moreover, in some embodiments, the trained neural network may be further configured to determine the bounding box associated with the at least one object represented in the captured image. This process involves the neural network predicting the coordinates or parameters that define the bounding box relative to the image frame, taking into account the object's size, position, and orientation within the scene.

Such a trained neural network, which may be integrated into the functionality of processor 801, may offer a holistic approach capable of identifying objects in the captured image, determining bounding boxes for these objects, and generating three-dimensional locators that indicate the objects'real-world coordinates. Alternatively, these different tasks (i.e., tasks included within steps 1904, 1906, and 1908 of process 1900) may be assigned and performed by distinct trained neural networks. For example, in some embodiments, a first trained neural network may be configured to receive (e.g., from processor 801 or directly from the onboard camera) the captured image as input and provide as an output the determined bounding box associated with the at least one object represented in the captured image. Additionally, in some embodiments, a second trained neural network may be configured to receive the captured image and the determined bounding box as input (e.g., from the first trained neural network or via processor 801) and provide as output the plurality of three-dimensional locators indicative of the location in real-world coordinates of the determined bounding box. Consistent with the disclosed embodiments, the determined bounding box (when outputted by the first trained neural network and received by the second trained neural network as input) may be represented by image coordinates associated with the captured image. Employing separate trained neural networks (e.g., first and second trained neural networks) for distinct tasks such as object detection, bounding box determination, and three-dimensional localization may offer various advantages. For example, each neural network can specialize in a specific task, optimizing its architecture and training (through a specific dataset tailored to their specific tasks) for that particular function. This specialization may lead to improved accuracy and efficiency in performing each task independently. Separating tasks into different neural networks may also enhance modularity within the system architecture. This modularity may allow for easier maintenance, debugging, and upgrading of individual components without affecting the entire system. It may also facilitate scalability, as each network can be independently optimized and deployed based on computational resources and performance requirements. Moreover, by assigning dedicated networks to each task, interference between tasks may be minimized. This separation may reduce computational overhead and potential conflicts that may arise when multiple tasks are handled by a single network, especially in complex scenarios such as real-time processing of large-scale image data.

In some embodiments, the plurality of three-dimensional locators may include three-dimensional coordinates for at least one point associated with the bounding box along with a plurality of dimension values associated with the bounding box. In other words, the three-dimensional locators may pinpoint particular points of the bounding box. For example, in some embodiments, the at least one point may correspond to a center of the bounding box, a corner of the bounding box, and/or a center of a face of the bounding box. Referring to FIG. 20B processor 801 may determine a plurality of three-dimensional locators that include one or more points associated with the corners, centers of faces, or the overall center of bounding boxes 2025 or 2035. Additionally, in some embodiments, the plurality of dimension values may include a length, height, and width of the bounding box. These dimension values correspond to dimensions in the 3D physical space. For instance, with FIG. 20B as a reference, processor 801 may calculate the physical length, height, and width for both bounding boxes 2025 and 2035.

In some other embodiments, the plurality of three-dimensional locators may include polar coordinates for at least one point associated with the bounding box. Polar coordinates (e.g., cylindrical coordinates or spherical coordinates) may consist of at least two values: the radial distance from a reference point (typically the origin) and the angle from a reference direction (often the positive x-axis). In the context of cylindrical coordinates, a third dimension (typically denoted as z and identical to cartesian coordinates) can be included, representing the vertical position along with the radial distance and angular direction. On the other hand, spherical coordinates may involve an additional angular dimension, measuring the angle from another specified reference direction. Polar coordinates may provide an alternative way to specify the position of a point in three-dimensional space, especially useful for describing spherical or cylindrical shapes where radial distance and angular direction are more intuitive metrics than Cartesian coordinates (x, y, z).

Once the plurality of three-dimensional locators has been determined, processor 801 may proceed to construct a data structure that consolidates both the existing 2D information and the newly generated 3D information. This data structure may serve as a comprehensive repository capturing the spatial characteristics of objects identified within the captured image. In more detail, the process may involve integrating the 3D information derived from the plurality of three-dimensional locators with the existing 2D information, which may include pixel or image coordinates along with other relevant features of the determined bounding boxes. By combining these datasets, processor 801 may create a unified representation that enhances the understanding of the detected objects in both their visual context and their physical dimensions within the real-world environment of the host vehicle. This integrated data structure may be used in subsequent stages of autonomous navigation and perception systems, providing input for decision-making algorithms and spatial reasoning tasks. This consolidated data structure may enable the system to not only identify objects and delineate their boundaries accurately but also to spatially localize them relative to the host vehicle and other elements in the environment.

At step 1910, processor 801 may generate a navigational action for the host vehicle based on the determined plurality of three-dimensional locators. This step may involve processor 801 to translate detailed spatial information into actionable decisions to guide the host vehicle through its environment safely and efficiently. Leveraging the 3D information gleaned from the plurality of locators, which may include precise spatial coordinates of significant features associated with scene objects-such as their real-world positions, dimensions, and potentially their orientation or directional vectors-processor 801 may derive navigational insights. For example, in some embodiments, the navigational action may include at least one of slowing the host vehicle or changing a heading direction of the host vehicle. Alternatively, in some other embodiments, the navigational action may include maintaining at least a predetermined closest approach distance between the host vehicle and a three-dimensional representation of the bounding box in real-world coordinates. This approach may ensure safe proximity management, particularly when navigating around obstacles or other vehicles. For example, referencing FIG. 20B, processor 801 might opt to uphold a minimum predefined distance (such as a meter or less) between host vehicle 800 and the three-dimensional representations of bounding boxes 2025 and 2035 in real-world coordinates. This proactive approach enables processor 801 to mitigate the risk of collision while navigating road segment 2010, where vehicles 2020 and 2030 are parked. By maintaining safe separation distances, processor 801 may ensure the safety of host vehicle 800 and other objects in its vicinity, supporting smooth and secure travel through potentially congested or challenging environments. By continuously assessing and adapting to the spatial dynamics revealed by the bounding box's three-dimensional representation, processor 801 may facilitate precise and proactive navigation strategies. These actions may not only enhance safety but also optimize efficiency, enabling the host vehicle to navigate with confidence in diverse and challenging environments.

In some embodiments, the navigational action generated by processor 801 may be tailored to optimize the host vehicle's trajectory and decision-making process. This may involve calculating optimal paths, adjusting vehicle speed or direction based on upcoming obstacles or road conditions, and ensuring compliance with traffic rules and safety protocols. The integration of 3D spatial data may enhance the precision and reliability of these navigational decisions, enabling the vehicle to navigate complex scenarios with confidence and adaptability.

At step 1912, processor 801 may cause at least one actuator associated with the host vehicle to implement the navigational action. For example, processor 801 may cause the activation of one or more actuators associated with a steering system (e.g., maintaining or changing a current heading direction), a braking system (e.g., reducing a current speed), or a drive system of vehicle 800 (e.g., accelerating, deaccelerating, reducing a current speed).

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of. Net Framework,. Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A system for navigating a host vehicle relative to a road segment, the system comprising:
at least one processor comprising circuitry and a memory, wherein the memory includes instructions that when executed by the circuitry cause the at least one processor to:
receive a captured image acquired by a camera onboard the host vehicle;
based on analysis of the image, generate image height information including a predicted height value for each of a first plurality of pixels included in the captured image, the predicted height value for each of the first plurality of pixels being indicative of height above a ground surface;
based on analysis of the image, generate image range information, including a predicted range value for each of a second plurality of pixels included in the captured image, the predicted range value for each of the second plurality of pixels being indicative of distance relative to the camera; and
determine a navigational action for the host vehicle based on at least one of the image height information or the image range information.

2. The system of claim 1, wherein the memory further includes instructions that when executed cause the at least one processor to cause at least one actuator associated with the host vehicle to implement the navigational action.

3. The system of claim 1, wherein a trained neural network is configured to generate both the image height information for each of the first plurality of pixels and the image range information for each of the second plurality of pixels based on receiving the captured image as input.

4. The system of claim 3, wherein generation of the range information is based, at least in part, upon previously generated height information.

5. The system of claim 1, wherein a first trained neural network is configured to generate the image height information based on receiving the captured image as input, and wherein a second trained neural network is configured to generate the image range information based on receiving the captured image as input.

6. The system of claim 5, wherein generation of the range information by the second trained neural network is based, at least in part, upon the height information generated by the first trained neural network.

7. The system of claim 1, wherein the memory includes instructions that when executed by the circuitry cause the at least one processor to identify an object in an environment of the host vehicle based, at least in part, on the height information.

8. The system of claim 7, wherein the object includes at least one projecting portion suspended above the ground surface.

9. The system of claim 8, wherein the at least one projecting portion is associated with a boom gate.

10. The system of claim 8, wherein the at least one projecting portion is associated with a road sign.

11. The system of claim 8, wherein the at least one projecting portion is associated with a parked vehicle.

12. The system of claim 7, wherein the object includes at least one suspended portion extending above the ground surface.

13. The system of claim 12, wherein the at least one suspended portion is associated with a bridge structure.

14. The system of claim 12, wherein the at least one suspended portion is associated with a road access control structure.

15. The system of claim 14, wherein the road access control structure includes a cable or a chain.

16. The system of claim 14, wherein the road access control structure includes a suspended gate.

17. The system of claim 1, wherein the ground surface corresponds to a road surface associated with the road segment.

18. The system of claim 1, wherein the determined navigational action includes an evasive maneuver if the height information indicates that an object in an environment of the host vehicle has a height above a predetermined threshold.

19. The system of claim 18, wherein the predetermined threshold is less than a ground clearance of the host vehicle.

20. The system of claim 1, wherein the memory includes instructions that when executed by the circuitry cause the at least one processor to determine, based on the height information, a height associated with a closest approach point associated with an object in an environment of the host vehicle.

21. The system of claim 20, wherein the closest approach point is associated with an open door of a parked vehicle.

22. The system of claim 20, wherein the closest approach point is associated with a side of a parked vehicle.

23. The system of claim 20, wherein the closest approach point is associated with a target vehicle.

24. The system of claim 20, wherein the closest approach point is associated with a portion of a curb along the road segment.

25. The system of claim 20, wherein the closest approach point is associated with a roadside barrier positioned relative to the road segment.

26. The system of claim 20, wherein the closest approach point is associated with a cargo loaded on a transport vehicle.

27. The system of claim 20, wherein the closest approach point is associated with an overhanging edge of an object disposed in a vicinity of the road segment.

28. The system of claim 1, wherein the navigational action includes at least one of slowing the host vehicle or changing a heading direction of the host vehicle.

29. The system of claim 1, wherein the first plurality of pixels coincides with the second plurality of pixels.

30. The system of claim 1, wherein the first plurality of pixels is different from the second plurality of pixels.

31. The system of claim 1, wherein at least one of the first plurality of pixels or the second plurality of pixels includes all pixels of the captured image.

32. The system of claim 1, wherein at least one of the first plurality of pixels or the second plurality of pixels includes less than all pixels of the captured image.

33. A method for navigating a host vehicle relative to a road segment, the method comprising:
receiving a captured image acquired by a camera onboard the host vehicle;
based on analysis of the image, generating image height information including a predicted height value for each of a first plurality of pixels included in the captured image, the predicted height value for each of the first plurality of pixels being indicative of height above a ground surface;
based on analysis of the image, generating image range information, including a predicted range value for each of a second plurality of pixels included in the captured image, the predicted range value for each of the second plurality of pixels being indicative of distance relative to the camera; and
determining a navigational action for the host vehicle based on at least one of the image height information or the image range information.

34. A non-transitory computer-readable medium storing instructions executable by at least one processor to perform a method for navigating a host vehicle relative to a road segment, the method comprising:
receiving a captured image acquired by a camera onboard the host vehicle;
based on analysis of the image, generating image height information including a predicted height value for each of a first plurality of pixels included in the captured image, the predicted height value for each of the first plurality of pixels being indicative of height above a ground surface;
based on analysis of the image, generating image range information, including a predicted range value for each of a second plurality of pixels included in the captured image, the predicted range value for each of the second plurality of pixels being indicative of distance relative to the camera; and
determining a navigational action for the host vehicle based on at least one of the image height information or the image range information.

35-73. (canceled)
